(19) United States
(12) Patent Application Publication
(10) Pub. No.: US 2014/0324463 A1
(43) Pub. Date: Oct. 30, 2014

(54) WEB ACCOUNT CREATION AND MANAGEMENT, DATA SHARING, HOME PAGE SETTING, AND DATA REPORTING

(71) Applicant: Roche Diagnostics Operations, Inc., Indianapolis, IN (US)

(72) Inventors: Schuyler S. Buck, Muncie, IN (US); Eric S. Carlsgaard, Zionsville, IN (US); Samer M. Dajani, Carmel, IN (US); Aaron H. Dinwiddie, Cicero, IN (US); Igor Gejdos, Indianapolis, IN (US); Michael L. Long, Noblesville, IN (US); Stefania Marcoli, Trecate (IT); Andreas Markdalen, Monza (IT); Mark G. Mears, Westfield, IN (US); Angela S. McDaniel, Greensburg, IN (US); Ryan S. McKinney, Brownsburg, IN (US); Franziska Schulz, Walldorf (DE); Dominique Steppeler, Walldorf (DE); Thomas R. Sutton, Milan (IT)

(73) Assignee: Roche Diagnostics Operations, Inc., Indianapolis, IN (US)

(21) Appl. No.: 14/172,316

(22) Filed: Feb. 4, 2014

Related U.S. Application Data
(60) Provisional application No. 61/816,517, filed on Apr. 26, 2013.
(60) Provisional application No. 61/816,601, filed on Apr. 26, 2013.
(60) Provisional application No. 61/816,674, filed on Apr. 26, 2013.
(60) Provisional application No. 61/816,676, filed on Apr. 26, 2013.

(51) Int. Cl. G06F 19/00

(52) U.S. Cl. CPC G06F 19/322
USPC 705/3

(57) ABSTRACT

A method includes: receiving, at a computing device, diabetes management data from a diabetes management device, wherein the diabetes management data does not include a blood glucose (bG) measurement; using the computing device, transmitting an indicator of an account and the diabetes management data to a diabetes management server. The method further includes, using the diabetes management server: creating a bG measurement entry for the account in a database, leaving empty a field of the bG measurement entry for a bG measurement in the bG measurement entry based on the diabetes management data not including a bG measurement; and storing the diabetes management data in one or more respective fields of the bG measurement entry. The method further includes, using the diabetes management server, generating a user interface for displaying data stored in the bG measurement entry and at least one other bG measurement entry associated with the account.

### CROSS-REFERENCE TO RELATED APPLICATIONS

This application claims the benefit of U.S. Provisional Application No. 61/816,517, filed on Apr. 26, 2013, U.S. Provisional Application No. 61/816,601, filed on Apr. 26, 2013, U.S. Provisional Application No. 61/816,674, filed on Apr. 26, 2013, and U.S. Provisional Application No. 61/816,676, filed on Apr. 26, 2013. The entire disclosures of the applications referenced above are incorporated herein by reference.

### FIELD

The present disclosure relates to patient and/or health care provider diabetes data management systems and methods.

### BACKGROUND

Persons with diabetes often have difficulty regulating blood glucose levels in their bodies. As a consequence, many of these persons carry specialized electronic meters, called blood glucose meters, which allow them to periodically measure their glucose levels and take appropriate action, such as administering insulin. After a blood glucose measurement or series of measurements is taken, a diabetic patient may find it useful to communicate these measurements to his or her healthcare professional for further review and analysis. In this regard, the patient's blood glucose meter may be capable of storing the blood glucose measurements for later review and analysis by the patient or the healthcare professional, who may then record the measurements manually or electronically.

The process of measuring, storing, recording and analyzing blood glucose levels can be a very time consuming process for both the patient and the patient's healthcare professional. Often, the exchange and review of data requires a meeting between the patient and the healthcare professional. People with diabetes are often searching for better and more efficient ways to manage their health. In addition, healthcare professionals need new tools to motivate people with diabetes to communicate more effectively. Technology can provide a viable platform for software applications for a wide variety of consumer demands. Moreover, many people with diabetes use personal computers and/or mobile devices in their daily lives.

To improve the effectiveness and efficiency of storing, communicating and analyzing blood glucose measurements, it may be desirable for the patient and the patient's healthcare professional to send data, including blood glucose measurements, to a centralized electronic data repository for later retrieval and analysis. It may also be desirable for the patient and the patient's healthcare professional to have these data transmission capabilities at various times and from various locations.

This section provides background information related to the present disclosure, which is not necessarily prior art.

### SUMMARY

A method of managing diabetes management data includes: receiving, at a computing device, account creation information input by a user; transmitting the account creation information from the computing device to a diabetes management server; using the diabetes management server, creating an account based on the account creation information; receiving, at the computing device, diabetes management data from a diabetes management device that is connected to the computing device wirelessly or by wire, wherein the diabetes management data does not include a blood glucose (bG) measurement; using the computing device, transmitting an indicator of the account and the diabetes management data to the diabetes management server. The method further includes, using the diabetes management server, in response to receipt of the diabetes management data: creating a bG measurement entry for the account in a database, leaving empty a field of the bG measurement entry for a bG measurement in the bG measurement entry based on the diabetes management data not including a bG measurement; and storing the diabetes management data in one or more respective fields of the bG measurement entry. The method further includes: using the diabetes management server, generating a user interface for displaying data stored in the bG measurement entry and at least one other bG measurement entry that is associated with the account; and, using the computing device, accessing data stored in the database in association with the account and displaying the user interface including displaying the data stored in the bG measurement entry and the at least one other bG measurement entry that is associated with the account.

In further features, the method further includes: using the diabetes management server, generating a second user interface based on a type of diabetes management therapy associated with the account, wherein the account information input by the user includes the type of diabetes management therapy; and using the computing device, displaying the second user interface.

In further features, the second user interface includes a bG measurement graph set based on the type of diabetes management therapy associated with the account.

In further features, the second user interface includes a date range set based on the type of diabetes management therapy associated with the account.

In further features, the second user interface includes a calorie intake graph set based on the type of diabetes management therapy associated with the account.

In further features, the second user interface includes an exercise graph set based on the type of diabetes management therapy associated with the account.

In further features, the second user interface includes an insulin intake graph set based on the type of diabetes management therapy associated with the account.

In further features, the second user interface includes a statistical analysis of an average bG value versus a target bG value set based on the type of diabetes management therapy associated with the account.

In further features, the diabetes management data includes an amount of insulin administered via a syringe and does not include a bG measurement.

In further features, the diabetes management data includes an amount of insulin administered via an insulin pump and does not include a bG measurement.

In further features, the diabetes management data includes a carbohydrate intake and does not include a bG measurement.

In further features, the diabetes management data includes a calorie intake and does not include a bG measurement.

In further features, the diabetes management data includes advice given and does not include a bG measurement.

In further features, the method further includes: receiving, at the computing device, information for a health care professional's account; and using the diabetes management server, selectively enabling one or more users of the health care professional's account to access diabetes management data stored in the database in association with the account.

In further features, the method further includes, using the diabetes management server, identifying the health care professional's account based on the information for the health care professional's account.

In further features, the method further includes: displaying, using the computing device, a request for consent to enable the health care professional's account to access the diabetes management data stored in the database in association with the account; and using the diabetes management server, enabling the one or more users of the health care professional's account to access the diabetes management data in response to receipt of the consent by the diabetes management server.

In further features, the method further includes, using the diabetes management server, updating the field for the bG measurement of the bG measurement entry with a bG measurement input by a user to the computing device.

In further features, the method further includes, using the diabetes management server, storing an indicator with the bG measurement, the indicator indicating that the bG measurement was edited by the user.

In further features, the method further includes, using the computing device, transferring the diabetes management data from the diabetes management device to the diabetes management server without ever storing the diabetes management device anywhere within the computing device.

A diabetes management system is also disclosed. A computing device receives account creation information input by a user to the computing device. A diabetes management server: receives the account creation information from the computing device; and creates an account in a database based on the account creation information. A diabetes management device: is connected to the computing device wirelessly or by wire; and transmits diabetes management data stored in the diabetes management device to the computing device, wherein the diabetes management data does not include a blood glucose (bG) measurement. The computing device further transmits an indicator of the account and the diabetes management data to the diabetes management server. In response to receipt of the diabetes management data, the diabetes management server further: creates a bG measurement entry for the account in the database, leaves empty a field of the bG measurement entry for a bG measurement in the bG measurement entry based on the diabetes management data not including a bG measurement; and stores the diabetes management data in one or more respective fields of the bG measurement entry. The diabetes management server further generates a user interface for displaying data stored in the bG measurement entry and at least one other bG measurement entry that is associated with the account. The computing device further: accesses data stored in the database in association with the account; and displays the user interface including displaying the data stored in the bG measurement entry and the at least one other bG measurement entry that is associated with the account.

Further areas of applicability of the present disclosure will become apparent from the detailed description, the claims and the drawings. The detailed description and specific examples are intended for purposes of illustration only and are not intended to limit the scope of the disclosure.

### DRAWINGS

The drawings described herein are for illustrative purposes only of selected embodiments and not all possible implementations, and are not intended to limit the scope of the present disclosure.

FIGS. 1-5 are example diabetes management systems;

FIGS. 6-34 illustrate various graphical user interfaces (GUIs) that may be used to create an account with a diabetes management system and importing diabetes management data into the account;

FIG. 35A includes an example block diagram of an example server computer and a database of a diabetes management server;

FIG. 35B includes an example method of applying selected rules that may be performed by a server computer to diabetes management data uploaded for an account;

FIGS. 36-53 illustrate various graphical user interfaces that may be used for sharing diabetes management in a diabetes management system;

FIGS. 54-101 illustrate various graphical user interfaces that may be used for filtering, editing, and displaying diabetes management in a diabetes management system;

FIGS. 102-114 illustrate various graphical user interfaces that may be used for displaying diabetes management data in a diabetes management system; and

FIG. 115 is another example diabetes management system.

Corresponding reference numerals indicate corresponding parts throughout the several views of the drawings.

### DETAILED DESCRIPTION

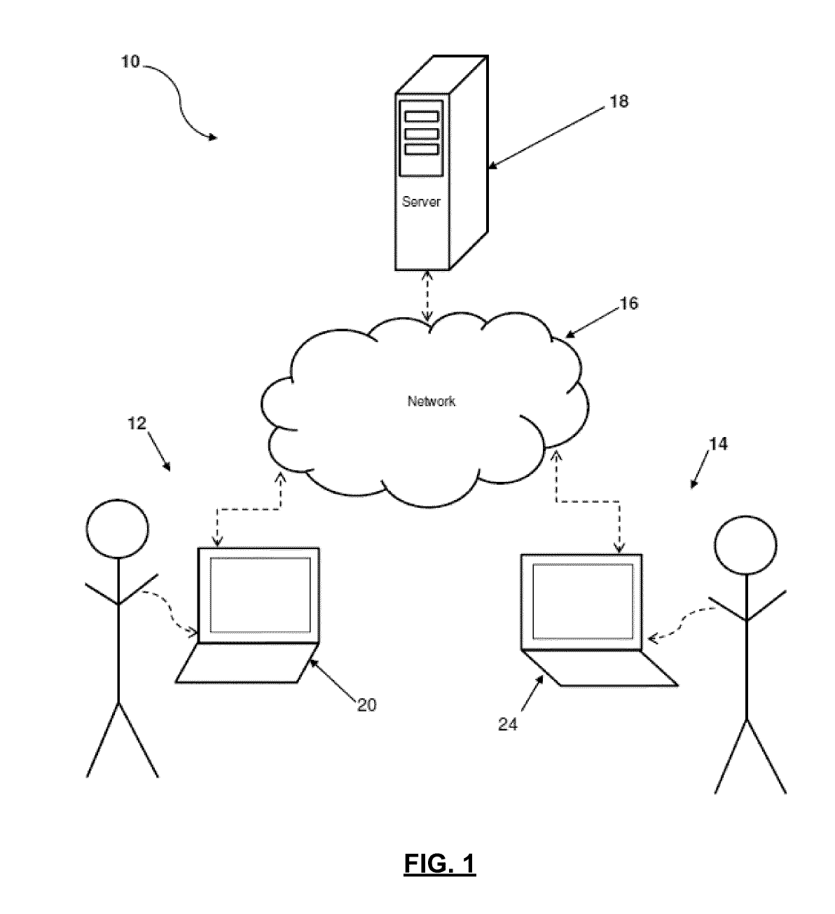

FIG. 1 illustrates an example diabetes management system (“DMS”) 10 for storing and transmitting medical data and information across a distributed computing environment. By way of non-limiting example, such medical data and information might include diabetes management data, search engine functionality, alerts and reminders, user-entered notes, reports and graphs, and global positioning system information. The diabetes management data may include, for example, blood glucose (bG) measurement data, insulin data, and other types of data related to diabetes management.

The DMS 10 may include generally a patient data system 12, a healthcare professional data system 14, a network 16, and at least one server computer 18. As will be explained in more detail below, the DMS 10 may be configured such that data and information is electronically sent to and received from the patient data system 12, the healthcare professional data system 14, and the server computer 18 via the network 16.

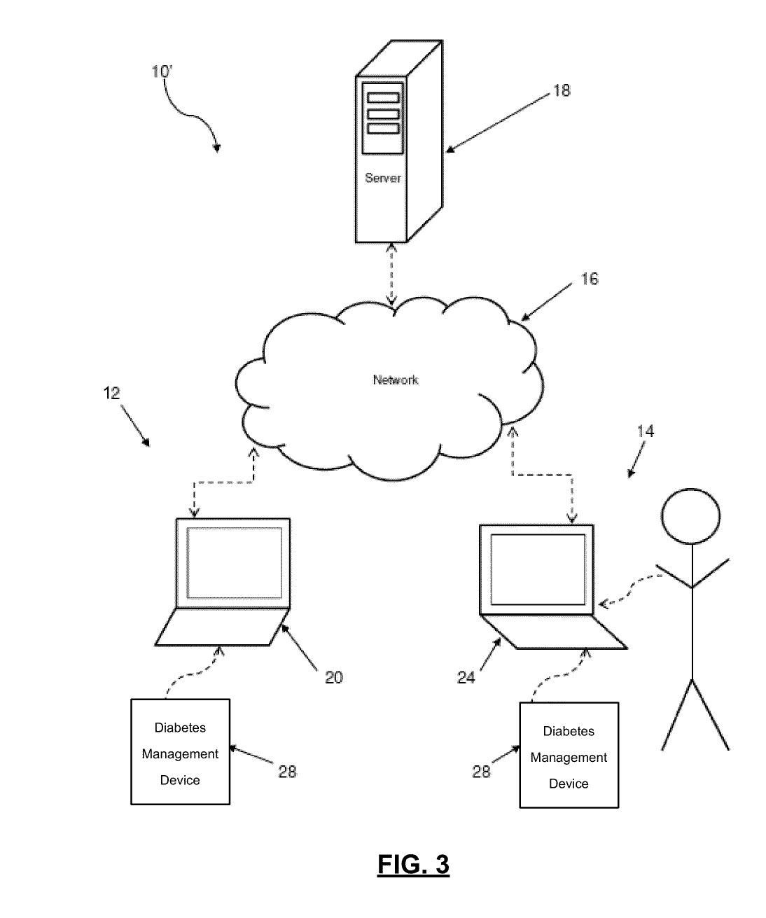

FIG. 3 includes another example DMS 10′. The DMS 10′ also include one or more diabetes management devices 28, such as a bG meter, an insulin pump, or another suitable type of device used in the management of diabetes. bG meters measure and store diabetes related data and information, such as blood glucose measurements and related data. Insulin pumps administer insulin to a user and store diabetes related data and information, such as amount of insulin administered and related data.

The diabetes management devices 28 are operable to send stored diabetes management data to at least one of the patient computing device 20 and the healthcare professional computing device 24. The diabetes management devices 28 may transmit stored diabetes management data to an external computing device by wire (e.g., Universal Serial Bus (USB)) via an I/O port or wirelessly, such as via by Bluetooth®, infrared (IR), or another suitable type of wireless communication.

Each diabetes management device 28 may be associated with a unique identifier or security code that attaches to any data transmitted by the diabetes management device. Accordingly, in this method of data transmission, the patient or other user may not be required to enter a username, password, or other security code prior to transmitting data via the network 16.

The patient data system 12 may include at least one patient computing device 20 operably connected to, and in communication with, the network 16 through a wired or wireless connection. By way of example, the patient computing device 20 may be a personal computing device or a mobile electronic device such as a tablet or a smartphone.

The patient computing device 20 may include at least one data input device, at least one processor, at least one storage device, and at least one output device. The data input devices may include a touchscreen, a keyboard, a mouse, a microphone, a hard-wired data port such as a USB port, and/or a wireless data transceiver such as a Bluetooth® transceiver. The processor is connected to the data input device(s), the storage device(s), and the output device(s). The storage device(s) may include memory, one or more hard drives, one or more disk drives, and/or one or more other suitable types of storage devices. The output devices include a display, a speaker, and/or other suitable output devices.

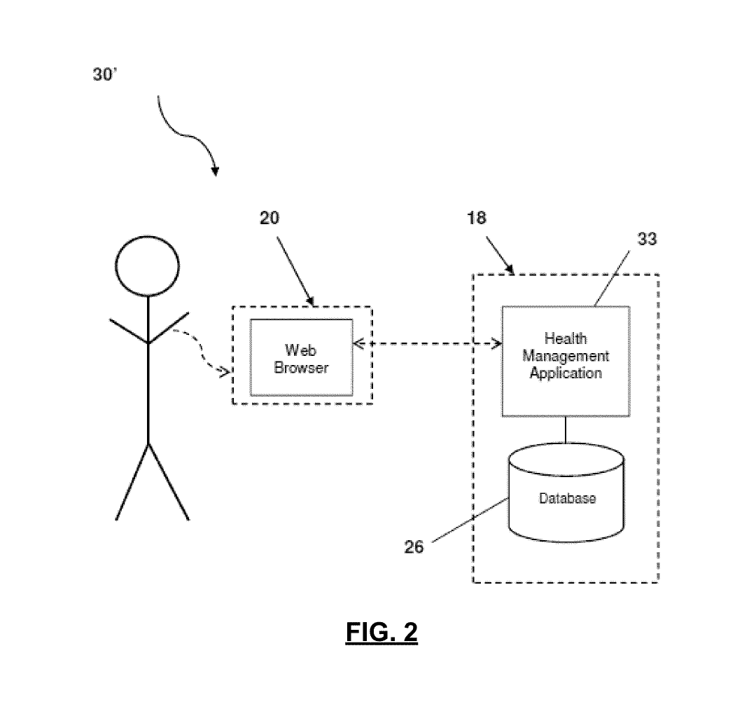

With reference to FIGS. 1 and 2, in one embodiment of the patient data system 12, a user (e.g., a patient) may enter diabetes management data into a web browser on the patient computing device 20 for transmission to the server computer 18 via the network 16. Prior to entering or transmitting data via the network 16, the user may be required to enter a username, password, or other security code, to ensure the accurate transmission and storage of data, as will be described in more detail below.

The healthcare professional data system 14 includes at least one healthcare professional computing device 24 operably connected to, and in communication with, the network 16 through a wired or wireless connection. A health care professional (e.g., a physician, nurse, or other health care professional with access to the healthcare professional computing device 24) may utilize the network 16 to download, upload, and view diabetes management data stored by the server computer 18.

By way of example, the healthcare professional computing device 24 may be a personal computing device or a mobile electronic device such as a tablet or a smartphone. The healthcare professional computing device 24 may include at least one data input device, at least one processor, at least one storage device, and at least one output device. The data input devices may include a touchscreen, a keyboard, a mouse, a microphone, a hard-wired data port such as a USB port, and/or a wireless data transceiver such as a Bluetooth® transceiver. The processor is connected to the data input device(s), the storage device(s), and the output device(s). The storage device(s) may include memory, one or more hard drives, one or more disk drives, and/or one or more other suitable types of storage devices. The output devices include a display, a speaker, and/or other suitable output devices.

The server computer 18 may include at least one data input device, at least one processor, at least one storage device including a database 26, and at least one output device. The processor is connected to the storage device(s), the input device, and the output device.

The server computer 18 and the database 26 are operably connected to, and in communication with, the network 16 through a wired or wireless connection. The server computer 18 sends and receives diabetes management data to and from the patient data system 12 via the network 16. The server computer 18 stores diabetes management data received from the patient data system 12 in the database 26. The server computer 18 also processes diabetes management data stored in the database 26 and can transmit diabetes management data to the patient data system 12. As will be discussed below, data sent via the network 16 may be assigned to a unique patient account prior to being stored in the database 26.

FIG. 3 illustrates another DMS 10′. The DMS 10′ may be similar to the DMS 10 of FIG. 1 and include the patient data system 12, the healthcare professional data system 14, the network 16, and the at least one server computer 18.

The diabetes management device 28, such as a bG meter, transmits diabetes management data to a connected computing device (e.g., the patient computing device 20 or the health care professional computing device 24) wirelessly or by wire. The diabetes management device 28 may transmit diabetes management data to the connected computing device, for example, at regular user programmable intervals or in response to user input prompting transmission of the diabetes management data. Additionally or alternatively, the diabetes management device 28 may transmit diabetes management data to the connected computing device in real time as diabetes management data is received by the diabetes management device 28 (e.g., as bG measurements are taken or as insulin is administered), or when diabetes management data (e.g., bG measurements) reaches certain threshold levels. The threshold levels may be set by the patient and/or the healthcare professional.

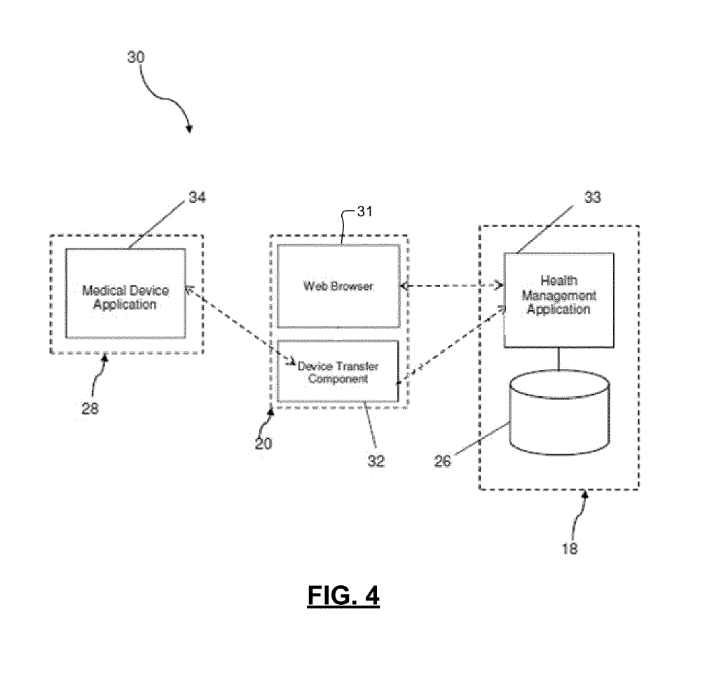

With reference to FIG. 4, a system 30 for use with the DMS 10 is illustrated. The system 30 may be operable to allow transmission and manipulation of data and information, such as bG measurements, from the diabetes management device 28, through the network 16 and between the patient data system 12, the server computer 18, and the healthcare professional data system 14.

The system 30 may include a device transfer component 32. The device transfer component 32 may be stored on the server computer 18 for transmission through the network 16 and execution by the processors of the patient computing device 20 and the healthcare professional computing device 24. Installation of the device transfer component 32 onto the patient computing device 20 or the healthcare professional computing device 24 will allow that computing device to send and receive diabetes management data to and from a health management application 33 installed on the server computer 18. The device transfer component 32 may also be referred to as an application. A user of a computing device can download the device transfer component 32 from the server computer 18, for example, via a web browser 31.

When the diabetes management device 28 sends diabetes management data to the patient computing device 20 or the healthcare professional computing device 24, the device transfer component 32 passes the received data to the server computer 18 via the network 16. The device transfer component 32 does not store the received data in the device transfer component 32 or the computing device executing the device transfer component 32.

A medical device application 34 may be installed on the diabetes management device 28 to facilitate the receipt of diabetes management data by the diabetes management device 28 and the exchange of diabetes management data with the device transfer component 32. Diabetes management data sent via the device transfer component 32 may include an identifier code that is unique to the patient and/or diabetes management device 28 from which it was received.

Prior to transferring diabetes management data to or from the server computer 18, a user may be required to link or associate the diabetes management device 28 with a unique patient account created on the server computer 18. The device transfer component 32 may perform authentication with the diabetes management device 28. Once the device transfer component 32 authenticates the diabetes management device 28, the diabetes management device 28 may be assigned an authentication token. While an example including an authentication token will be discussed, another unique identifier may be used.

A user of a computing device can create a unique account with the server computer 18 via the device transfer component 32. Account creation is discussed further below. After downloading and executing the device transfer component 32, and allowing the diabetes management device 28 to communicate with the patient computing device 20, the diabetes management device's authentication token can be associated with the appropriate patient account. Once the diabetes management device's 28 authentication token has been assigned to the patient account, data and information can be transferred through the device transfer component 32 and assigned to the appropriate patient account in the database 26.

In an alternative embodiment, the device transfer component 32 may be assigned a unique identification code. Prior to transferring data and information from the diabetes management device 28 through the network 16, the user may be required to associate the device transfer component's 32 unique identification code with the patient's account. Data and information from the diabetes management device 28 can be linked to the device transfer component's 32 unique identification code prior to transmission through the network 16, and thus assigned to the appropriate patient account in the database 26.

After data has been transferred from the diabetes management device 28 to the patient account located on the server computer 18, the system 30 may allow such data to be further transferred from the patient account to authorized healthcare professional computing devices 24 and patient computing devices 20 via the device transfer component 32. Transfer of data from the patient account to a healthcare professional's computing device 24 may require linking the patient account with the device transfer component 32 installed on the healthcare professional computing device 24.

The system 30 may also allow a patient, healthcare professional, or other user to create customized reports related to stored diabetes management data and perform research with respect to diabetes management data stored within or outside of the system 30. In addition, the system 30 may be operable to provide data backup and restoration services with respect to data that may have been lost from the patient data system 12 or the healthcare professional data system 14.

With reference to FIG. 2, the user may send and receive data from the server computer 18 and the database 26 via a web browser 31 on the patient computing device 20, in lieu of downloading and utilizing the device transfer component 32 on the patient computing device. In the system 30′, the server computer 18 may include the device transfer component 32, allowing the user to send data and information to the server computer 18 for storage in the database 26, and for further transmission to the healthcare professional computing device 24 via the network 16. The user may access the DMS 10 and the system 30′ by entering a Uniform resource Locator (URL) designated for the diabetes management system into the web browser 31.

Prior to transferring data through the network 16 to the server computer 18, the user may be required to create a unique patient account and security credentials, such as a username and password, to ensure that the patient's diabetes management data is stored in a unique and secured storage location in the database 26. The user may also be required to associate, or link, the diabetes management device 28 authentication token with the patient account. Once the user has created the patient account and linked the diabetes management device 28 authentication code to the patient account, the user may be permitted to transfer data and information to and from the server computer 18 without otherwise logging into the patient account.

In one aspect of the DMS, access to the server computer 18 via the web browser 31 may allow a user to transmit data such as bG measurements, patient weight, meal information, and similar information, to the patient account in the database 26. In another aspect of the DMS, access to the server computer 18 via the web browser 31 may allow the user to create and view reports, graphs, and other information based at least in part on data transmitted from the user.

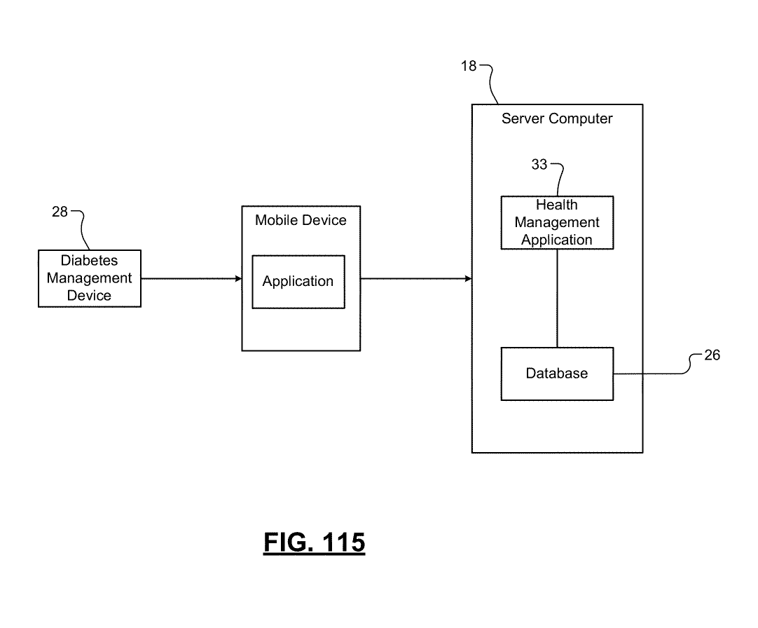

Communication between the patient data system 12, the healthcare professional data system 14, and the server computer 18 may utilize hypertext transfer protocol (HTTP) basic authentication in combination with a secure sockets layer (SSL) security protocol. Other communication and security protocols known in the art are also contemplated. Another example DMS is shown in FIG. 115.

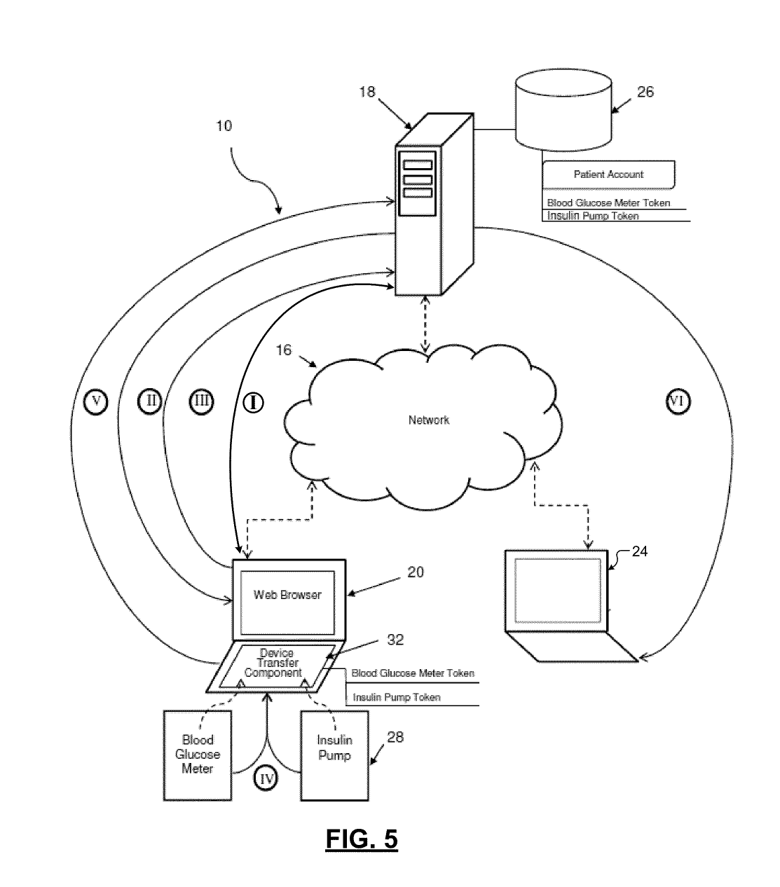

With reference to FIG. 5, an example of operation of the DMS 10 is shown. In a first step, indicated by I, a user may access the server computer 18 via the network 16 using a web browser 31 on a computing device, such as the patient computing device 20. The user may create a unique patient account on the server computer 18 utilizing security credentials such as a username and password. Creation of a patient account may allow the user to send and store diabetes management data and information in association with the patient account within the database 26. The patient account may also allow the user to access previously stored diabetes management data associated with the account.

In a second step, indicated by II, the user may utilize a web browser 31 to access the server computer 18 to download the device transfer component 32 onto the patient computing device 20.

In a third step, indicated by III, a user may register the diabetes management device 28 with at least one of the device transfer component 32 and the patient account. Registration of at least one diabetes management device 28 (or an application installed on a mobile computing device) with the device transfer component 32 and the patient account may be accomplished by first allowing the at least one diabetes management device 28 to communicate with the patient computing device 20. Each diabetes management device 28 may be assigned a unique identification code or authentication token that can be associated with the patient account, thus ensuring that data and information sent from the diabetes management device 28 is stored only in association with the patient account. Registration of the diabetes management device 28 with the device transfer component 32 and the patient account may also be accomplished by the user by directly entering the diabetes management device's identification code or authentication token directly into device transfer component 32 or a web browser 31.

In a fourth step, indicated at IV, a user may send diabetes management data from the diabetes management device 28 to the device transfer component 32. Data and information received from the diabetes management device 28 will include the identification code or authentication token assigned to the particular diabetes management. In this way, the DMS 10 can ensure the integrity of data and information sent to the patient account.

In a fifth step, indicated by V, the device transfer component 32 may send diabetes management data received from the diabetes management data device 28 to the server computer 18. The device transfer component 32 may not store or otherwise record the diabetes management data received from the diabetes management device 28. Rather, the device transfer component 32 may function as an intermediary between the diabetes management device 28 and the server computer 18, in facilitating the transfer of data and information therebetween. Data and information transferred from device transfer component 32 may be authenticated and stored in association with the patient account through the associated identification code or authentication token received from the diabetes management device 28.

In a sixth step, indicated at VI, data and information associated with the patient account in the database 26 may be transferred to at least one of the patient computing device 20 and the healthcare professional computing device 24 via the network 16. The transfer of diabetes management data associated with the patient account to the healthcare professional computing device 24 requires that the patient account first be linked with an account of the health care professional.

In various aspects, the present technology includes the creation and management of one or more web accounts integrated with the DMS 10. As used herein, the term “web account” or “web online account” includes an account, architecture, or collection of data that is controlled by or connected to another computer, server, or network, for example, through the internet.

A healthcare professional may create a web account through the DMS 10. For example, this may be accomplished using software or a link in the medical device application 34 installed on the diabetes management device 28. In other aspects, the healthcare provider can directly create an account using a web browser. When created via the web browser, the healthcare provider can import, load, or register multiple patients, as well as manage patients from the healthcare provider's account. Thus, a healthcare provider can manage many patients, and optionally other healthcare providers, within an account.

Additionally, a patient can create an account using a web browser and import the patient's records from the diabetes management system. In this regard, business rules may be used when importing the data to perform certain conversions, and to reduce errors. It should be understood that various end user license agreements (EULAs), voluntary consents, or the like may be incorporated or configured as part of the account.

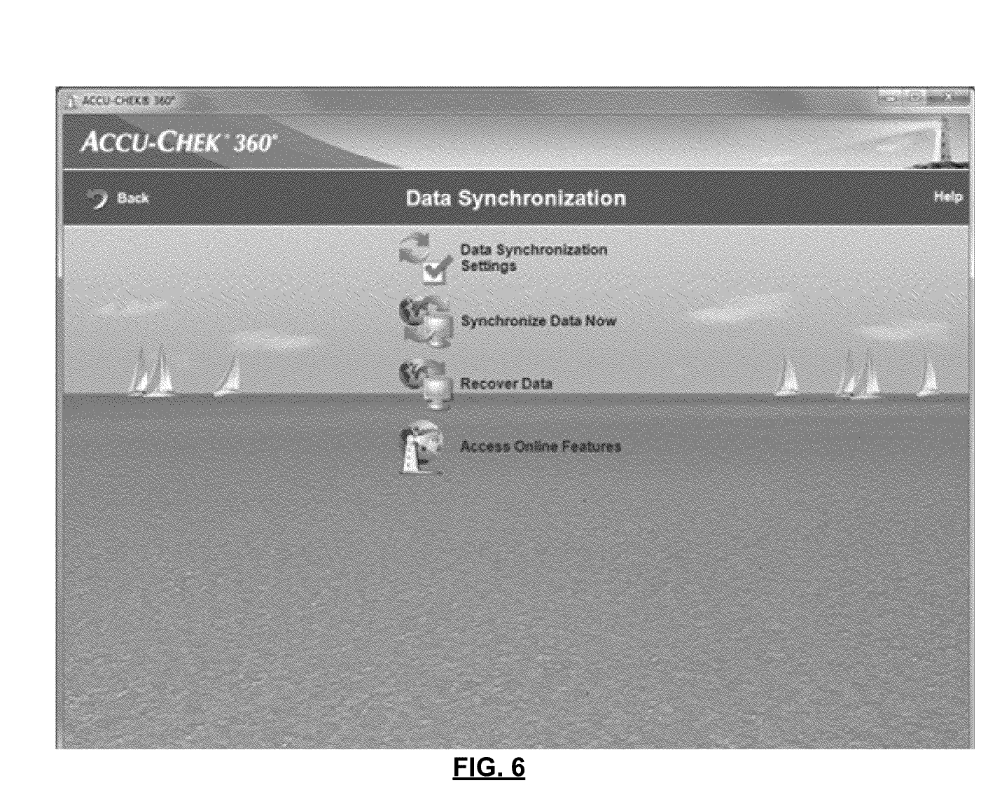

FIG. 6 is an example GUI that may be displayed, for example, on the patient computing device 20 executing the device transfer component 32. From this GUI, a user can synchronize data synchronization settings stored on the patient computing device 20 with data synchronization settings stored in the database 26. The data synchronization settings may include, for example, data indicative of when to transfer diabetes management data from the diabetes management device 28 to the server computer 18 and other types of settings. The user can also synchronize the diabetes management data stored in the diabetes management device 28 with diabetes management data stored in the database 26. The user can also recover diabetes management data stored in the database 26 and store that data in the diabetes management device 28. The user can also access one or more features accessible via the Internet, such as diabetes management features.

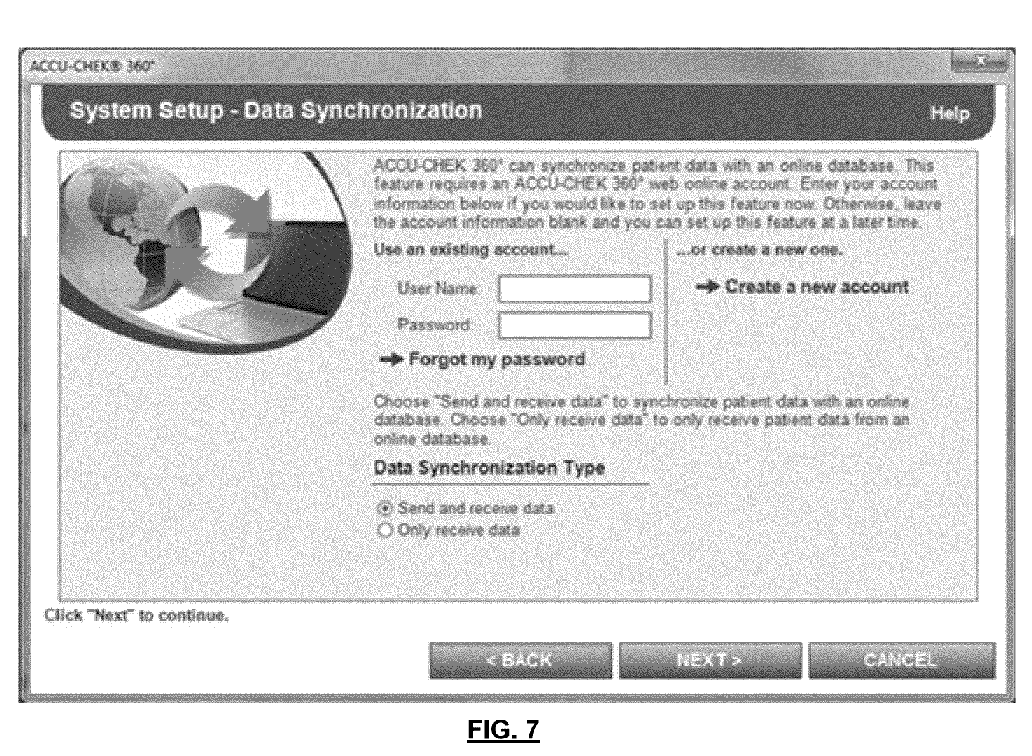

FIG. 7 is an example GUI that may be displayed, for example, in response to user selection of a data synchronization option. As discussed above, an account is required for synchronization. As such, this user interface enables the user to create an account or to input a username and password for a previously created account.

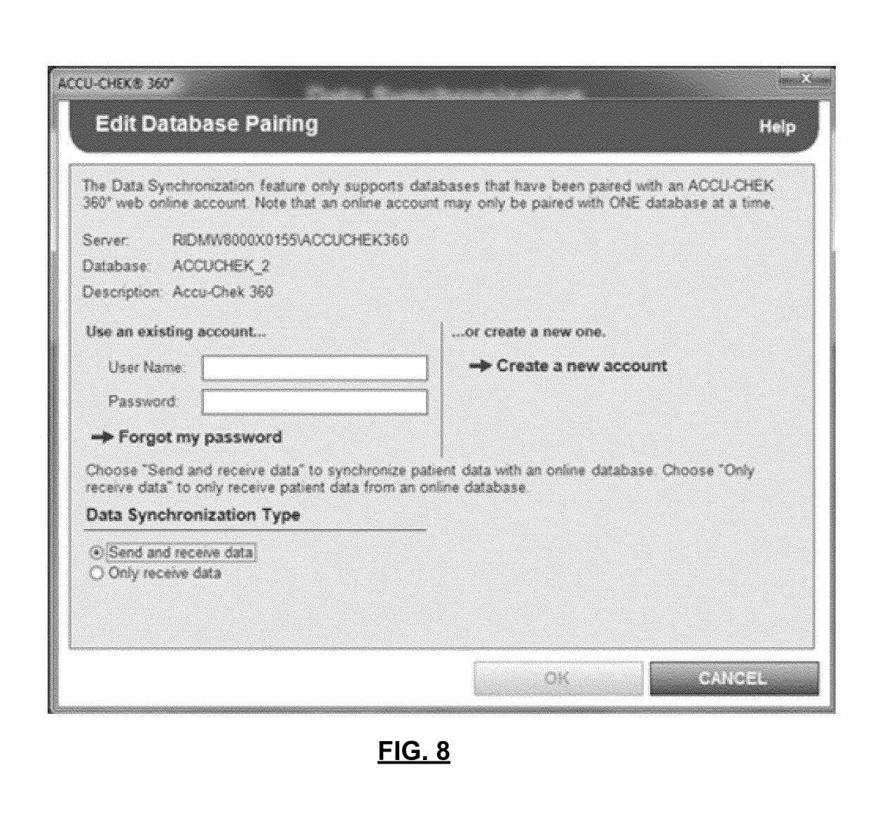

The account can be configured with a data synchronization type. The data synchronization type can be, for example, to both send and receive diabetes management data from the database 26 or to only receive diabetes management data from the database 26. A connection is established with a server and database as shown in the GUI illustrated in FIG. 8.

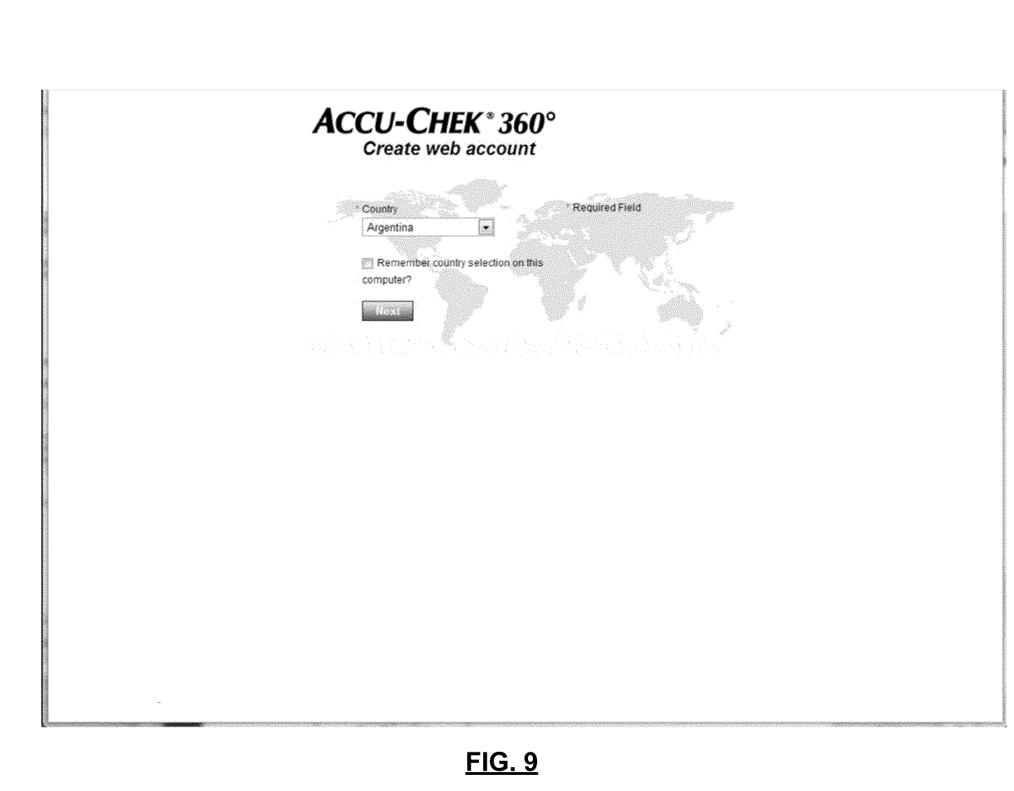

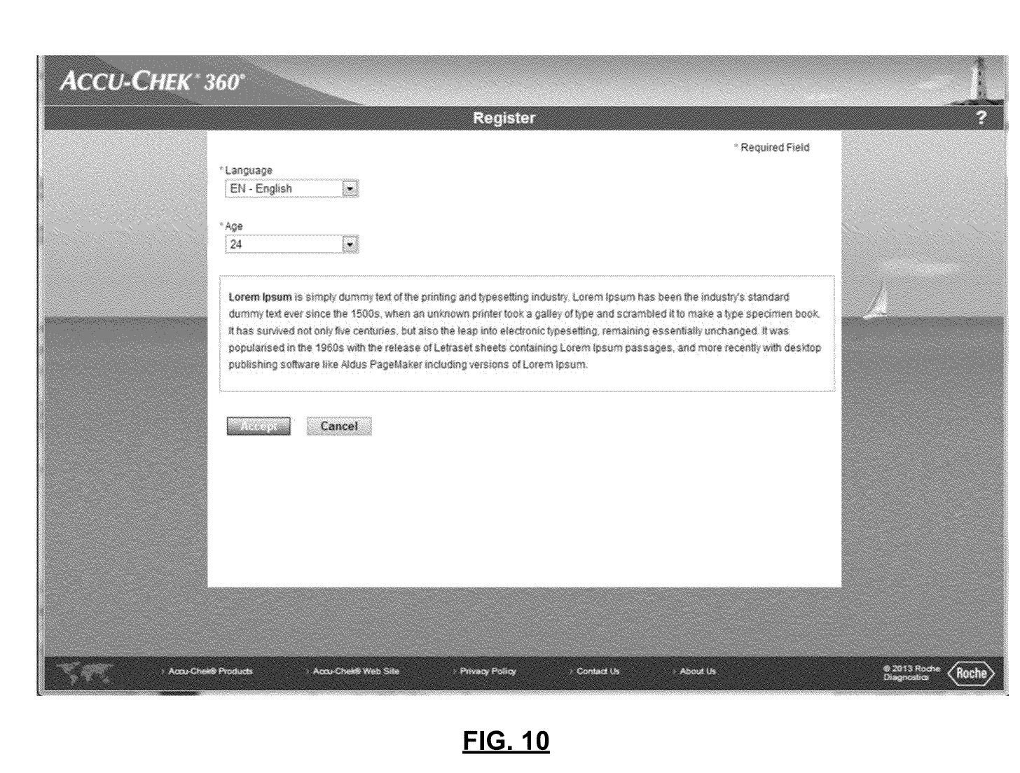

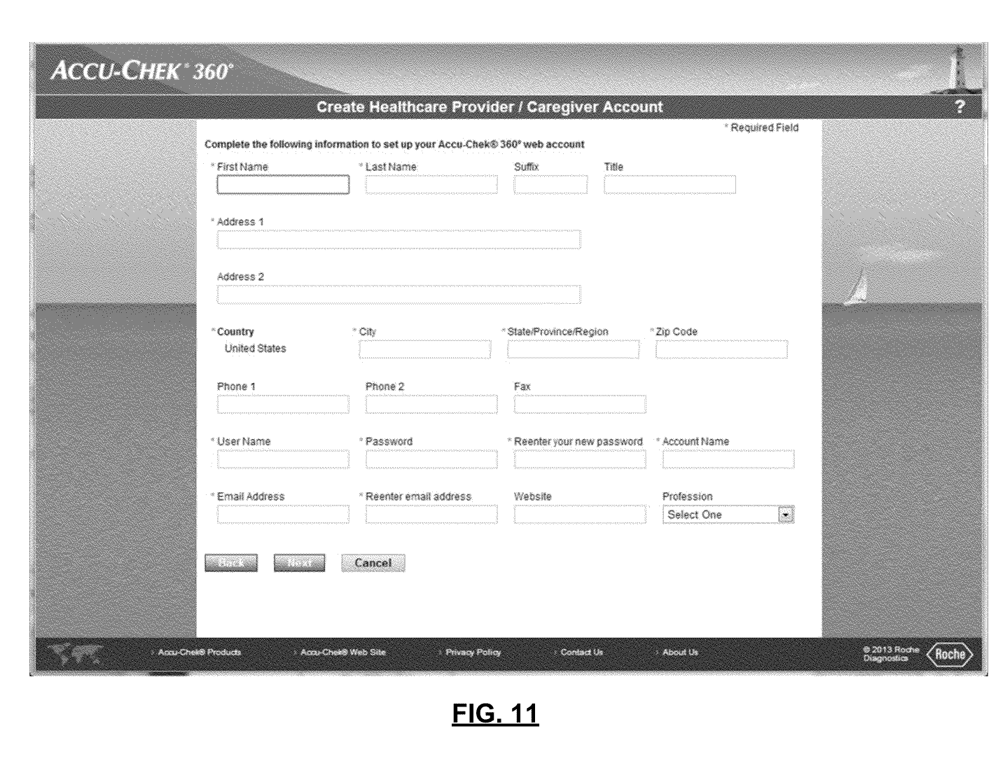

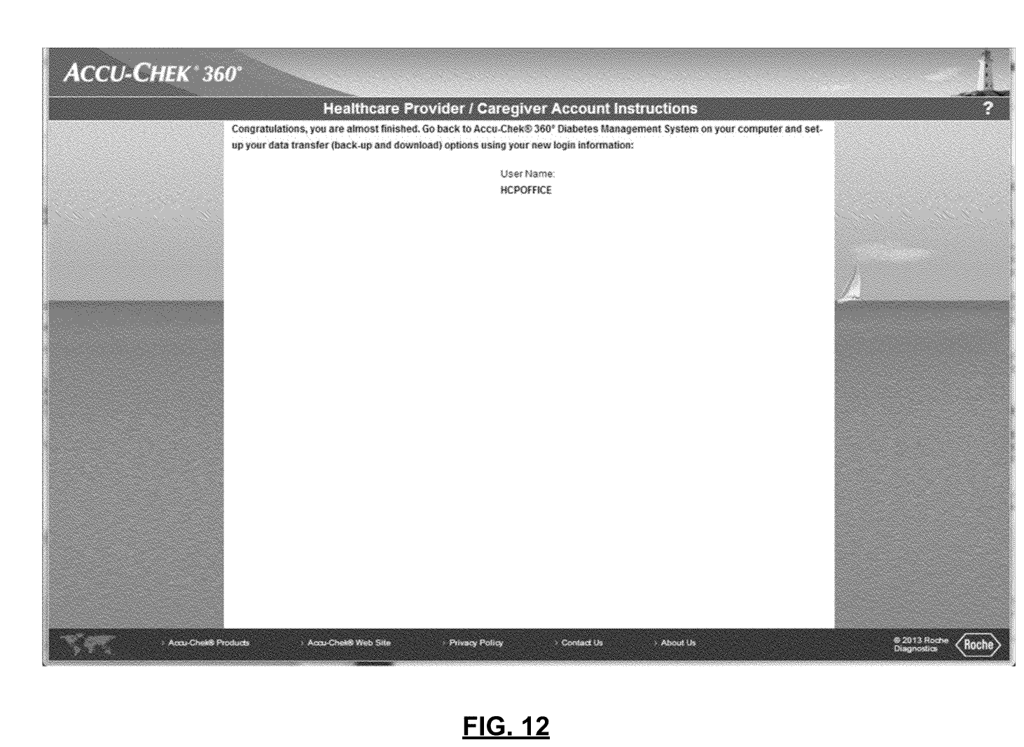

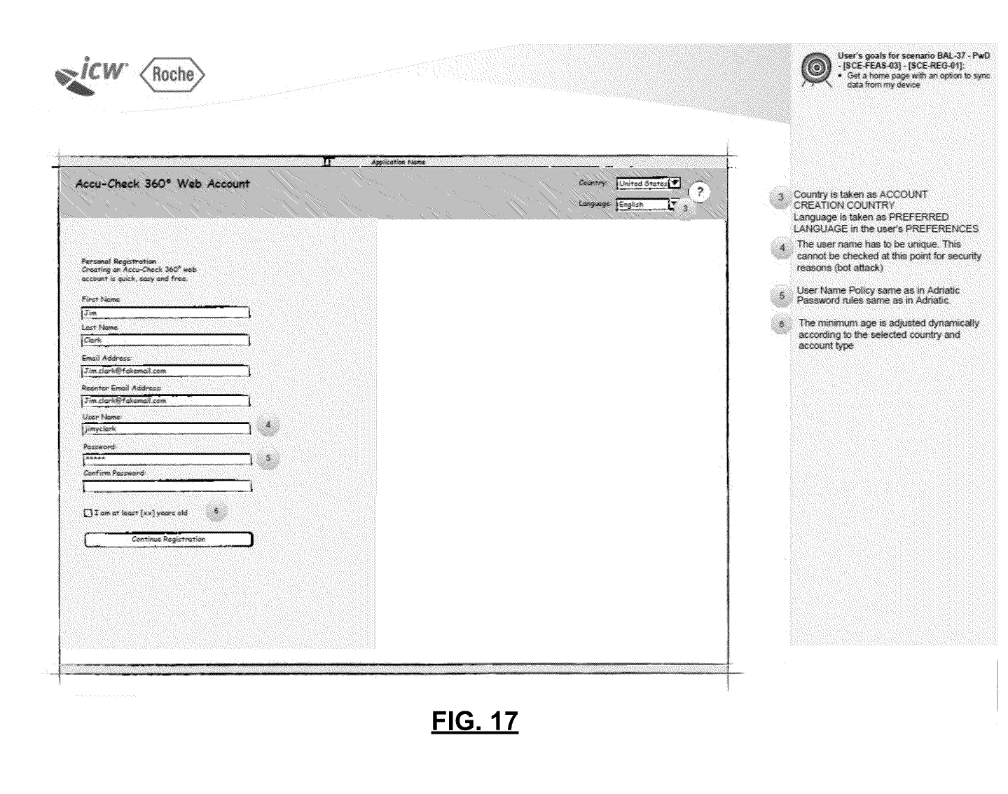

FIGS. 9, 10, and 11 illustrate GUIs for soliciting and input user registration information, such as country location, preferred language, age, name and address information, password, and other demographic, logistical, or otherwise relevant diabetes management information. The GUI shown in FIG. 11 is an example that may be presented to solicit information for creation of an account for a health care professional. As discussed further below (e.g., see FIG. 17), a different GUI may be presented to solicit information for creation of a patient account. FIG. 12 illustrates a GUI showing the user name chosen for a created health care professional's account.

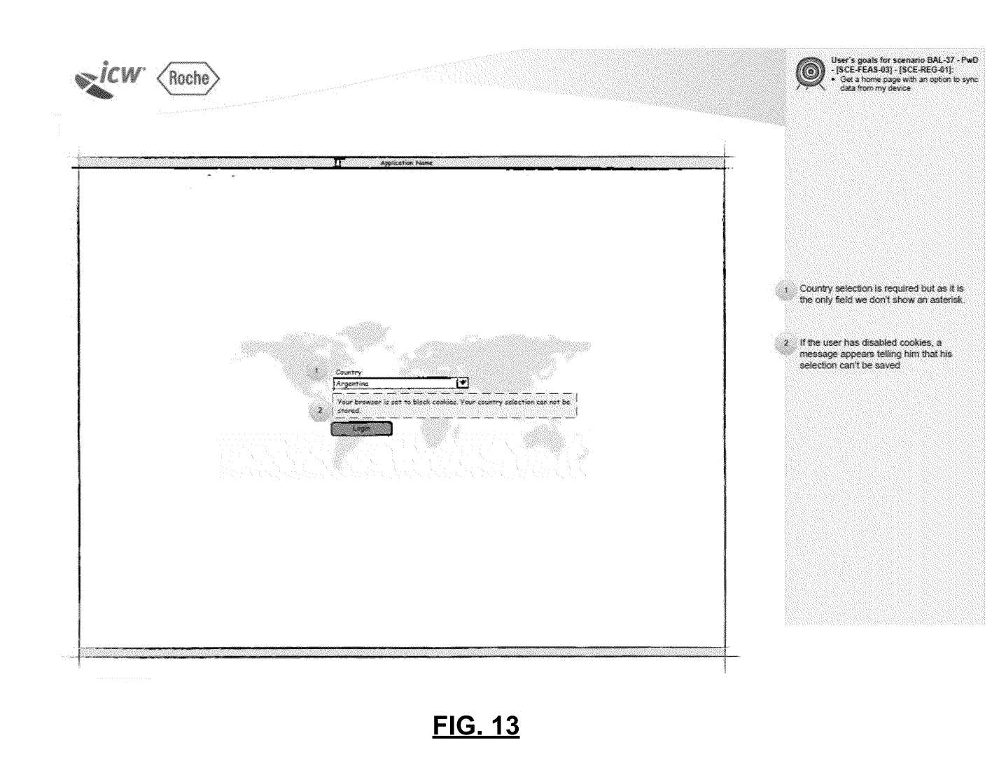

As shown in FIG. 13, the first time that the device transfer component 32 is executed on a computing device, a landing GUI may be shown that prompts the user to select the user's country. An option to remember the selected country may also be presented. The option to remember the selected country may be selected by default, but the user may de-select the option such that the selected country is not remembered. Frequently referred to as “remember me” options, information may be saved to a user's computer device using “cookies” or other known methods of identification.

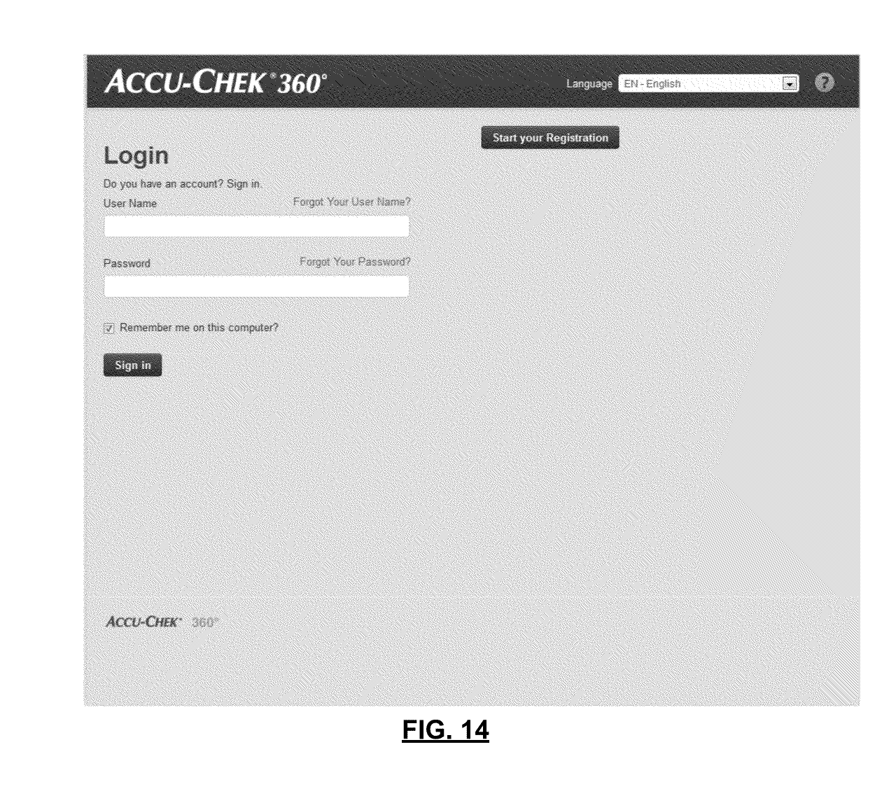

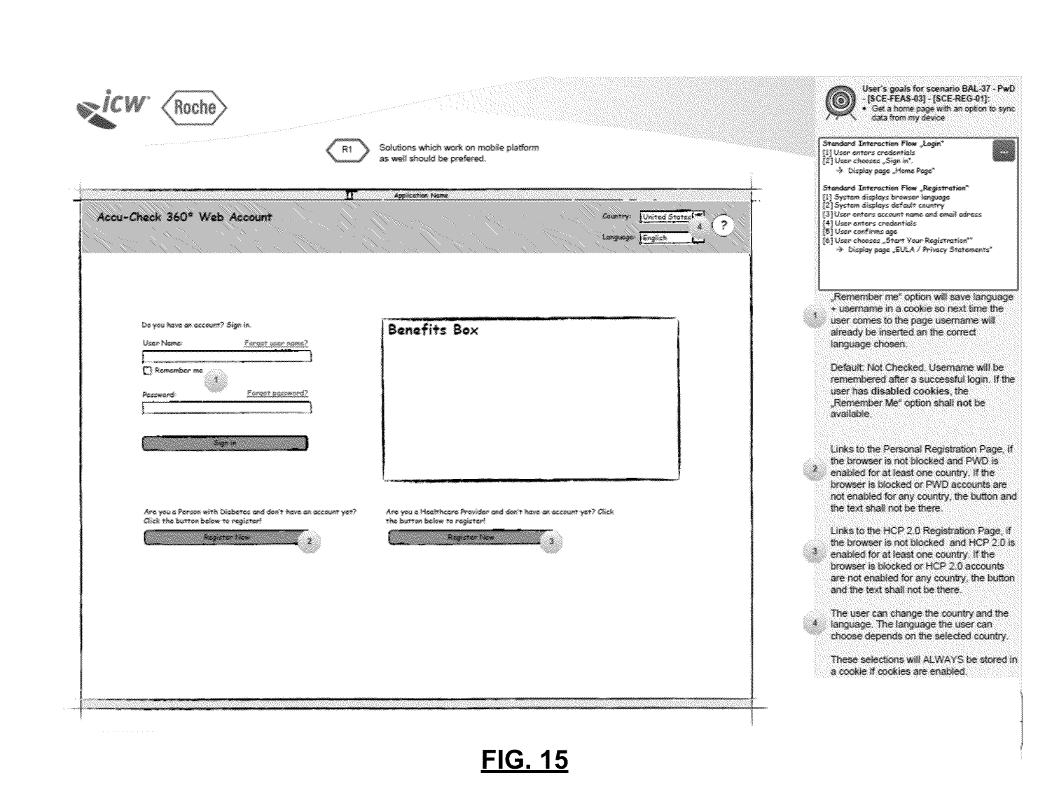

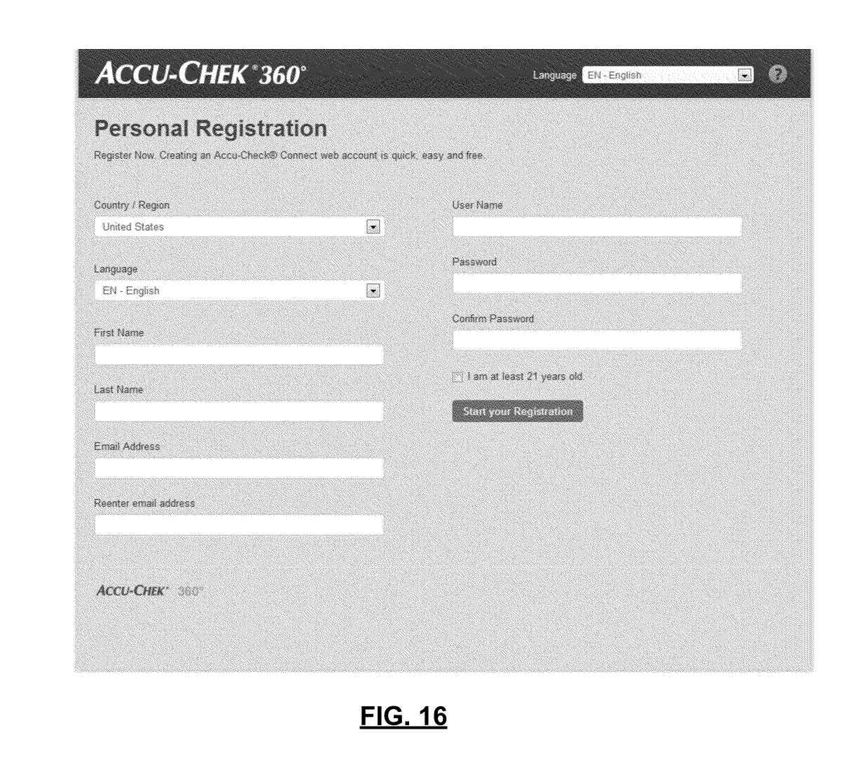

FIGS. 14 and 15 illustrate other example GUIs from which a user can enter the username and password for previously created accounts or select an option to create a new account, such as an account for a patient or an account for a health care professional. FIGS. 16 and 17 illustrate example GUIs with fields for information for creating a patient account. To create a patient account, the user may be requested to input information such as country, language, first and last name, email address, desired user name, and password. To ensure proper entry, the user may be requested to input the email address and password twice. The user may also be requested to verify that they are at least a predetermined minimum age, such as 21 years old.

Certain fields may be pre-selected, such as the country previously selected. User names are unique, passwords may have certain rules, and minimum age adjustments may be adjusted dynamically based on country selections.

When a user is authenticated, the system may display a unique screen title for each screen page, display a common header area, and display a common navigation area. Certain of the GUIs referenced herein and shown in the figures may be high resolution or low resolution, depending on the computer device being used.

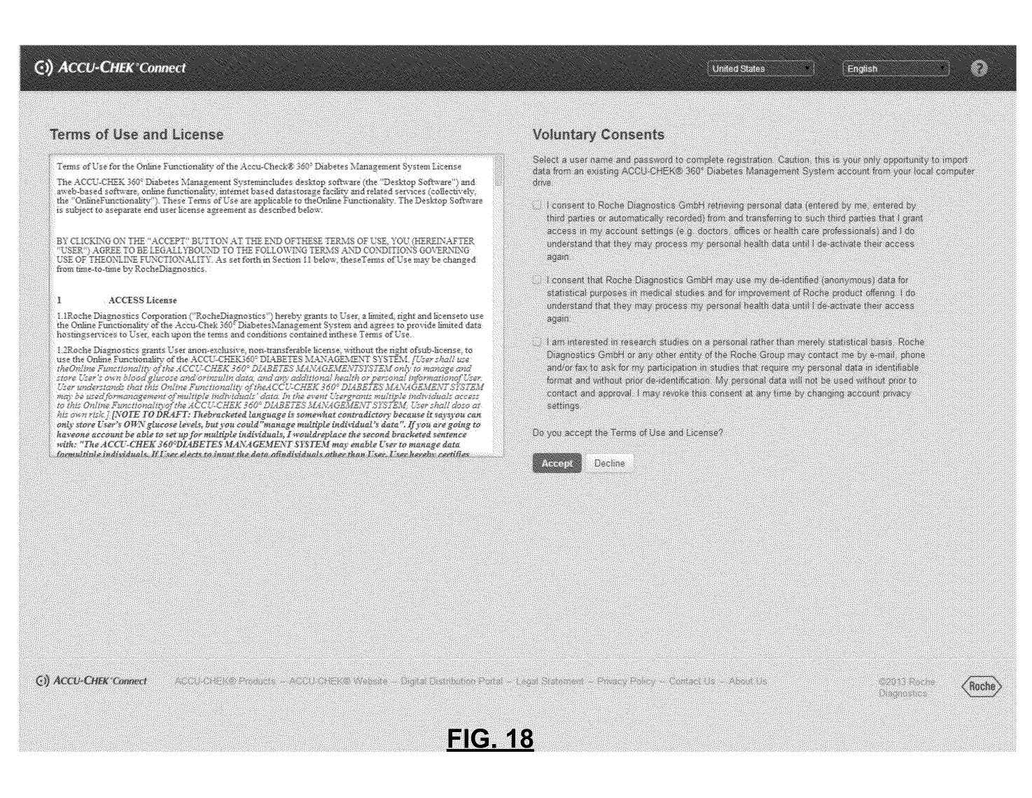

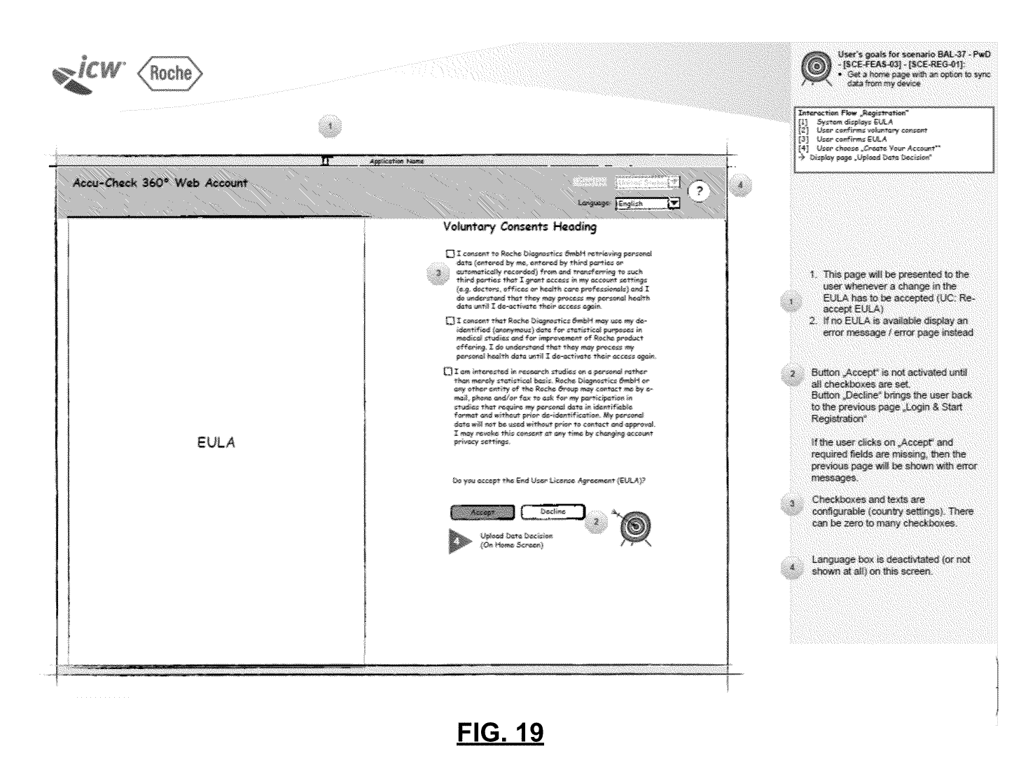

As mentioned above, it may be beneficial to provide an end user license agreement for use of the diabetes management system and/or voluntary consents for the use or release of their data. FIGS. 18 and 19 illustrate the presentation of the EULAs and solicitations for consent to various items. Any changes to the agreement(s) since the user last accepted the agreement may be presented to the user for review and acceptance. A user must typically agree to each consent item by checking an appropriate indicator box prior to the “accept” button becoming active for a user to select.

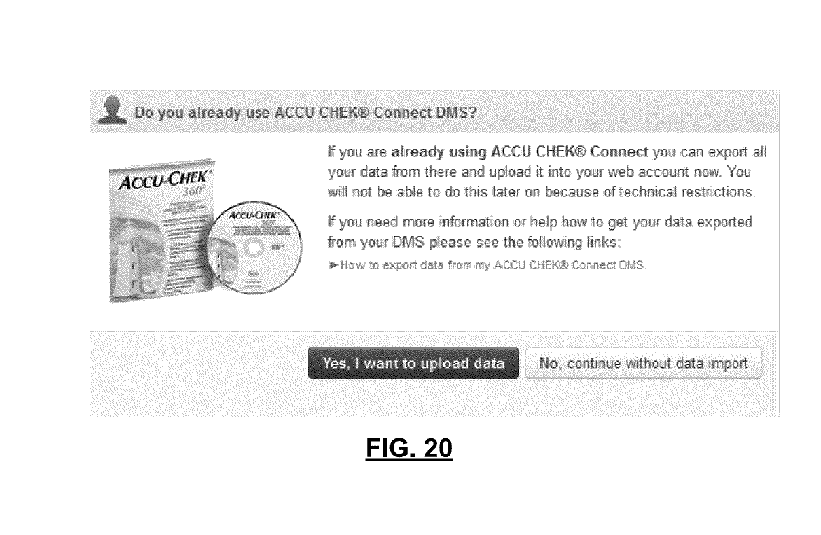

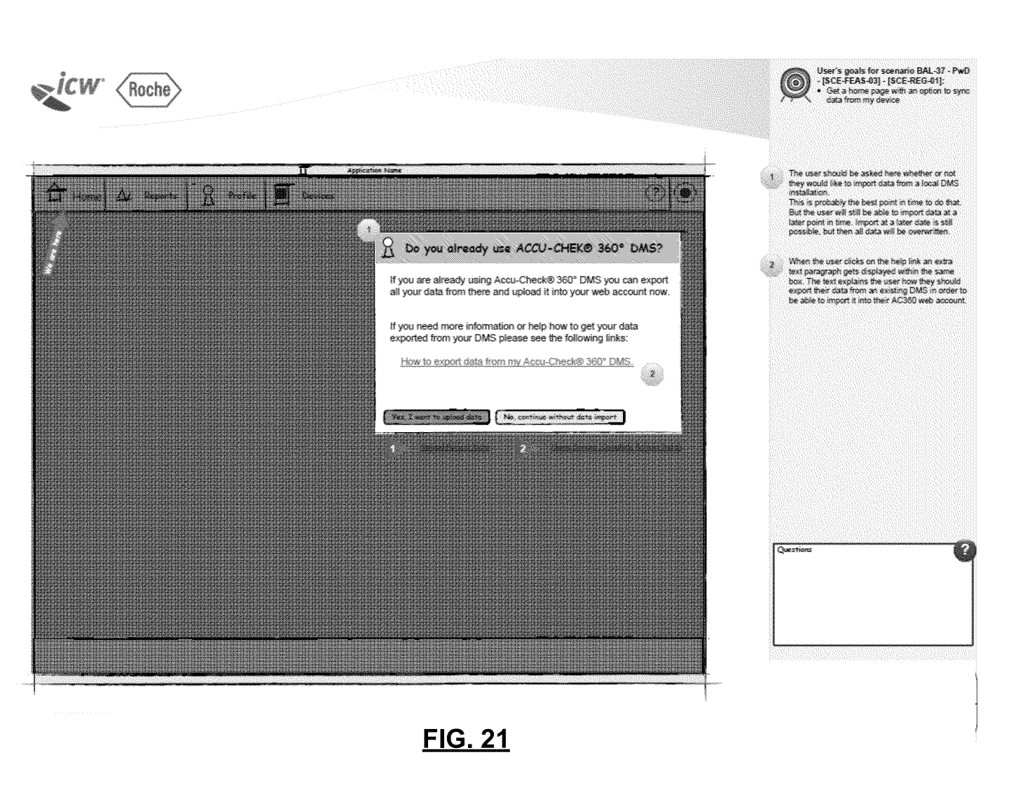

Once a user has created an account, the user may be asked whether the user would like to transmit data to upload diabetes management data to the database 26 in association with that account. FIGS. 20 and 21 include example GUIs illustrating user selectable options for uploading diabetes management data in association with the user's account or proceeding without uploading diabetes management data. Even if not uploading diabetes management data at that time, the user can upload diabetes management data at a later time.

The GUIs of FIGS. 20 and 21 may also include a user-selectable option for obtaining information as to how to export diabetes management data from an existing DMS (e.g., stored in their computing device) to be able to upload that data to the database 26 in association with the account. The existing DMS may include, for example, a diabetes management application executing on a computing device.

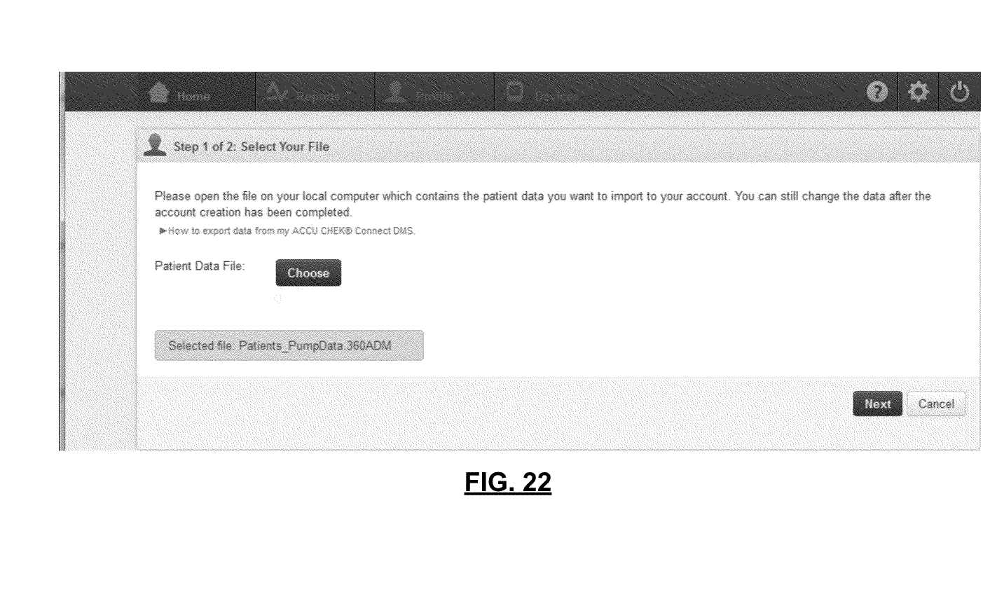

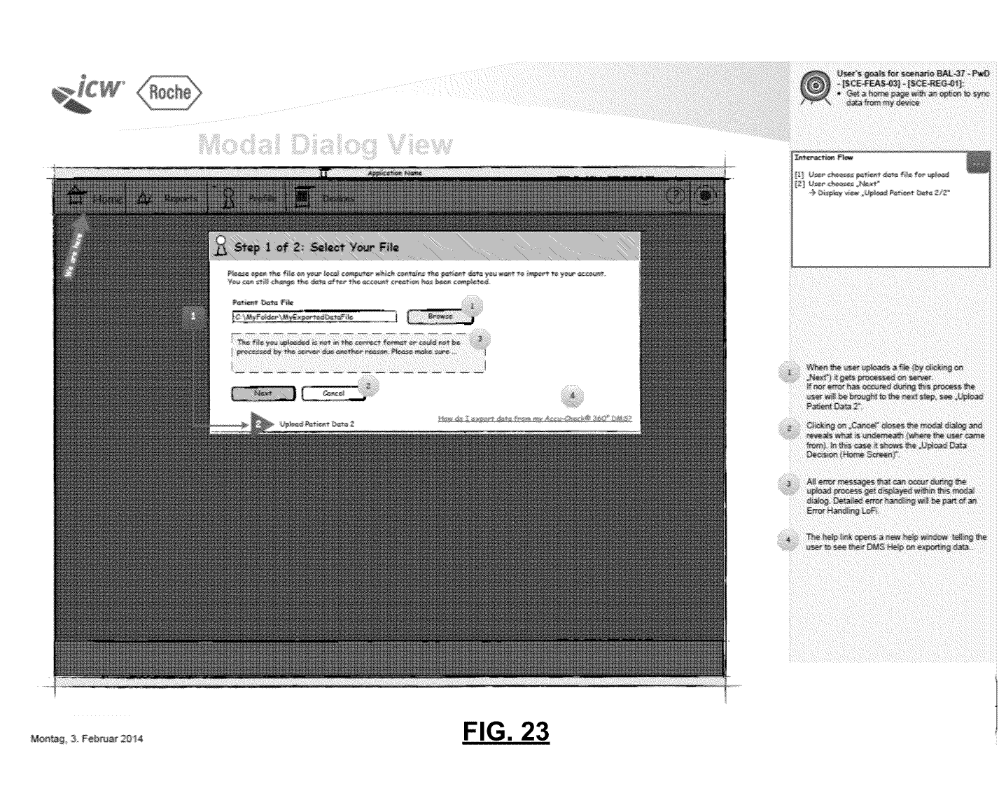

FIGS. 22 and 23 illustrate example GUIs for step 1 of 2 steps when the user has selected to upload data for the account. The first step may involve the user selecting a file that includes diabetes management data. The device transfer component 32 may display a choose file option that the user can select to identify a file including diabetes management data. The device transfer component 32 may identify one or more predetermined types of files (e.g., having predetermined file extensions) and display files of the predetermined type(s) to the user for possible selection and uploading.

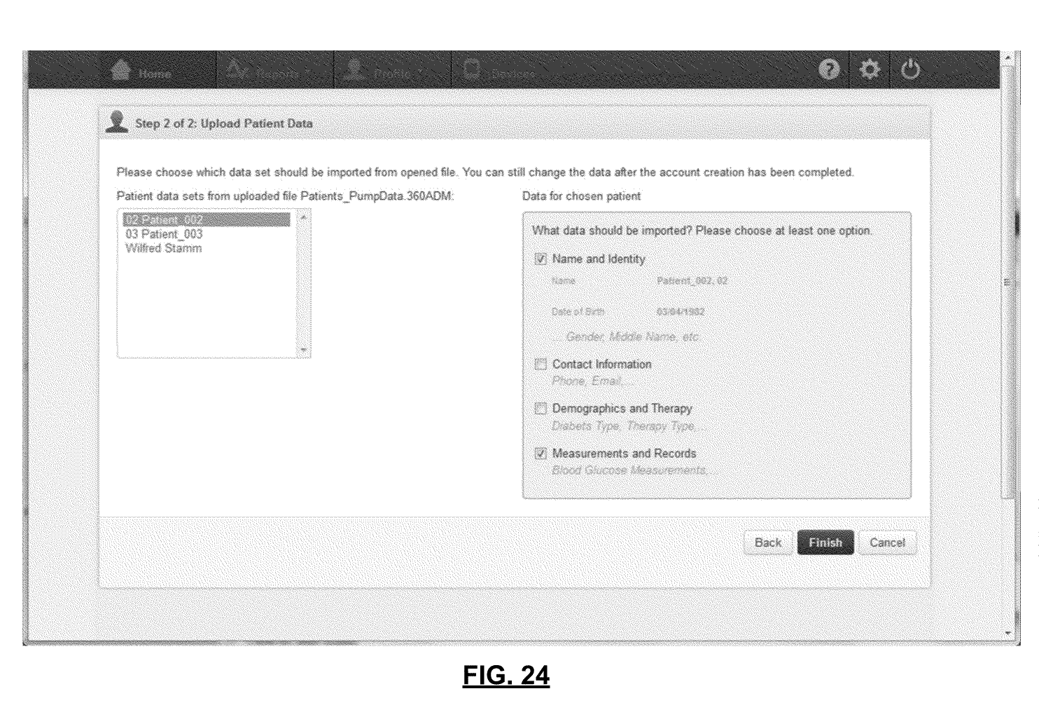

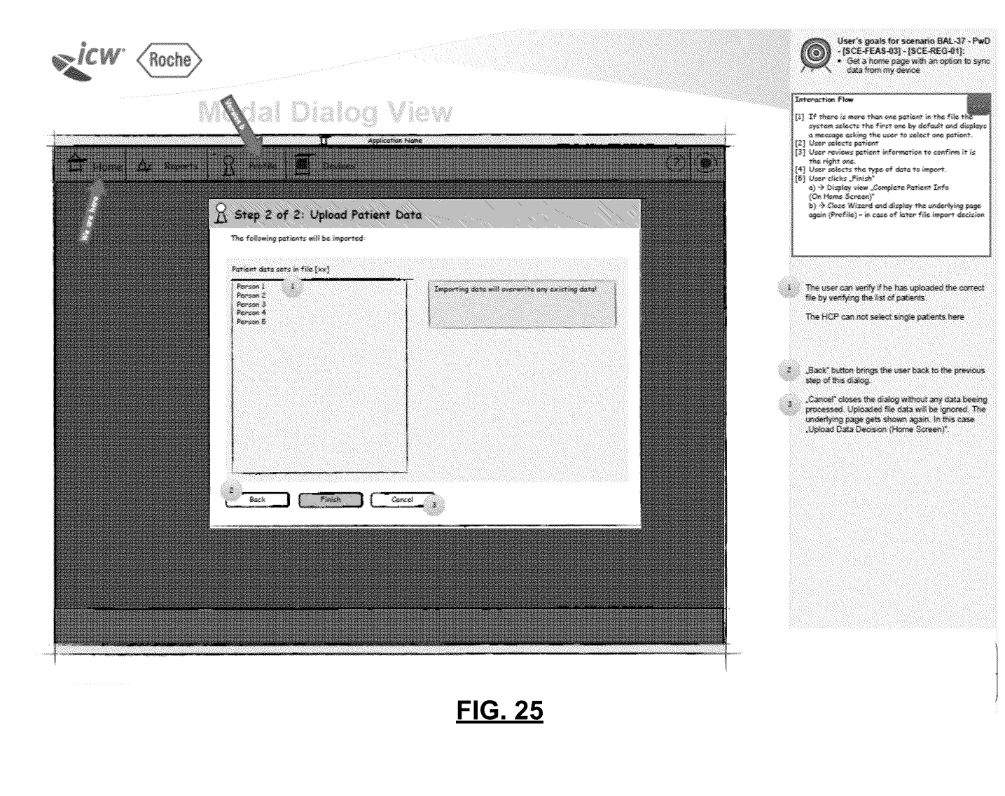

FIGS. 24 and 25 include example GUIs for step 2 of uploading diabetes management data for an account. When the user proceeds to the second step of uploading diabetes management data from a selected file (e.g., by selecting the “next” option), the device transfer component 32 or the server computer 18 may parse the file to identify patient(s) having diabetes management data stored in the selected file and what types of diabetes management data are included in the selected file. The device transfer component 32 or the server computer 18 may process the selected file to determine whether the selected file includes one or more errors. Errors may be displayed to the user.

The selected file may include, for example, personal information (e.g., name, birthdate, etc.), contact information (e.g., phone number, email, etc.), demographic data and therapy type, and measurements and records. For each patient having diabetes management data stored in the selected file, the user can select what types of diabetes management data should be uploaded.

Users can verify the correct file has been selected by checking the list of patients or patient data sets displayed in a window. If a user cancels the operation at this time, the dialog window may be closed without the data being processed, and may reveal a home screen.

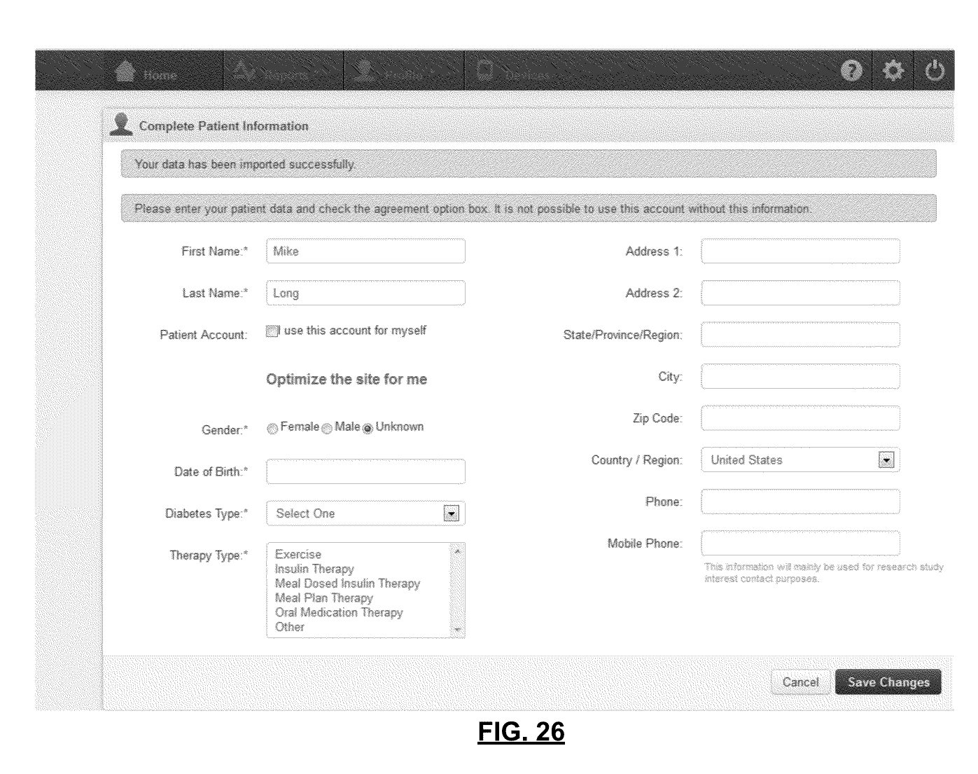

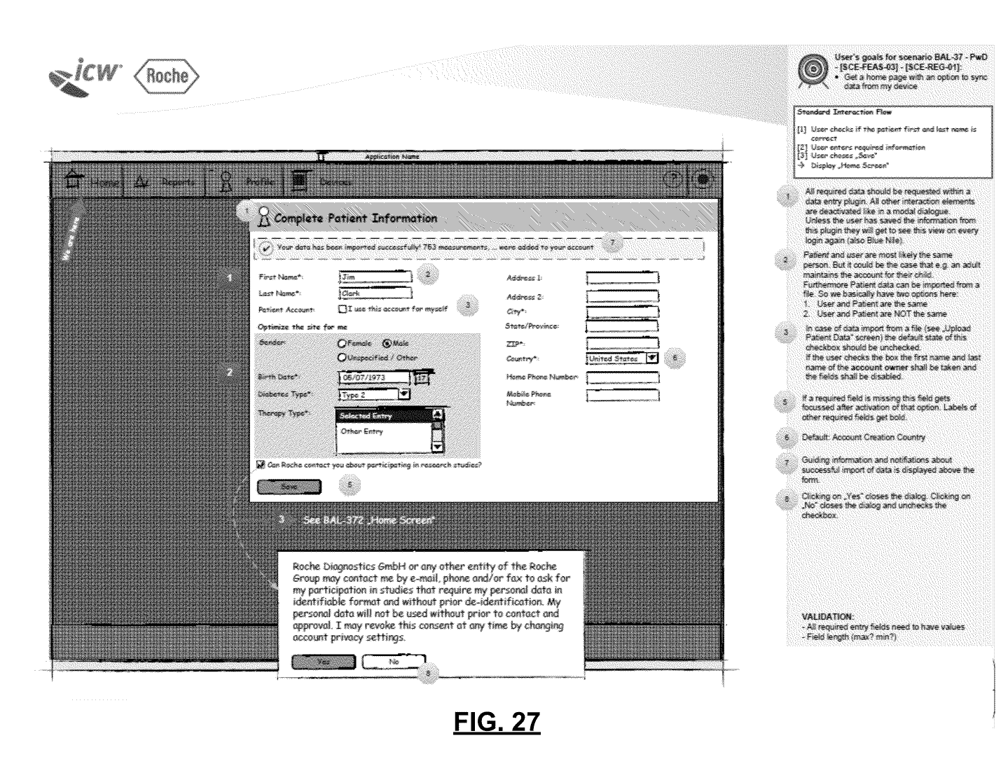

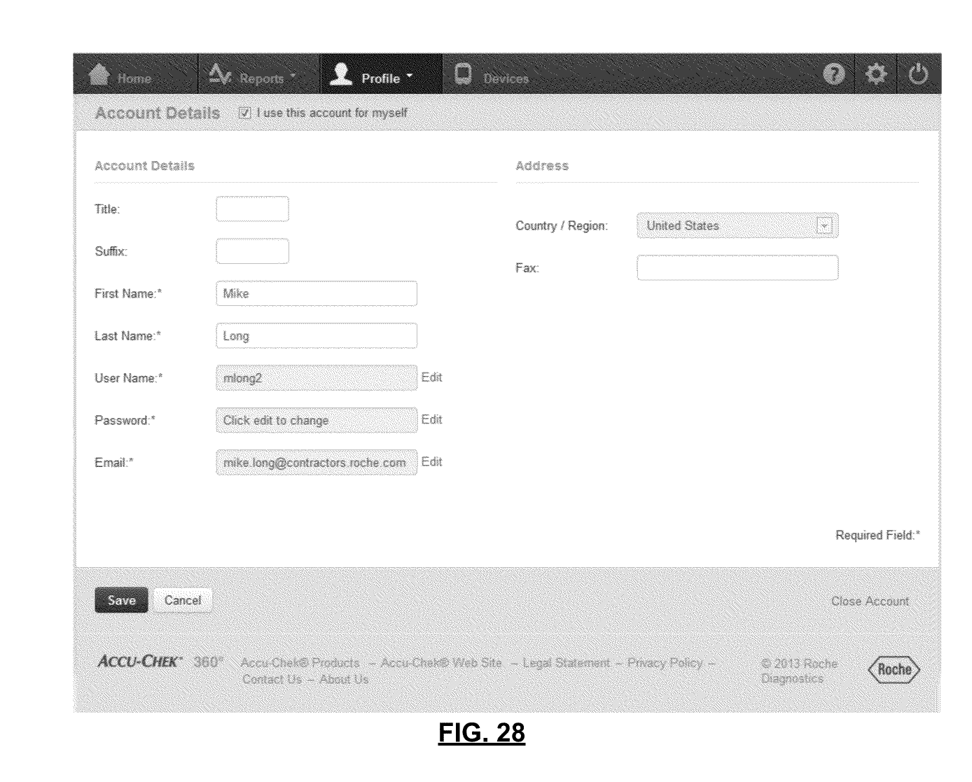

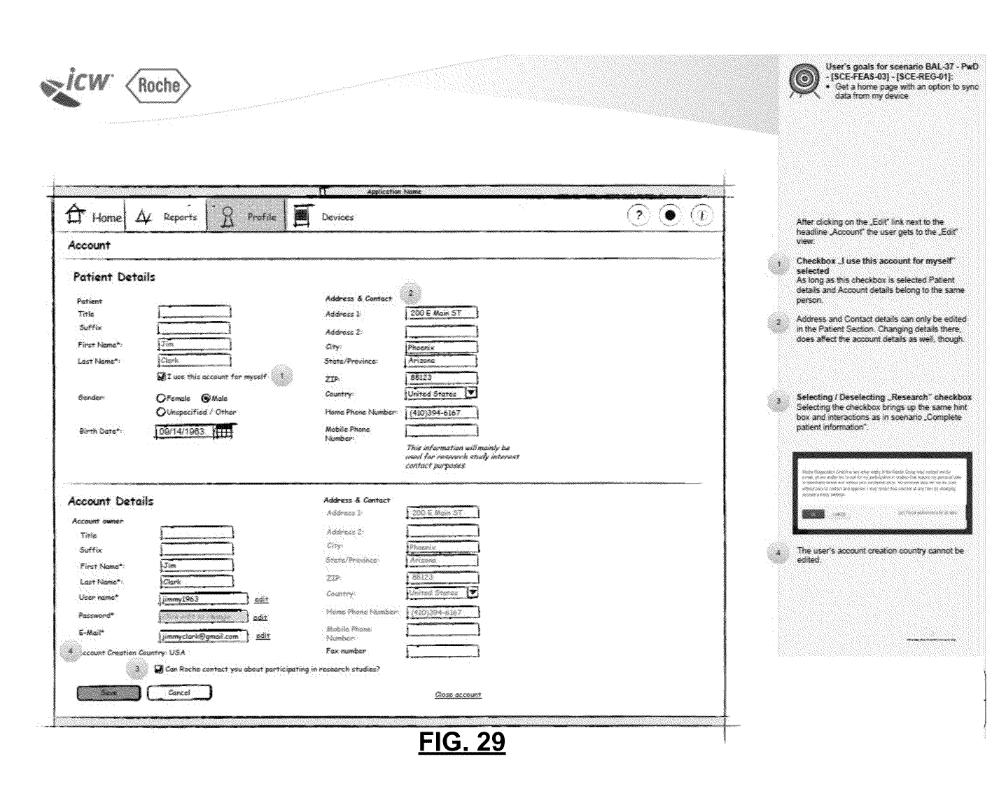

Once data has been successfully imported, the user may be prompted to enter patient data. FIGS. 26, 27, 28, and 29 include example GUIs for entry of the patient data. The patient data may include, for example, first name, last name, an indicator of whether the user uses the created account for him or herself, address, city, state, zip code, country, and phone number information. It should be understood that a patient and a user most likely will be the same individual. However, there may be various instances where an adult or care-giver is entering information on behalf of a child or other individual under their control or supervision. Thus, this information may be solicited. FIG. 28 includes an example GUI for entry of patient data once the user has indicated that the user will use the created account for him or herself. One or more options for optimizing the user's experience may also be displayed, such as gender, date of birth, type of diabetes, and type of therapy. An option for the user's data to be included in one or more research studies may also be included, as shown in FIGS. 27 and 29. As shown in FIG. 28, the user may edit the user name, password, or email for the account.

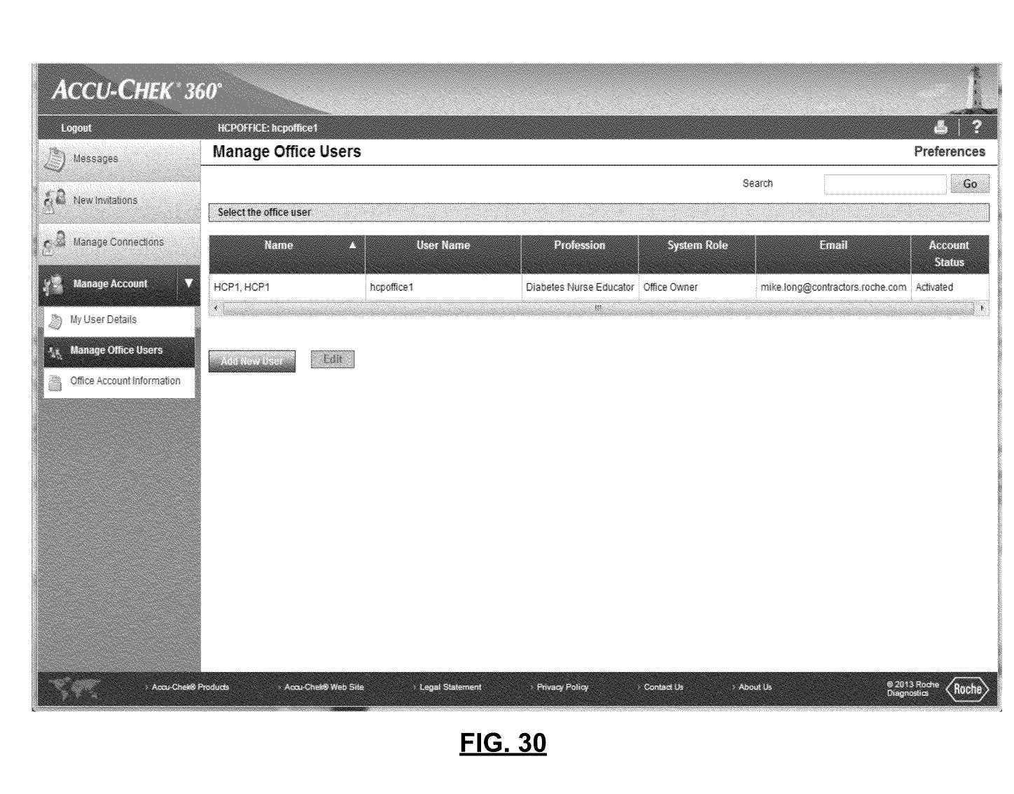

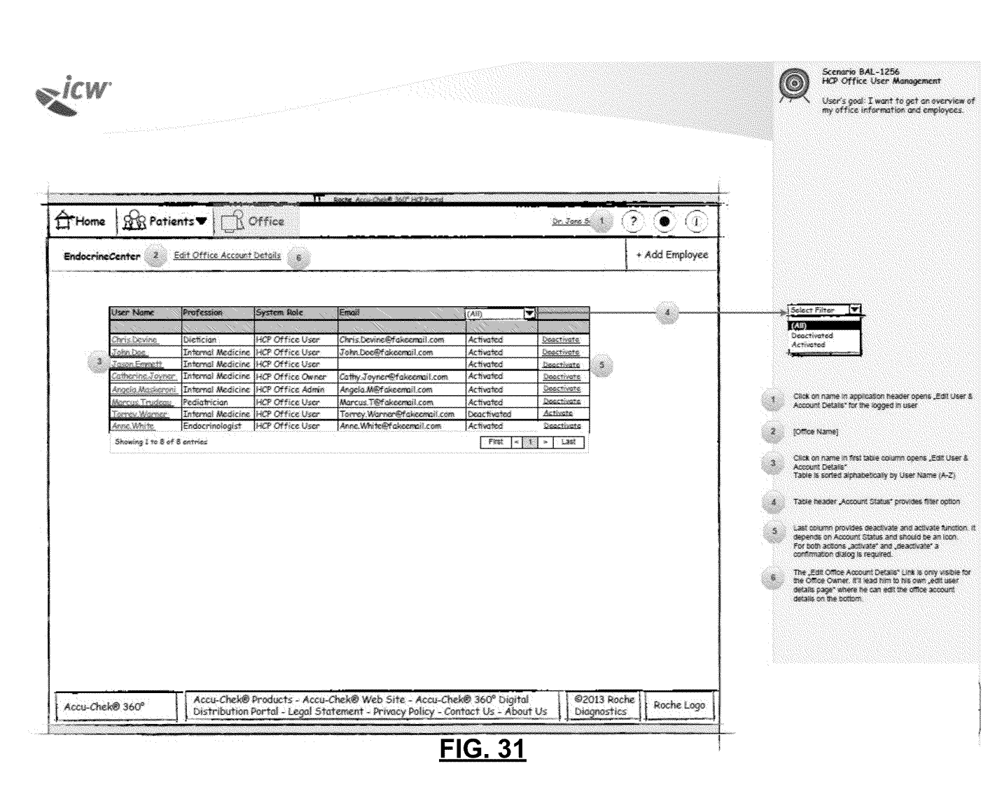

FIGS. 30 and 31 illustrate an example GUI when a manage account option has been selected while the user is logged into a healthcare professional account. From this GUI, one or more other authorized users of the healthcare professional account can be added. Additionally, user information for authorized users of the healthcare professional account are shown.

As shown in FIG. 31, clicking on a name in a table application header may enable a filter option. The last column of FIG. 31 may provide an activate/deactivate function, depending on the account status. Certain features may only be operable for an owner or a manager of a healthcare professional office.

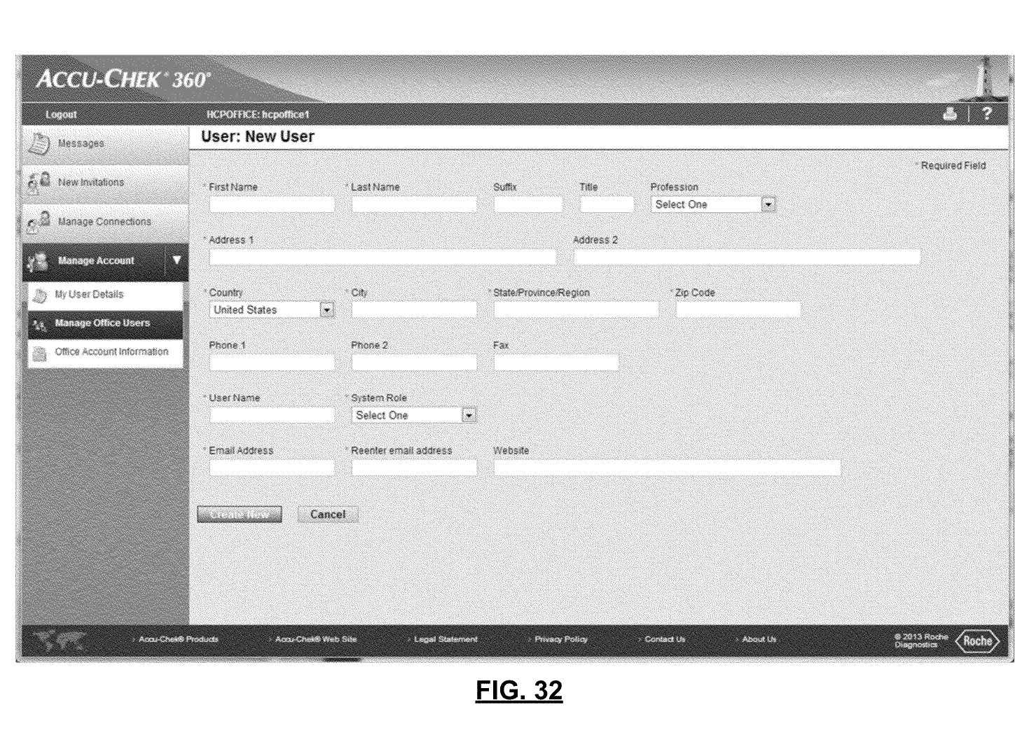

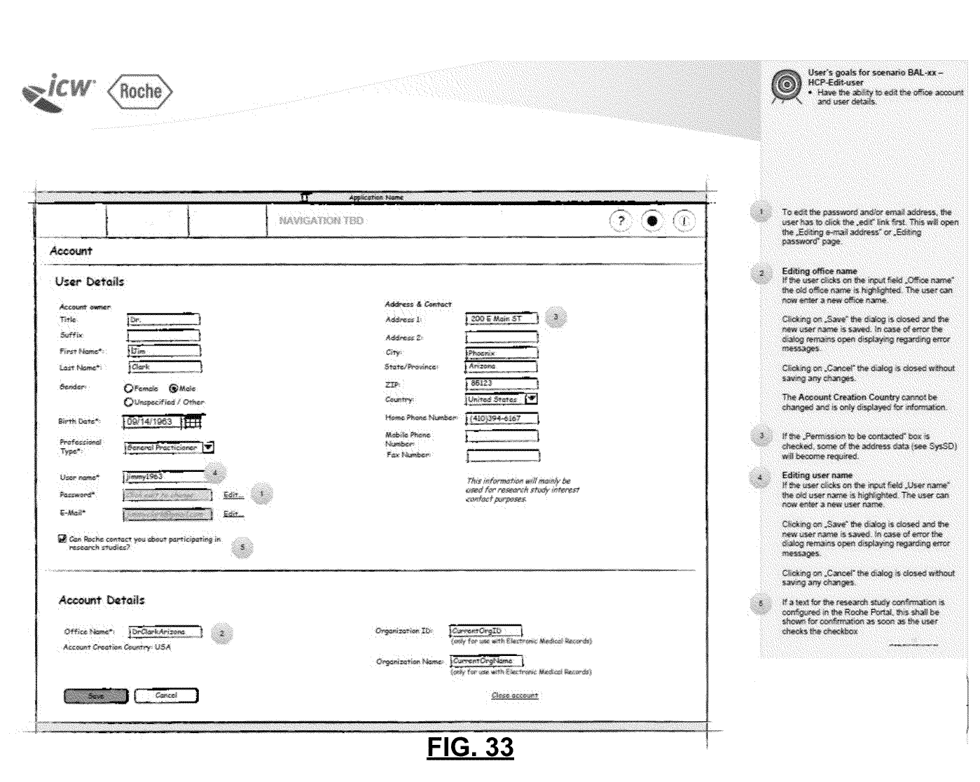

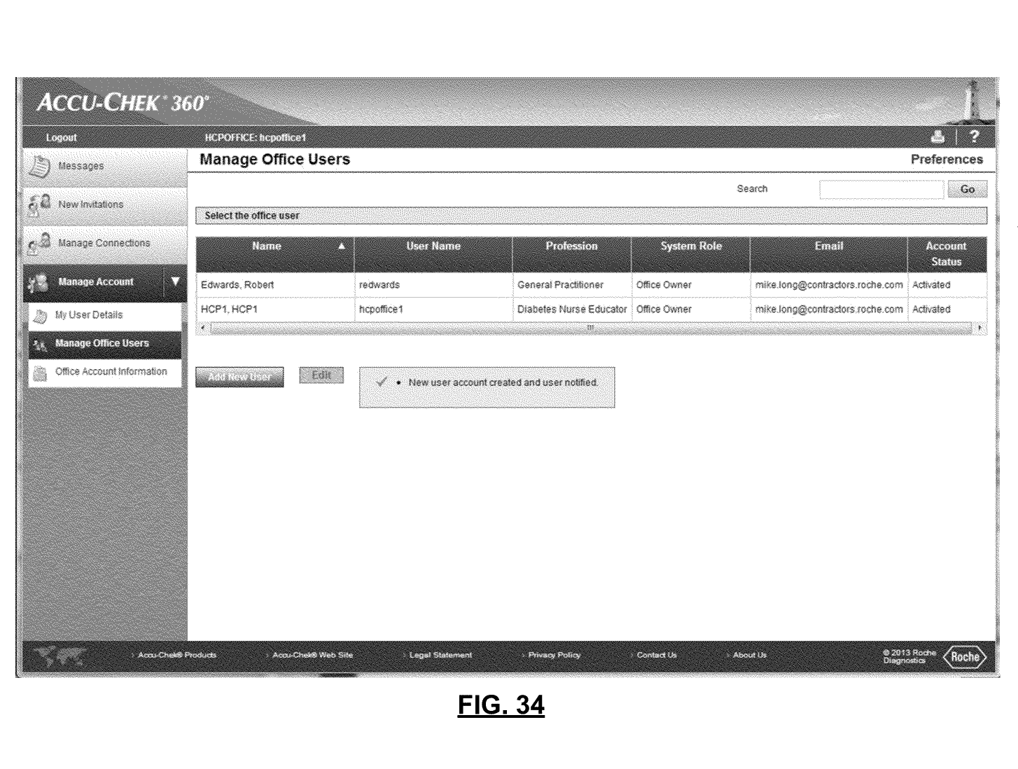

FIGS. 32 and 33 illustrate the feature of adding a new authorized user to a healthcare professional account. Various information can be edited based on menu selections and the entry of new text. Certain account details can only be edited by users with the correct/appropriate role or credentials (e.g., office owner or manager). Other users can see the information as read-only. Once the information is saved, an alert is provided as indicated in FIG. 34 and the server computer 18 sends an email to the new user to notify the new user of their ability access the healthcare professional account.

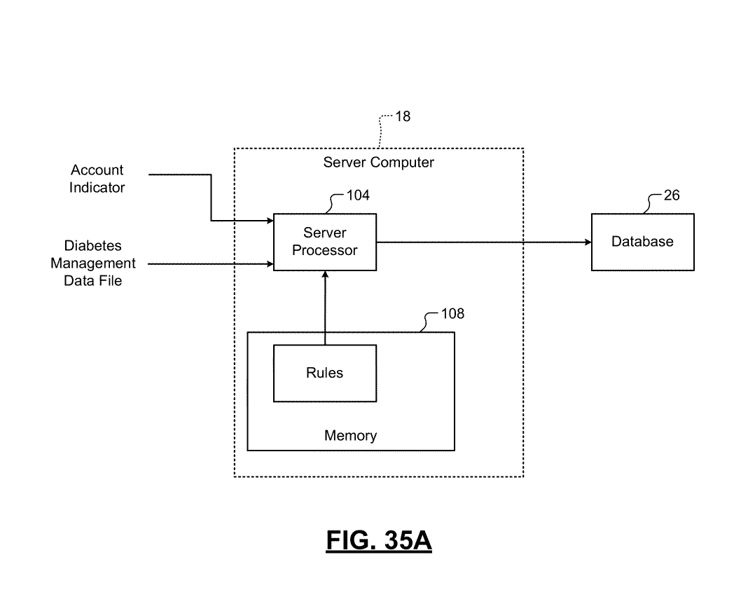

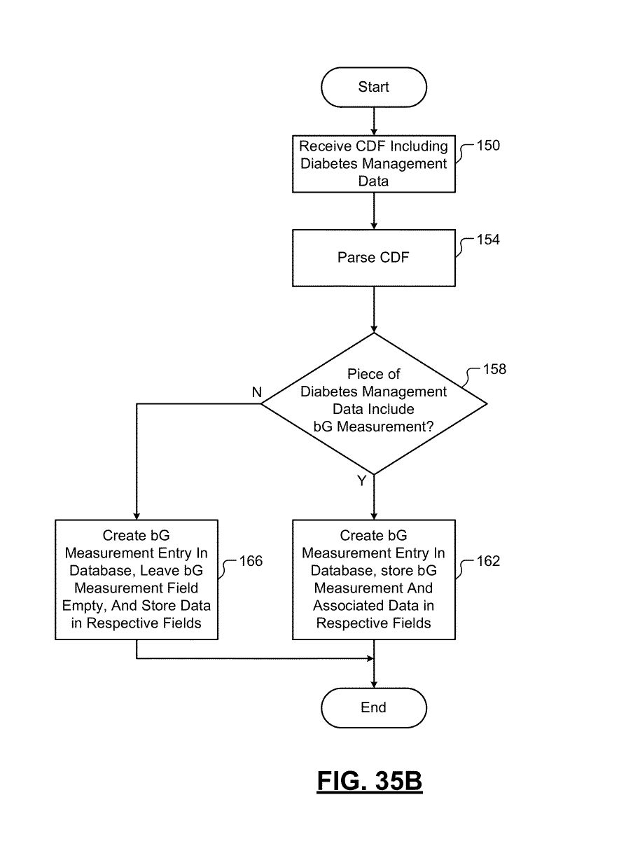

FIG. 35A includes an example block diagram of an example system including the server computer 18 and the database 26. As stated above, the server computer 18 includes one or more processors, such as server processor 104. The processor(s) apply predefined rules to uploaded diabetes management data for storing diabetes management data in the database 126 in association with the account. The predefined rules are stored, such as in memory 108. The rules and application of the rules is described in detail below.

Files uploaded to the server computer 18 are written by diabetes management devices using a common data format (CDF). CDF is a diabetes care patient centric extensible markup language (XML) based data format defined for the DMS. The server computer 18 determines whether files uploaded to the server computer 18 comply with rules for uploaded files.

The server computer 18 also formats uploaded diabetes management data for use in a logbook. Discussion of the logbook is discussed further below. Regarding formatting uploaded diabetes management data for use in the logbook, the server computer 18 identifies different types of diabetes management data uploaded to the server computer 18 for storage in association with an account. One type of data includes bG measurements. A plurality of other types of data can be provided for each bG measurement taken and may help explain trends or other relevant bG measurement changes.

For example, other types of data include basal insulin dosage and insulin total daily dose (TDD), blood pressure (systolic and diastolic), hbA1c measurement, pulse, body temperature, weight, medication, bolus insulin advice given to the patient, whether that advice was accepted or not, amount of meal bolus insulin, and amount of correction bolus insulin. The other types of data can also include carbohydrate intake advice, whether that advice was accepted or not, corresponding insulin bolus, carbohydrates and calories, bG control data, energy level of the patient, emotional state of the patient, health state of the patient, event before and after data, events (e.g., exercise), one or more notes, and/or other data. Even one or more pieces of the data was not included in the uploaded file, the user can add and/or edit stored data.

For various different types of data identified in uploaded diabetes management data that are not bG measurements (e.g., insulin administered, carbohydrate intake, calorie intake, etc.), the server computer 18 creates bG measurement entries. The server computer 18 leaves fields for those bG measurements entries empty and stores the uploaded diabetes management data in association with the entries. When the account is later accessed, the user can therefore enter bG measurements that are left empty.

When accessing the account, the server computer 18 generates information to be displayed to the user via a computing device based on the bG measurement entries. For example, based on the bG measurement entries, the server computer 18 may generate one or more statistical values for display to the user.

FIG. 35B includes a flowchart depicting an example method of applying selected ones of the rules that may be performed by the server computer 18. At 150, the server computer 150 receives a CDF file including diabetes management data for an account. At 150, the server computer 18 parses the CDF file to identify diabetes management data included in the CDF file.

At 158, the server computer 18 selects a piece of the diabetes management data and determines whether that piece of diabetes management data includes a bG measurement. Example types of diabetes management data that may or may not include a related bG measurement include, for example, an amount of insulin administered (e.g., by syringe or pump), a carbohydrate intake, a calorie intake, advice given (e.g., insulin, carbohydrate or calorie), and other types of diabetes management data. If 158 is true, the server computer 18 may continue with 162. If 158 is false, the server computer 18 may continue with 166.

At 162, the server computer 18 creates a new bG measurement entry for the account in the database 26. The server computer 18 also stores the bG measurement in a field for the bG measurement in the new bG measurement entry. The server computer 18 also stores other different types of related data to the bG measurement entry in fields for those types of data in the new bG measurement entry.

At 166, when the piece of diabetes management data does not include a bG measurement, the server computer 18 creates a new bG measurement entry for the account in the database 26. The server computer 18, however, leaves the field for a bG measurement in the new bG measurement entry blank. In this manner, a user of the account can later add a bG measurement into that bG measurement entry. The server computer 18 also stores other different types of related data to the bG measurement entry in fields for those types of data in the new bG measurement entry. As described further below, the server computer 18 generates user interfaces for displaying data for the account based on bG measurement entries. While the example of FIG. 35B illustrates ending after 162 or 166, 158 and 162 or 166 may be performed for multiple different pieces of diabetes management data.

Further description of rules that are applied by the server computer 18 will now be described. For example, the server computer 18 may not discard an entire uploaded file including diabetes management data if the uploaded file includes one or more elements that are not addressed under one or more rules. Before validating diabetes management data uploaded to it, the server computer 18 executes each transformation rule described below. However, the server computer 18 validates uploaded data as received unless a transformation is to be performed.

When the server computer 18 receives data that applies to one or more validation rules, the server computer 18 stores all data as received unless a transformation is to be performed. When the server computer 18 creates data, the server computer 18 stores logbook data so that the validation rules apply. When the server computer 18 receives data to be stored in the database 26, the server computer 18 validates that the following types of data are within predefined ranges and rejects data that falls outside of the predefined ranges: bG measurements and insulin pump bolus amounts; text fields; and dates.

When the server computer 18 receives data via an association with a personal (patient) account and the patient element of a piece of diabetes management data does not have an identifier (ID), the server computer 18 sets the IDs of the patient element to the IDs associated with the association that was used to send the diabetes management data. When the server computer 18 receives result data that does not include an ID, the server computer 18 creates a new data entry instance ID and assigns that new ID to the result. When the server computer 18 receives a patient event that does not have an ID, the server computer 18 creates a new data entry instance ID and assigns that new ID to the patient event. When the server computer 18 receives result comment data that does not include an ID, the server computer 18 creates a new data entry instance ID and assigns that new ID to the result comment. When the server computer 18 receives a diabetes management device flag that does not have an ID, the server computer 18 creates a new data entry instance ID and assigns that new ID to the device flag.

When the server computer 18 receives result data that is sent directly from a diabetes management device 28, the server computer 18 sets the ID of the patient element to the index ID patient from the account associated with the association that was used to send the result data. The server computer 18 moves device flags received in an uploaded file to a device flags portion associated with the account.

When the server computer 18 receives top level results with one of the following result types containing related results (i) syringe insulin, (ii) insulin pump bolus (e.g., standard, extended, or multiwave), (iii) carbohydrates or calories, (iv) advice (e.g., total bolus advice, carbohydrate advice), the server computer 18 moves any related results as related results under a new empty top level bG measurement and combines them on the same level as the original top level result. When the server computer 18 moves top level results under a new top level bG measurement and the original top level results contains one or more results qualifiers, the server computer 18 moves any results qualifiers that do not belong to that result type from the original top level result to the new empty top level bG measurement. When the server computer 18 moves top level results under a new top level bG measurement and the original top level results contains one or more patient events, the server computer 18 moves any patient events that are related to the original top level result to the new top level bG measurement. When the server computer 18 moves top level results under a new top level bG measurement and the original top level result contains a comment, the server computer 18 moves any result comment that is related to the original top level result to the new top level bG measurement. Top level bG measurements correspond to logbook entries. Diabetes management data stored under a top level bG measurement corresponds to one logbook entry.

When the server computer 18 moves top level results under an empty top level bG measurement, the server computer 18 stops processing an uploaded file if any other rules are violated.

When the server computer 18 receives syringe insulin data as a top level result, the server computer 18 moves the syringe insulin data to a new top level bG measurement. When the server computer 18 receives insulin pump bolus data of standard or extended type as a top level result, the server computer 18 moves that data to a new top level bG measurement.

When the server computer 18 receives multiwave insulin pump bolus results as a top level result, the server computer 18 moves an insulin pump bolus of type multiwave (standard part) and insulin pump bolus of type multiwave (extended part) that fulfill predetermined conditions, as related results under the same top level bG result. The predetermined conditions include being sent one after the other as top level results, both having the same result date, and having predetermined results qualifiers. When the server computer 18 receives multiwave insulin pump bolus results as a top-level result, the server computer 18 moves an insulin pump bolus of type multiwave (standard part) for which no corresponding extended part result has been received as related results under a new top level bG result and creates an additional related result for the missing extended part.

When the server computer 18 receives multiwave insulin pump bolus results as a top level result, the server computer 18 moves an insulin pump bolus of type multiwave (extended part) for which no corresponding standard part result has been received as related results under a new top level bG result and creates an additional related result for the missing standard part. When the server computer 18 receives multiwave insulin pump bolus results as a top level result, the server computer 18 will accept an insulin pump bolus of type multiwave (extended part) as a top level result and not move it as a related result under a new empty top level bG result. When the server computer 18 receives an insulin pump bolus as a top level result including additional result qualifiers, the server computer 18 moves any result qualifier included in a pump bolus other than predetermined types of qualifiers up to the empty top level (parent) bG result.

When the server computer 18 receives carbohydrate data as a top level result, the server computer 18 moves the carbohydrate data as a related result under a new top level bG result. When the server computer 18 receives calories data as a top level result, the server computer 18 moves the calories data as a related result under a new top level bG result. When the server computer 18 receives carbohydrate or calories data as a top level result including additional result qualifiers, the server computer 18 moves any included result qualifiers up to the empty top level (parent) bG result.

The server computer 18 may receive from a diabetes management device 28 total bolus advice data and/or carbohydrate advice data as top level results. In conjunction with sending total bolus advice data as a top level result, the server computer 18 may receive from a diabetes management device 28 related results including bG correction bolus data and/or meal correction bolus data.

When the server computer 18 receives total bolus advice data as a top level result, the server computer 18 moves the total advice data as a related result under a new top level bG result. When the server computer 18 receives total bolus advice data as a top level result and the total bolus advice data includes additional result qualifiers, the server computer 18 moves the included result qualifiers under the new top level bG result with the total bolus advice data.

When the server computer 18 receives total bolus advice data as a top level result along with a related bG correction bolus, the server computer 18 moves the total bolus advice data and the bG correction bolus as related results under the same top level bG result. When the server computer 18 receives total bolus advice data as a top level result along with a related meal correction bolus, the server computer 18 moves both the total bolus advice data and the meal correction bolus under the same top level bG result.

When the server computer 18 receives advised carbohydrate data as a top level result without any related results, the server computer 18 moves the advised carbohydrate data as a related result under a new top level bG result. When the server computer 18 receives advised carbohydrate data as a top level result along with one or more result qualifiers, the server computer 18 moves results qualifiers up to the (parent) top level bG result.

When a bG result is received, the server computer 18 removes flags included with the bG result that indicate that timing of the bG result was before or after a snack event.

When the server computer 18 receives a bG measurement flagged with an asterisk on a diabetes management device and the bG measurement does not already include a meal event flag, the server computer 18 replaces the meal event flag with the meal event that is assigned to the flag in the patient settings of the associated account. When the server computer 18 receives a bG measurement flagged with an asterisk on a diabetes management device and the bG measurement does include a meal event flag, the server computer 18 removes data from the bG measurement and continues. When the server computer 18 receives a bG measurement with any additional result qualifiers of a predetermined type, the server computer 18 removes predetermined data from the bG measurement and continues.

When the server computer 18 receives a global unique identifier (GUID) for a meal event flag from a diabetes management device and the bG measurement does not already include a meal event flag, the server computer 18 replaces the GUID based on the following table.

Meal Event Flags

| | | |
|---|---|---|
| Before Meal | FD9890D42ED84E848EE739B5F51EF3B0 | cdf.resq.timing.meal.before |
| After Meal | 622E4CAD438441BD8380AD64C1DA2055 | cdf.resq.timing.meal.after |
| Fasting | 918A3F1EAD24425689E52CA6F340F7AF | cdf.resq.timing.fasting |
| Before Breakfast | 98AD9A792DEA475AA69088260381ECC5 | cdf.resq.timing.breakfast.before |
| Before Breakfast | AF84FD99EFC849EE8190374F4AB24224 | cdf.resq.timing.breakfast.before |
| (Focused Testing Qualifier) | | |
| After Breakfast | 2BF51BD8C31D43FD89DFB08744F23CAC | cdf.resq.timing.breakfast.after |
| After Breakfast | AF84FD94FDA54DB19DC3A50CE194D181 | cdf.resq.timing.breakfast.after |
| (Focused Testing Qualifier) | | |
| Before Lunch | C6D7055F419D4227ADF645D6F5C98798 | cdf.resq.timing.lunch.before |
| Before Lunch | AF84FD9529B84CD3AFD281DE346D63DD | cdf.resq.timing.lunch.before |
| (Focused Testing Qualifier) | | |
| After Lunch | E6775F9C9DF542F1A188D561FC8E725C | cdf.resq.timing.lunch.after |
| After Lunch | AF84FD9D517C4F6CAF34DB2094A6A906 | cdf.resq.timing.lunch.after |
| (Focused Testing Qualifier) | | |
| Before Teatime | 68D6241E070C441686165E1A776F17B8 | cdf.resq.timing.teatime.before |
| After Teatime | 5923EF261B8C4971BDAF7323CD41564B | cdf.resq.timing.teatime.after |
| Before Dinner | 0079ACE381564EF0BFBADACBE913C5DA | cdf.resq.timing.dinner.before |
| Before Dinner | AF84FD956784435CBC80A5923CFD49EF | cdf.resq.timing.dinner.before |
| (Focused Testing Qualifier) | | |
| After Dinner | 587FED7C427D4649A7D6F0879279A28C | cdf.resq.timing.dinner.after |
| After Dinner | AF84FD99E180457F8F852112AA70900E | cdf.resq.timing.dinner.after |
| (Focused Testing Qualifier) | | |
| Bedtime | 0A9FDD90A9514F5D9F0CB6EC901F3F01 | cdf.resq.timing.bedtime |
| Bedtime | AF84FD9F3EF544D1A7490362CBDBC1B5 | cdf.resq.timing.bedtime |
| (Focused Testing Qualifier) | | |
| Midsleep | BBB680B72A7647C99A85384D660E1BCD | cdf.resq.timing.midsleep |
| Other | 92A7845930894F75B824FF9CEEDD6F35 | cdf.resq.timing.other |

When the server computer 18 receives a GUID for a meal event flag from a diabetes management device 28 and the bG measurement does already include a meal event flag, the server computer 18 stores the meal event flag as is. When the server computer 18 receives a GUID for a meal event flag from a diabetes management device 28 and the GUID is for either for before or after a snack, the server computer 18 removes the meal event flag and continues. When the server computer 18 receives GUID for a meal event flag from a diabetes management device 28 and the meal event flag is set for fasting, the server computer 18 replaces the GUID with a meal event flag for fasting if the bG measurement does not include another meal event flag to be used for the replacement.

When the server computer 18 receives a GUID for energy level from a diabetes management device 28 and a bG measurement does not already include an energy level, the server computer 18 replaces the GUID for the energy level based on the table below.

Energy Level

| | | |
|---|---|---|
| High (Focused | AF84FD9B31EC40019BEFCA4FC207D1E1 | cdf.resq.state.energy.high |
| Testing Qualifier) | | |
| Medium High (Focused | AF84FD9CB0A64217B558041BB35752C0 | cdf.resq.state.energy.medium.high |
| Testing Qualifier) | | |
| Medium (Focused | AF84FD9555BB49609A4D0855AB2E61AA | cdf.resq.state.energy.medium |
| Testing Qualifier) | | |
| Medium Low (Focused | AF84FD950A3B4F95A19801AEE7500402 | cdf.resq.state.energy.medium.low |
| Testing Qualifier) | | |
| Low (Focused | AF84FD98EE4C4F7D83BA560B25D0085B | cdf.resq.state.energy.low |
| Testing Qualifier) | | |

When the server computer 18 receives a GUID for energy level from a diabetes management device 28 and a bG measurement already includes an energy level, the server computer 18 removes the GUID for the energy level and continues.

When the server computer 18 receives a GUID for meal size from a diabetes management device 28 and a bG measurement does not already include a meal size, the server computer 18 replaces the replaces the GUID for the meal size based on the table below.

Meal Size

| | | |
|---|---|---|
| Large (Focused | AF84FD953BAF43C0ACEEA46FDCDF831B | cdf.resq.state.meal.large |
| Testing Qualifier) | | |
| Medium (Focused | AF84FD91C6F94523A477BBA9A50D4036 | cdf.resq.state.meal.medium |
| Testing Qualifier) | | |
| Small (Focused | AF84FD9B3BC440698AB574B8817E2AF1 | cdf.resq.state.meal.small |
| Testing Qualifier) | | |
| None (Focused | AF84FD9593094531BE9E03494F4119A6 | cdf.resq.state.meal.none |
| Testing Qualifier) | | |

When the server computer 18 receives a GUID for meal size from a diabetes management device 28 and a bG measurement does already include a meal size, the server computer 18 removes the GUID for the meal size and continues.

When the server computer 18 receives logbook assignment data with a reference to a non-bG result or a patient event that does not include a type attribute, the server computer 18 sets a missing reference type to a predetermined type, such as local. When the server computer 18 receives logbook assignment data with more than one medication, the server computer 18 keeps the first medication of the logbook assignment data and deletes the additional medication references from that logbook assignment, but keeps the medication references as independent entries.

When the server returns a CDF file as a reply to a service interface request, the server computer 18 includes data origin information in the CDF document including a URL, a name, and an identity. The data origin information may include an identifier of a last record loaded to the device to a device data client in a predetermined location in the CDF file. The data origin information may also include a date that the last record was loaded from the device to the device data client in a predetermined location in the CDF file. When the server computer 18 receives a CDF file from a diabetes management device or a device transfer component, the server computer 18 only accepts CDF files that have a device type, a model identifier, a model name, and a serial number.

When the server computer 18 receives a CDF file from a diabetes management device 28 or a device transfer component 32 via a device interface request, the server computer 18 only accepts data origin information that is consistent with the device associated with the association that is used to send the CDF file. The server computer 18 only accepts data from a device transfer component 32 if the device information in CDF file is identical with the device information of the association used to send the data. The serial number of a device should comply with predetermined rules.

A device type included in a CDF file of a bG meter should indicate bG meter. A device type included in a CDF file of an insulin pump should indicate insulin pump. A device type included in a CDF file of a device transfer component should indicate device transfer component.

When the server computer 18 receives a CDF file in the context of a data synchronization function or a data import/upload function, the server computer 18 only accepts data origin information in a predetermined format. Data entered manually into a diabetes management device 28 and included in a CDF file should include an indicator that the data was entered manually. Data that was generated by a diabetes management device 28, such as advice information, should include an indicator that the data was generated by the device.

The server computer 18 accepts data definitions in CDF files for predefined emotional states, predefined and custom health states, predefined and custom exercise types, predefined and custom medications, predefined and custom insulin types, and predefined device warnings. The server computer 18 also accepts data definitions in CDF files for basal profiles.

The server computer 18 does not accept user-defined (custom) data definitions for energy levels, meals, control, bolus type, basal flag, basal temperature flags, statistics, advice, and timing. The server computer 18 does not accept definitions for event qualifier types including severity, intensity, and body regulation.

The server computer 18 does not accept definitions for result qualifiers that include custom names that are longer than a predetermined length, such as longer than 128 characters. The server computer 18 does not accept definitions for event qualifiers that include custom names that are longer than a predetermined length, such as longer than 128 characters. The server computer 18 does not accept definitions for medications that include custom names that are longer than a predetermined length, such as longer than 30 characters. The server computer 18 does not accept data definitions for custom health care professionals, custom ethnicity types, custom data types, and custom device parameter types.

For the purpose of data identify and synchronization of changes in data records, CDF-based data messages include root and extension attributes on elements that represent globally unique identification. For example, a patient, a result, a result comment, a patient event, or a device flag may have an object identifier in the following attributes: root—typically object identifier (OID) assigned for system or database instance; and extension—typically a unique ID of the record in the system or database instance.

When the originating system has the capacity to create and maintain universally unique identifiers for data records, the system that creates data items should assign root and extension attributes. Each participating system may remember the root and extension received for records from other participating systems. Each participating system may use the original root and extension when communicating data elements with any other participating system. The server computer 18 does not accept elements under a data definition portion of a CDF file that includes root or extension attributes.

When a user accesses their account via the server computer 18 and manually enters data, the server computer 18 assigns a new unique identifier to the manually entered data. OIDs may be assigned based on a manufacturer of the product. The server computer 18 only accepts root and extension attributes if they are correctly formatted, such as using a sequence of integer values separated by dots. Correct formatting may be defined by, for example, a HL7 OID convention. The server computer 18 may expect that transmitting devices convert for proper formatting.

The server computer 18 accepts results and patient events that include valid date and time information. When the server computer 18 receives data without date and time information, the server computer 18 may store the data in the database 26, but may mark that data as either having an invalid date and/or time or mark the data for deletion.

The server computer 18 may accept results and patent events including date and time information having a predetermined format, such as a time and date standard of the international organization for standardization (ISO). For example, the predetermined format may be YYYY-MM-DDThh:mm:ss, where Y indicates year, M indicates month, D indicates date, h indicates hour, m indicates minute, and s indicates second. The predetermined format may also include an optional time zone designator. In various implementations, the time and date information may be in separate data elements. If provided in separate data elements, the server computer 18 may store data missing one or more of the pieces of date and time information, but mark that data with an invalid date and/or time. The server computer 18 may reject data that includes multiple pieces of date and time in one element but separate pieces of date and time information in separate elements (e.g., YYYY-MM-DD in one data element and hh, mm, and ss in separate data elements or YYYY, MM, and DD in separate data elements while hh-mm-ss are in one data element).

Every result or patient event has data elements including an “is edited” element, an “is annotated” element, and may include a change attribute. The root, extension, and change attributes can be used to given an element a unique name to be able to identify that element afterwards and to indicate if an already existing element has been changed or deleted.

For example, when the server computer 18 receives data, a patient, result, result comment, patient event, or device flag may have a change attribute to create, update, or delete data objects. New may indicate a request to create a new data object. Updated may indicate a request to update an already existing data object. Deleted may indicate a request to delete an already existing data object. Change may indicate a request to update an already existing data object (e.g., change down for the result if the related result command should be updated). The server computer 18 may only accept data objects with a change attribute if the data object also includes valid identifier in the root and extension attributes. The server computer 18 ignores change attributes for data definition elements.

For new data objects to be stored in the database 26, the sending system sets the change attribute to new. For data objects already stored in the database 26 that need to be updated, the sending system sets the change attribute to updated. For data objects already stored in the database 26 that need to be deleted, the sending system sets the change attribute to delete. For data objects already stored in the database 26 for which one or more related objects need to be updated, the sending system sets the change attribute to change down.

The server computer 18 rejects objects with the change element set to undeleted. The server computer 18 does not return an error to a sending system of a data object is ignored by the server computer 18 because a request by the sending system is a duplicate or violates a rule. The server computer 18 only accepts a request to delete a bG result that is part of a structure test if the structure test is also deleted.

When the server computer 18 receives data via an association with a personal (patient) account and the patient element does not have an identifier, the server computer 18 only accepts the patient data if the change attribute is set to change down.

For new data to be stored in the database 26, the sending system sets the “is edited” and “is annotated” flags/elements for that data to “No.” This is regardless of the data source, regardless of whether it was created manually or downloaded from a diabetes management device, and regardless of whether it is a top level result or a related result. When the data value of data stored in the database 26 is changed, the server computer 18 changes that data's “is edited” element to “Yes” to indicate that it has changed. The server computer 18 may leave the “is edited” element of a parent bG result set to “No” when only a related result is updated.

For exercise data, the server computer 18 may set the “is edited” element to “Yes” if the exercise type, duration, or intensity has been changed. The server computer 18 may leave the “is edited” element of exercise data set to “No” if only a related exercise element is changed.

Regarding the “is annotated” element, changes in relates results of an event affect the “is annotated” element, while the “is edited” element will remain unchanged. For example, when an already existing bG result is stored, the server computer 18 changes the “is annotated” element from “No” to “Yes” when one or more related results are added for that bG result, such as insulin bolus, carbohydrates, and/or calories. The server computer 18 changes the “is annotated” element from “Yes” to “No” when all related results are removed from a bG result.

When an already existing bG result is stored, the server computer 18 changes the “is annotated” element from “No” to “Yes” when one or more result qualifiers are added, updated, or removed for that bG result. When an already existing bG result is stored, the server computer 18 changes the “is annotated” element from “No” to “Yes” when one or more comments are added, updated, or removed for that bG result. For existing results other than bG results, the server computer 18 may maintain the “is annotated” element for those results at “No” when one or more comments are added, updated, or removed for that result.

The server computer 18 does not accept any data when a client uses a device results option to send data to the server computer 18 under a results element and under a patient element of the same CDF file. The server computer 18 does not accept any data of a CDF file if the CDF file includes any of the following elements: patient medical data, patient personal data, blocks of time, groups, work week, external patient identifiers, patient identify, primary health care professional, health care professional, devices, or therapies. When a client sends health data to a personal account using a patient option, the server computer 18 only accepts data if the patient ID provided in the root, extension, and global ID elements matches the ID of the patient associated with the personal account that was returned to the client during the create associations process.

The server computer 18 accepts only the following results as top level results: bG results, basal insulin from an insulin pump, vital signs and lab analytics, and total daily dose. The server computer 18 may accept the extended part of a multiwave bolus as a top level result if it includes a stop qualifier.

The server computer 18 only accepts medication events as top level patient events. The server computer 18 may accept related results for a top level result when the top level result is either a bG result or a blood pressure result. The server computer 18 does not accept results or patient events that include a visitation note, and does not accept results that include an add on value.

The server computer 18 expects that bG results will include the following data elements and values: an indicator that it is a measurement; an indicator that the measurement is of bG; the bG value; a date and time that the value was measured; an indicator of the device that measured the bG; a “has value” element; and the “is edited” and “is annotated” element. The server computer 18 rejects bG results that includes a duration, a slot ID, or an indicator of administered medication.

bG results may include result qualifiers for: bG control indicator; a high or low bG indicator; an out of sequence indicator; a flagged with an asterisk on the device indicator; a results flag from the device; a predefined meal event indicator; a predefined emotional state indicator; a predefined or custom health state indicator; a predefined energy level indicator; and a predefined or custom device warning indicator. The server computer 18 may reject bG results that include a results qualifier other than those listed above. The server computer 18 may also reject an empty bG result that serves as a grouping element and has no bG value but does have one or more related results. The server computer 18 may accept related results to a bG result including carbohydrates related results, calories related results, insulin bolus related results, and advice (bolus and carbohydrate) related results.

A bG result may include exactly one meal time event as a result qualifier. The meal time event may be before a meal, after a meal, before breakfast, after breakfast, before lunch, after lunch, before tea time, after tea time, before dinner, after dinner, bedtime, midsleep, fasting, or other.

When a bG result has been downloaded from a diabetes management device 28, a bG result may include one or more results flags from the device. The server computer 18 may ignore a bG result and skip it and all related results when the bG results includes a deleted or not set result flag.

A control bG result includes a control indicator, and may include one of the following control levels: control level 1, control level 2, or control level 3. The server computer 18 rejects results other than bG results that include a control indicator.

A bG result with a HI indicator also includes a result qualifier indicating that the bG value of that bG result is above a predetermined range. The server computer 18 rejects bG results that include both a HI and a LO indicator. The server computer 18 rejects results other than bG results that include HI or LO indicators. A bG result with a LO indicator also includes a result qualifier indicating that the bG value of that bG result is below the predetermined range. The server computer 18 also rejects results other than bG results that include an out of sequence indicator.

bG results may also include one or more additional results flags from the diabetes management device 28 stored as result qualifiers, such as used drum, expired strips, invalid result, or other's result. The server computer 18 rejects results other than bG results that include one of these additional results flags.

A bG result may include information about the emotional state of the patient in the form of a result qualifier, such as happy, sad, confused, guided, scared, calm, supported, frustrated, worried, or positive. The server computer 18 rejects bG results including more than one emotional state.

A bG result may include a predefined health state, such as illness, stress, or premenstrual. A bG result may include a user defined health state using a custom result qualifier. The server computer 18 rejects bG results having improperly defined health states.

A bG result may include a predefined energy level, such as low, medium-low, medium, medium-high, or high. The server computer 18 rejects bG results having an energy level that is not one of the predetermined energy levels or that has multiple energy levels.

A bG result may include an additional comment. The server computer 18 may reject comments that are longer than a predetermined length, such as 300 characters.

The server computer 18 accepts insulin bolus results having one of the following types: syringe insulin bolus 1, syringe insulin bolus 2, syringe insulin bolus 3, or insulin pump bolus. The server computer 18 only accepts insulin bolus as related results of a bG result. The server computer 18 accepts insulin bolus results that are related to empty bG results.

Insulin bolus results may include a predetermined type of insulin, such as 10/90, 20/80, 25/75, 30/70, 40/60, 50/50, 60/40, 70/30, 75/25, 80/20, 90/10, Apidra, Glargine, Humalog, Humalog Mix 25, Humalog mix 50, Lantus, Lente, Levemir, NPH, Novamix 30, Novolog, NovoRapid, regular, Ultralente, Generic Bolus, or Generic Basal. Insulin bolus results may alternatively include a user defined insulin type.

Syringe insulin bolus 1 results include the following elements and values: an indicator that the value is a measurement; an indicator that the data is an insulin dosage; the amount of the dosage; a slot ID (slot 1); a date and time of the insulin intake; a type of device that measured the insulin; a “has value” element, and “is edited” and “is annotated” data elements. Syringe insulin bolus 2 results include the following elements and values: an indicator that the value is a measurement; an indicator that the data is an insulin dosage; the amount of the dosage; a slot ID (slot 2); a date and time of the insulin intake; a type of device that measured the insulin; a “has value” element, and “is edited” and “is annotated” data elements. Syringe insulin bolus 3 results include the following elements and values: an indicator that the value is a measurement; an indicator that the data is an insulin dosage; the amount of the dosage; a slot ID (slot 3); a date and time of the insulin intake; a type of device that measured the insulin; a “has value” element, and “is edited” and “is annotated” data elements. The server computer 18 may reject syringe insulin bolus results that include a duration, results qualifiers, or patient events.

The server computer 18 accepts the following types of pump bolus results: standard bolus, extended bolus, and multiwave bolus. The server computer 18 rejects pump bolus that include both a start and a stop qualifier. A pump bolus may include a result qualifier indicating a meter command indicating that a remote controller (remote to the pump) initiated the bolus on the insulin pump.

A standard insulin bolus result includes the following elements and values: an indicator of a standard bolus insulin injection; the amount of the dosage; a slot ID; a date and time of the insulin intake; a type of device that measured the insulin; a “has value” element; and “is edited” and “is annotated” data elements. The server computer 18 rejects standard bolus insulin results that include a duration, a slot ID, or patient events.

An extended insulin bolus result includes the following elements and values: an indicator of an extended bolus insulin injection; the amount of the dosage; a slot ID; a date and time of the insulin intake; a type of device that measured the insulin; a “has value” element; and “is edited” and “is annotated” data elements. An extended bolus result also includes a start qualifier or a stop qualifier. The server computer 18 rejects extended bolus insulin results that include a slot ID or patient events.

A multiwave bolus result includes both a standard part (result) and an extended part (result). A multiwave bolus standard part includes the following elements and values: an indicator of multiwave insulin injection; the amount of the dosage; a slot ID; a date and time of the insulin intake; a type of device that measured the insulin; a “has value” element; and “is edited” and “is annotated” data elements. A multiwave bolus extended part includes the following elements and values: an indicator of multiwave insulin injection; the amount of the dosage; a slot ID; a date and time of the insulin intake; a type of device that measured the insulin; a “has value” element; and “is edited” and “is annotated” data elements. The server computer 18 rejects multiwave bolus results that include different types of insulin administered. The server computer 18 rejects multiwave bolus standard results that include a duration, a slot ID, or patient events. The server computer 18 rejects multiwave bolus extended results that include a slot ID or patient events.

The server computer 18 accepts only the following basal insulin information: basal rate; and temporary basal (start or stop event). The server computer 18 only accepts basal rates and temporary basal information sent as top level results. The server computer 18 rejects basal insulin profile names that are longer than a predetermined length, such as 128 characters.

A basal rate includes the following elements and values: an indicator of basal injection; the rate of the dosage; a duration of the dosage; a date and time of the insulin intake; a type of device that measured the insulin; a “has value” element; and “is edited” and “is annotated” data elements. A basal rate may also include profile information. The server computer 18 may reject basal rate information that includes a slot ID, administered medication, or patient events.

The server computer 18 accepts the following types of temporary basal information: temporary basal start events; and temporary basal stop events. A temporary basal start event includes the following elements and values: an indicator of temporary basal event; a temporary factor for increasing or decreasing the basal rate; a duration of the temporary increase or decrease; a date and time of the temporary change; a type of device that the temporary data came from; a “has value” element; and “is edited” and “is annotated” data elements. A temporary basal stop event includes the following elements and values: an indicator of a temporary basal event; a temporary factor for increasing or decreasing the basal rate; a duration of the temporary increase or decrease; a date and time of the temporary change; a type of device that the temporary data came from; a “has value” element; and “is edited” and “is annotated” data elements. Temporary basal information may include profile data.

The server computer 18 rejects temporary basal information that includes a slot ID, administered medication, or patient events. Additionally, the state date and time of the temporary basal state event plus the duration of the temporary event should be consistent with the stop date and time of the temporary basal event. Insulin results from pumps may include a result qualifier from the pump indicating that the pump was affected by a pause. The server computer 18 rejects other types of data including an indicator that the device was affected by a pause.

A total daily dose result sent by an insulin pump includes the following elements and values: an indicator that the data is a total daily dose; the amount of the total daily dose as calculated by the insulin pump; the end of the day the TDD was calculated for; the type of pump that the TDD came from; a “has value” element; and “is edited” and “is annotated” data elements. The server computer 18 rejects total daily dose results that include a slot ID, a duration, result qualifiers, administered medication, or patient events.

The server computer 18 accepts only the following advice types: bolus advice, including total advised bolus advice, bG correction bolus advice, and meal correction bolus advice; and advised carbohydrates. The server computer 18 rejects advice information that includes one or more different types of bolus advice and advised carbohydrates advice. The server computer 18 accepts advice information only as related results to a bG result.

A total advised bolus result includes the following elements and values: an indicator of advice regarding total bolus dosage; amount of insulin advised; a type of device that the advice came from; a “has value” element; and “is edited” and “is annotated” data elements. A total advised bolus result may include an indicator of whether the advice was accepted or changed. A total advised bolus result may include an indicator of whether the bolus type was standard, extended, multiwave, or another suitable type. The server computer 18 only accepts bolus advice that includes a bolus type if the bolus type is the same for all related bolus advice results. The server computer 18 rejects bolus advice that includes a duration, a slot ID, administered medication, patient events, or one or more predetermined types of result qualifiers. A total advised bolus result may include information about a type of bolus.

A bG correction bolus result includes the following elements and values: an indicator of advice regarding for a bG correction bolus; amount of insulin advised; a type of device that the advice came from; a “has value” element; and “is edited” and “is annotated” data elements. A bG correction bolus result may include an indicator of whether the advice was accepted or changed. A bG correction bolus result may include an indicator of whether the bolus type was standard, extended, multiwave, or another suitable type. The server computer 18 rejects bG correction bolus results that include a duration, a slot ID, administered medication, patient events, or one or more predetermined types of result qualifiers. A bG correction bolus result may include information about a type of bolus.

A meal correction bolus result includes the following elements and values: an indicator of advice regarding for a meal correction bolus; amount of insulin advised; a type of device that the advice came from; a “has value” element; and “is edited” and “is annotated” data elements. A meal correction bolus result may include an indicator of whether the advice was accepted or changed. A meal correction bolus result may include an indicator of whether the bolus type was standard, extended, multiwave, or another suitable type. The server computer 18 rejects meal correction bolus results that include a duration, a slot ID, administered medication, patient events, or one or more predetermined types of result qualifiers. A meal correction bolus result may include information about a type of bolus.

An advised carbohydrates result includes the following elements and values: an indicator of advice regarding for carbohydrate intake; amount of carbohydrates advised; a type of device that the advice came from; a “has value” element; and “is edited” and “is annotated” data elements. An advised carbohydrates result may include an indicator of whether the advice was accepted or changed. The server computer 18 rejects advised carbohydrates results that include a duration, a slot ID, administered medication, patient events, or one or more predetermined types of result qualifiers.

The server only accepts one of the following meal information elements related to the same bG result: carbohydrates; meal size; and calories. The server computer 18 accepts carbohydrate and calories results that are related to an empty bG result. For an empty bG result, the bG value is set to zero.

A carbohydrates result includes the following elements and values: an indicator of carbohydrate intake; amount of carbohydrates; a date and time of the carbohydrate intake; a type of device that the result came from; a “has value” element; and “is edited” and “is annotated” data elements. The server computer 18 rejects carbohydrates results that include a duration, a slot ID, administered medication, patient events, or one or more predetermined types of result qualifiers.

A meal size result may include a predefined meal size, such as none, small, medium, or large.

A calories result includes the following elements and values: an indicator of calorie intake; amount of calories taken; a date and time of the calorie intake; a type of device that the result came from; a “has value” element; and “is edited” and “is annotated” data elements. The server computer 18 rejects calories results that include a duration, a slot ID, administered medication, patient events, or one or more predetermined types of result qualifiers.

The server computer 18 accepts only exercise results that are patient events of bG results. An exercise result may include one of the following predetermined types of exercise results: walking; running; swimming; bicycling; and weight lifting. An exercise result may alternatively include a user customized exercise type. An exercise result includes the following elements and values; time and date of the exercise; and type of device that the result came from. The server computer 18 rejects exercise results that include event attributes, recurrence, or prescribed medication. An exercise result may include a duration and/or an intensity level. The server computer 18 rejects exercise results with more than one intensity level. The server computer 18 rejects exercise results including more than one exercise type.

The server computer 18 rejects patient events that include one of the following event types: education; office visit; and complication. The server computer 18 only accepts medication results if the patient event was sent as a top level patient event and not part of a result. A medication event includes the following elements and values: a date and time that the medication was taken; the type of device that the result came from; a GUID for the pharmaceutical; a recurrence/interval indicator; a recurrence start date; an indicator of a medication result; a “has value” element; and “is edited” and “is annotated” data elements.

A medication event may also include a recurrence end date. The server computer 18 rejects medication events that include a duration or event qualifiers. A medication event may also include a medication dosage and/or a comment related to the medication. The pharmaceutical may be customized. The server computer 18 rejects medication events that include more than one pharmaceutical.

When exchanging data, the server computer 18 only accepts the following vital signs and lab results: weight; temperature; heart rate; blood pressure; and A1C. The server computer 18 only accepts a weight if the weight result is sent as a top level result.

A weight result includes the following elements and values: an indicator of a weight measurement; the weight; a date and time of the measurement; a type of device that the result came from; a “has value” element; and “is edited” and “is annotated” data elements. The server computer 18 rejects a weight result that includes a duration, a slot ID, results qualifiers, administered medication, or patient events.

The server computer 18 only accepts temperature results sent as top level results. A temperature result includes the following elements and values: an indicator of a temperature measurement; the temperature; a date and time of the measurement; a type of device that the result came from; a “has value” element; and “is edited” and “is annotated” data elements. The server computer 18 rejects a temperature result that includes a duration, a slot ID, results qualifiers, administered medication, or patient events.

The server computer 18 only accepts heart rate results sent as top level results. A heart rate result includes the following elements and values: an indicator of a heart rate measurement; the heart rate; a date and time of the measurement; a type of device that the result came from; a “has value” element; and “is edited” and “is annotated” data elements. The server computer 18 rejects a heart rate result that includes a duration, a slot ID, results qualifiers, administered medication, or patient events.

The server computer 18 only accepts systolic blood pressure results sent as top level results. The server computer 18 only accepts diastolic blood pressure results as related results to a systolic blood pressure result. A systolic blood pressure result includes the following elements and values: an indicator of a systolic blood pressure measurement; the systolic blood pressure; a date and time of the measurement; a type of device that the result came from; a “has value” element; and “is edited” and “is annotated” data elements. A diastolic blood pressure result includes the following elements and values: an indicator of a diastolic blood pressure measurement; the diastolic blood pressure; a date and time of the measurement; a type of device that the result came from; a “has value” element; and “is edited” and “is annotated” data elements. The server computer 18 rejects systolic blood pressure results that do not include a related diastolic blood pressure result. The server computer 18 rejects a blood pressure result that includes a duration, a slot ID, results qualifiers, administered medication, or patient events.

The server computer 18 only accepts A1C results sent as top level results. An A1C result includes the following elements and values: an indicator of an A1C measurement; the A1C; a date and time of the measurement; a type of device that the result came from; a “has value” element; and “is edited” and “is annotated” data elements. The server computer 18 rejects an A1C result that includes a duration, a slot ID, results qualifiers, administered medication, or patient events.

The application of the above rules by the server computer 18 ensures that data can be presented to a user based on the data stored in association with their account in an orderly fashion. Also, the user can access their account and edit, add, remove, or update data stored in association with their account.

In various aspects, the present technology provides that a patient can share data, or electronic medical records, with a healthcare professional. The term electronic medical record may refer to records of health related information on an individual or patient that is created, gathered, managed, and consulted by licensed clinicians and staff from a single organization who are involved in the individual's health and care. Electronic medical records may also be referred to or known as computer-based patient records or electronic health records.

The particular data that is shared according to the present technology may include logbook records and device settings. Electronic medical record data that is shared may include any valid electronic medical data such as blood glucose, hemoglobin A1C, and other typical lab tests, etc., such as described above.

For example, the server computer 18 can send an email inviting the patient to send an invitation to a healthcare provider. Thereafter, the patient can send an invitation to the healthcare provider to receive the patient's stored data. The server computer 18 can accept an invitation in certain aspects. In other aspects, the server computer 18 can add patients during an invitation mapping process.

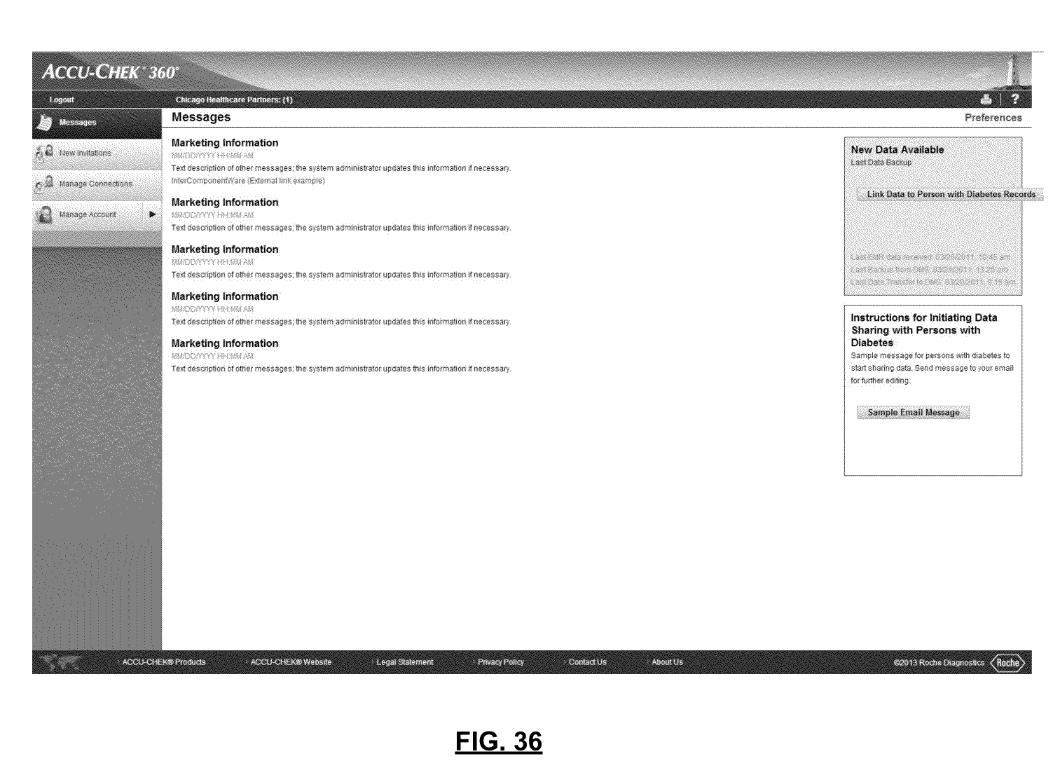

FIG. 36 includes a GUI generally illustrating a messaging feature as an option to select from a tabbed portion of a webpage, and may include instructions for initiating data sharing with patients. Sharing with patients may refer to linking a patient's account with a health care professional's account such that data stored in the database 26 for the patient's account is shared with the health care professional's account. Sample messages for patients to start sharing data may be provided. Sample messages may be provided to a user's email for further editing as desired.

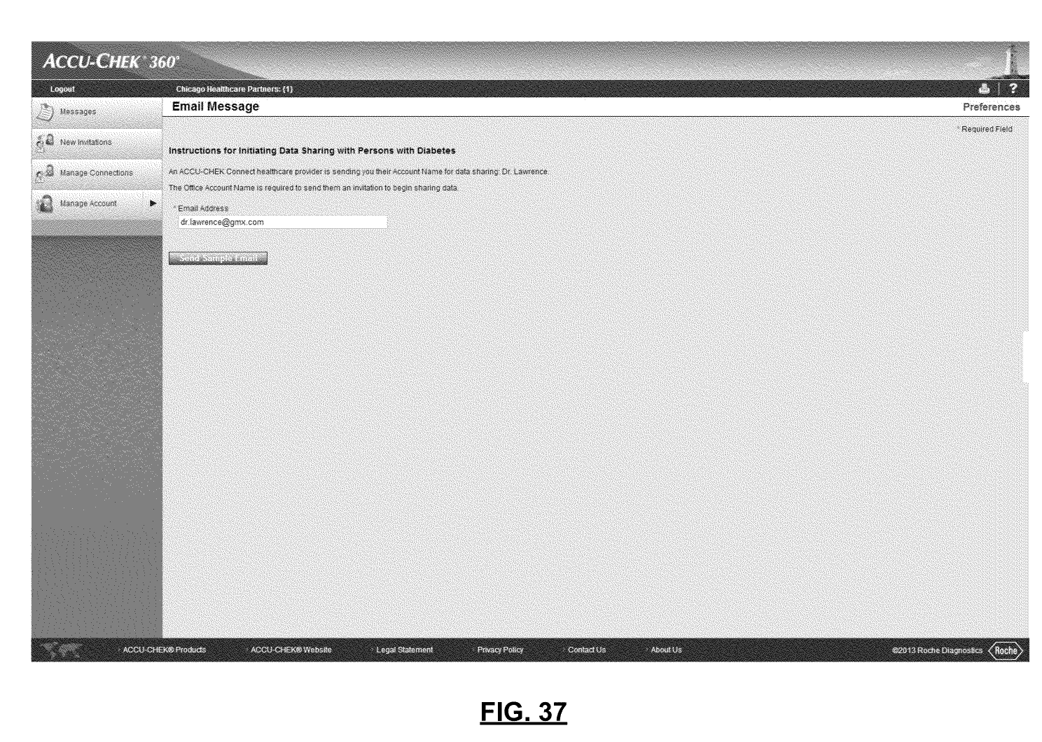

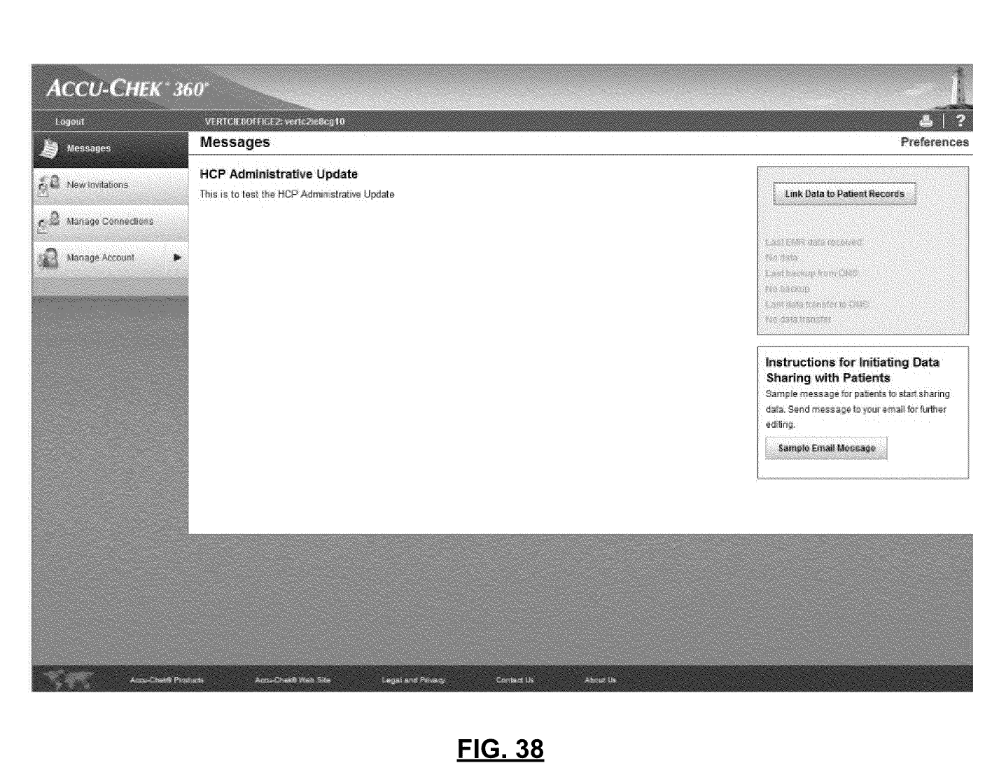

FIG. 37 illustrates an example of the solicitation of an email address that can be sent to a patient to begin the process of linking the patient's account with the health care professional's account. An account name may be required to send an invitation to begin sharing data. As shown in FIG. 38, various security features may be initiated to test any healthcare provider administrative updates, if any.

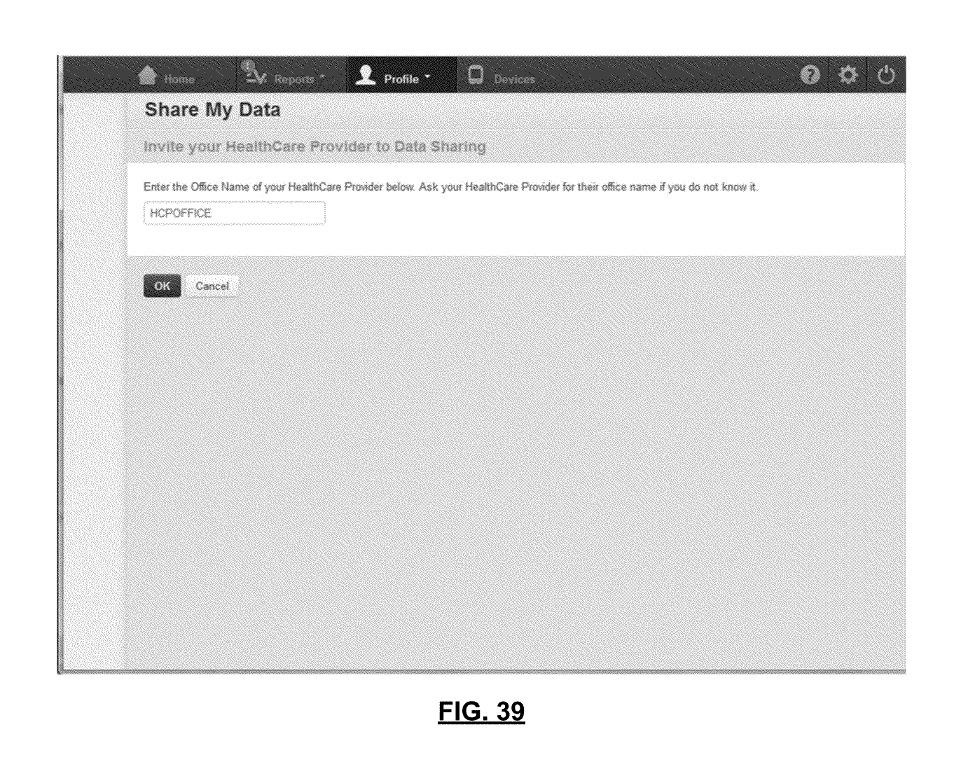

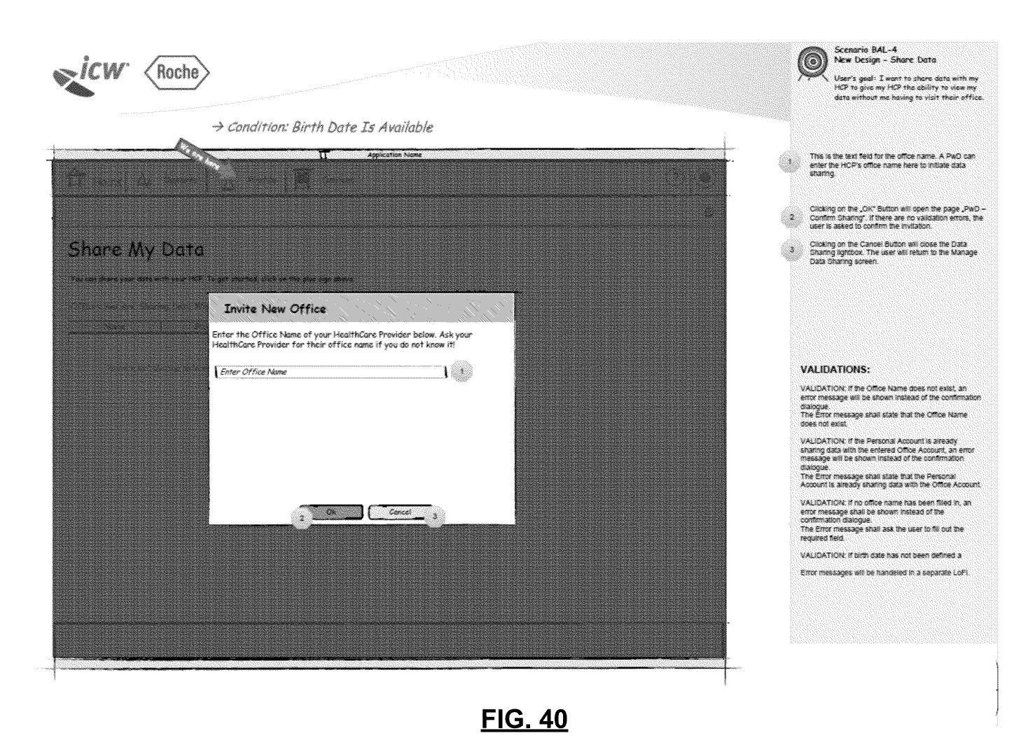

FIGS. 39 and 40 illustrate GUIs presented to a patient to invite their health care professional to link their account with the patient's account. As shown, a user may be prompted to enter the office name of the healthcare provider to initiate the data sharing. The user may be reminded to ask their healthcare provider for their office name if they are not aware of it.

The server computer 18 may search for health care professionals based on the name input by the patient. If the office name does not exist, an error message may inform the user that the office name does not exist. If a personal account is already shared with a health care professional's account associated with the office name, an error message may also be provided indicating the same.

If there are no validation errors, selecting an “OK” button may open a separate page asking the user to confirm the request for sharing. Leaving the field empty may prompt the user to provide the requested confirmation. Selecting the “cancel” button will end the process and close any pop-up box that may have been introduced.

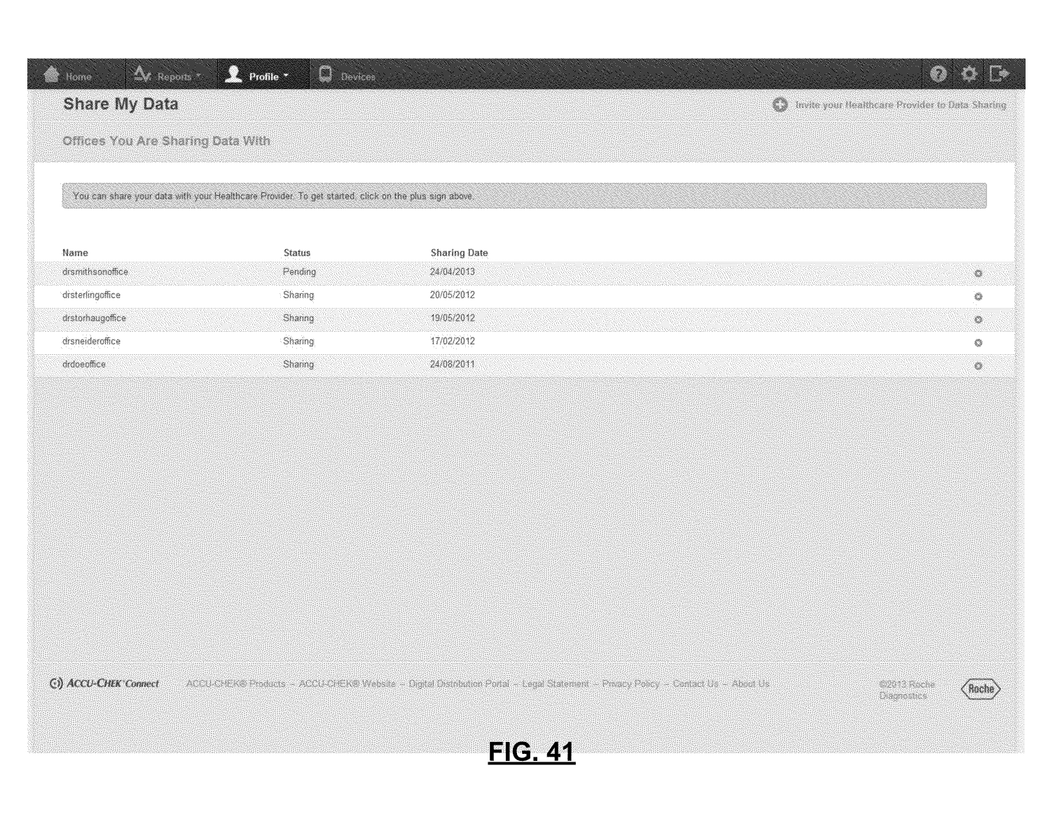

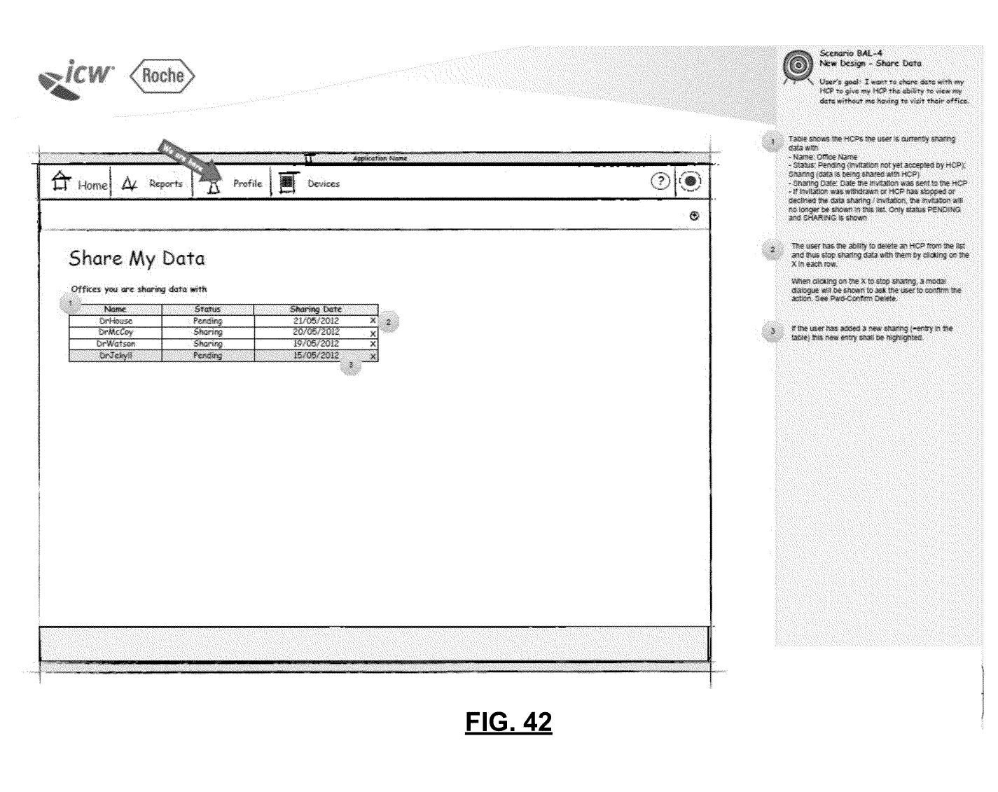

FIGS. 41 and 42 provide GUIs for management of the data sharing. This information may be provided in a table format, and shows the healthcare provider(s) that the user is currently sharing data with. The relevant information may include the office name and the status of the data sharing. A status of “pending” may indicate that the invitation is not yet accepted by the healthcare provider, while a status of “sharing” may indicate that the data is being shared with the healthcare provider. If the invitation was withdrawn or declined by the healthcare provider, the invitation may not necessarily be shown in the list. For example, the list may only provide names that are currently “pending” or “sharing.”

The user has the ability to delete a healthcare professional from the list, for example, by selecting the “X” at the end of each row as shown in FIG. 42. In other words, the user has the ability to stop sharing their data with a health care professional. If the “X” is selected, a separate dialog may be shown to ask the user to confirm the action (i.e., the stoppage of sharing). If a user has recently added a new sharing, the new entry can be highlighted or otherwise differentiated from the other entries.

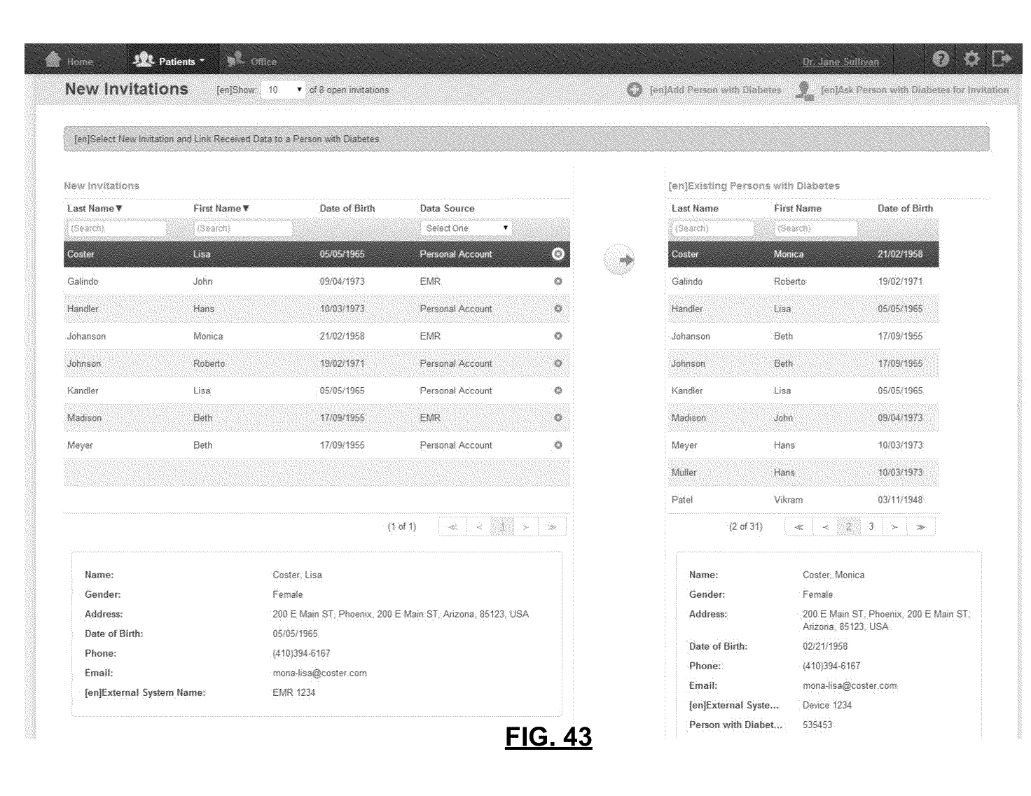

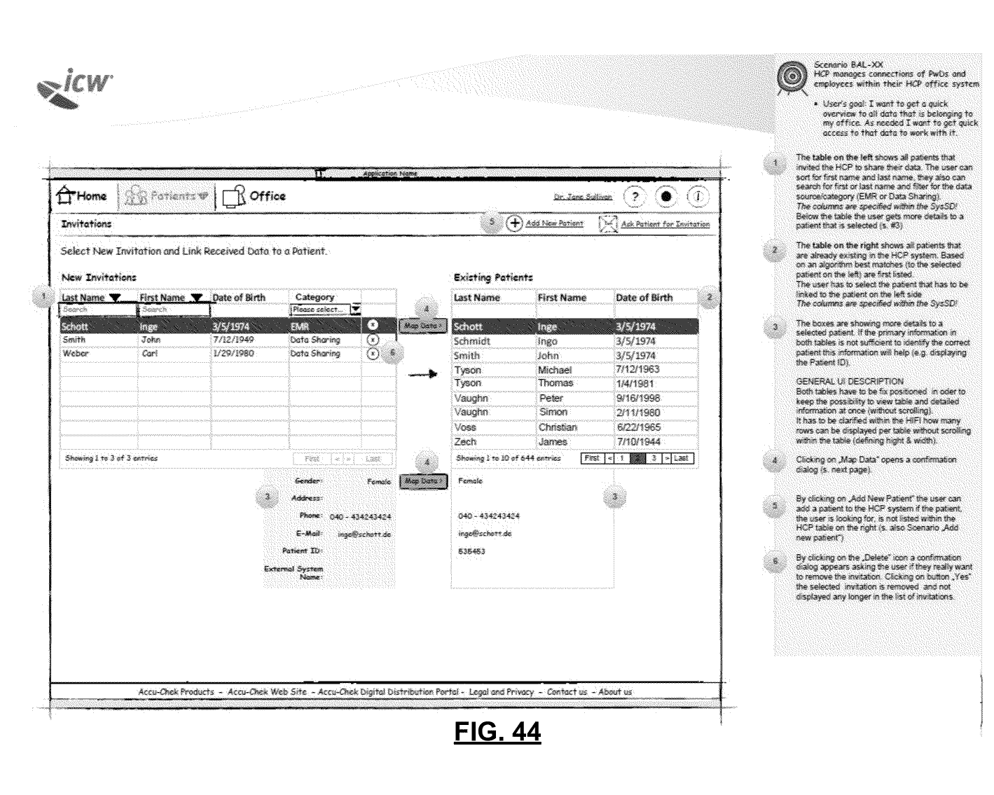

FIGS. 43-45 provide additional GUIs for the management of patient invitations. An invitation page may be introduced by a headline that explains the main scenario on this page, namely linking newly uploaded data with patient records. By selecting the “add new patient” feature, the user (of the health care professional account) can add a patient to the healthcare provider's account if the patient is not already listed within the table on the right side of FIGS. 43 and 44.

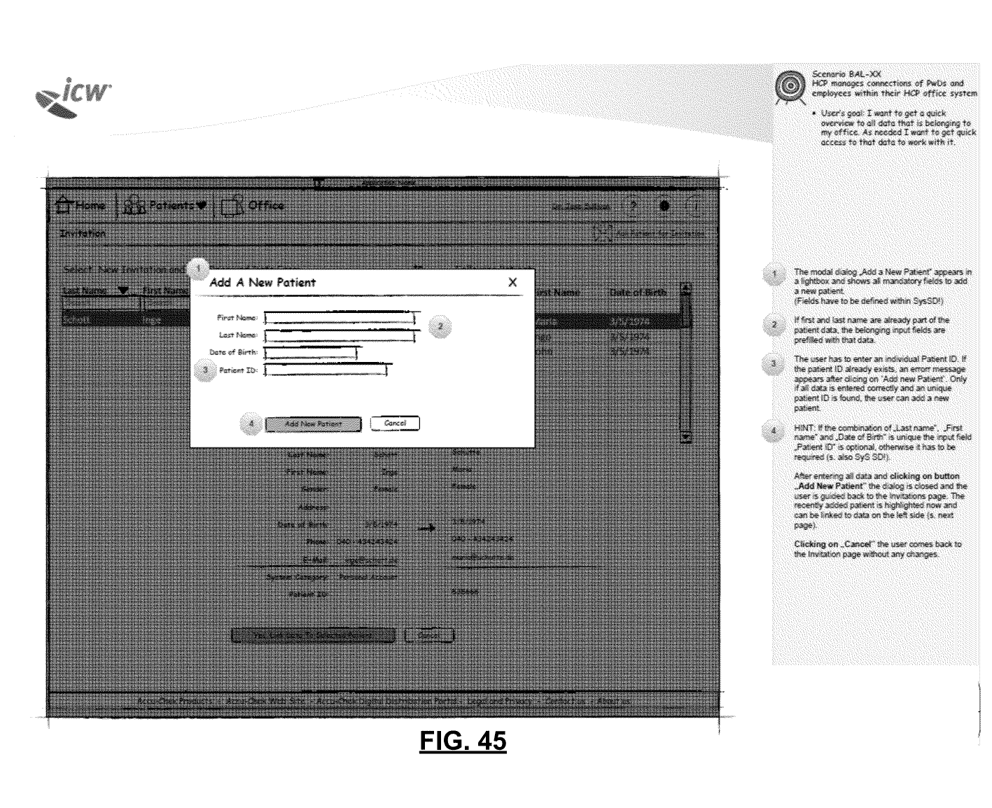

FIG. 45 provides an example GUI for the addition of a new patient. A headline on each of the tables may help the user to understand what to do on each page. New data may be linked by selecting an invitation, matching it to an existing patient record, and selecting the appropriate link.

The tables on the left side of FIGS. 43 and 44 show all patients that invited the healthcare provider to share their data. More specifically, data newly uploaded by linked patient accounts is displayed in the table on the left side of FIGS. 43 and 44.

A user can sort by the first or last name, or they can search by first or last name. Below the table, more details may be provided regarding a patient that is selected. The table on the right may indicate all patients that already exist in the healthcare provider account. Based on a matching algorithm, best matches (to the patient selected on the left) are first listed. A user has to select the patient that has to be linked to the patient on the left side. The columns in the table may be formatted as desired. Boxes presented below the table may provide additional details regarding the selected patient. If the primary information in both tables is not sufficient to identify the correct patient, the information in the boxes may be of assistance.

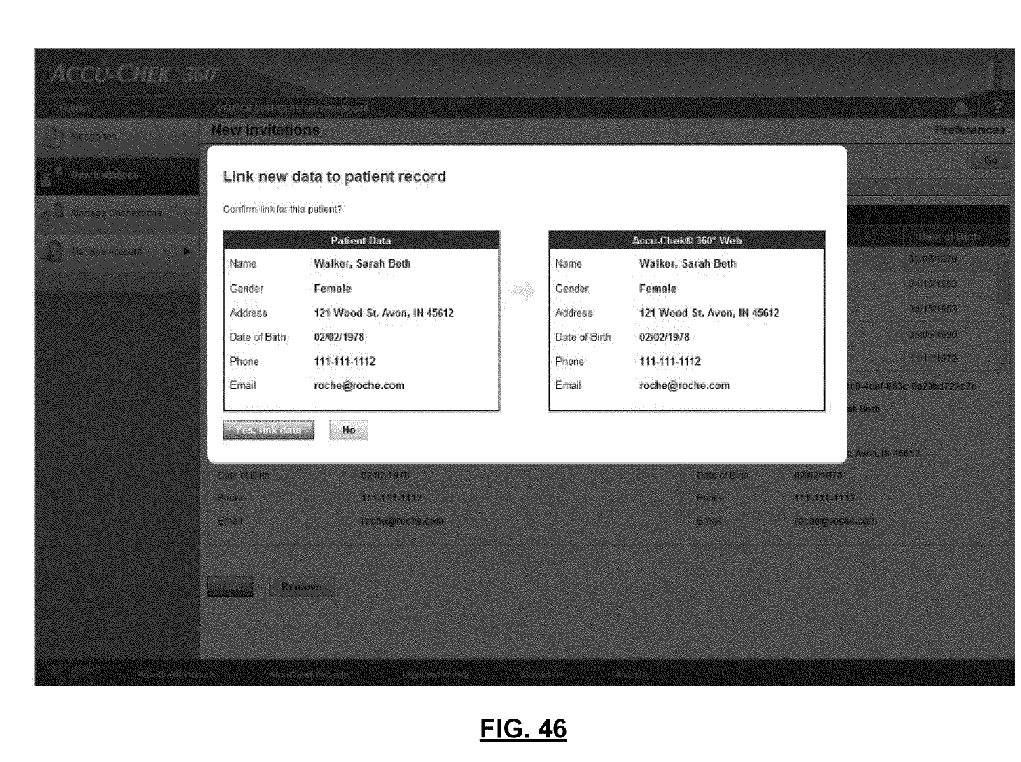

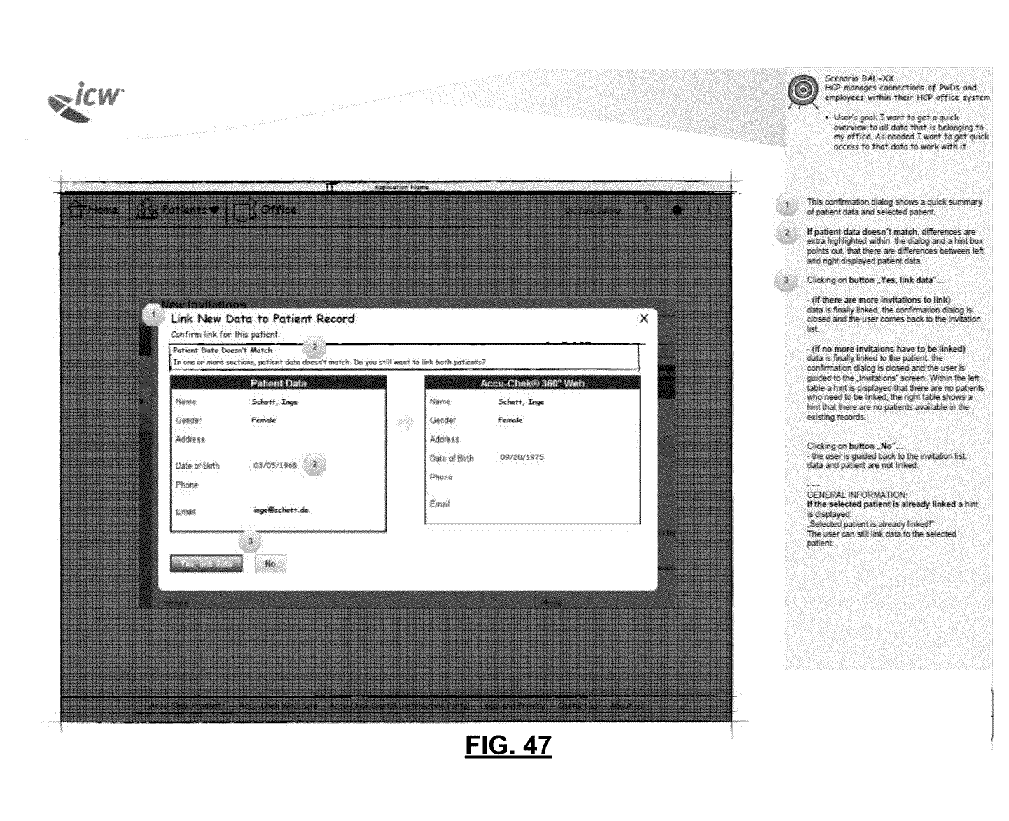

Selecting “link data” option button may open a confirmation GUI as shown in FIGS. 46 and 47. The confirmation GUI requests an additional user confirmation before linking selected newly uploaded data with an existing patient in the health care professional's account. Once confirmed, the data is linked and the confirmation GUI is closed, directing the user back to the invitation list if there are more patients to link. Selecting the “no” button does not link the data to a patient, and directs the user back to the invitation list.

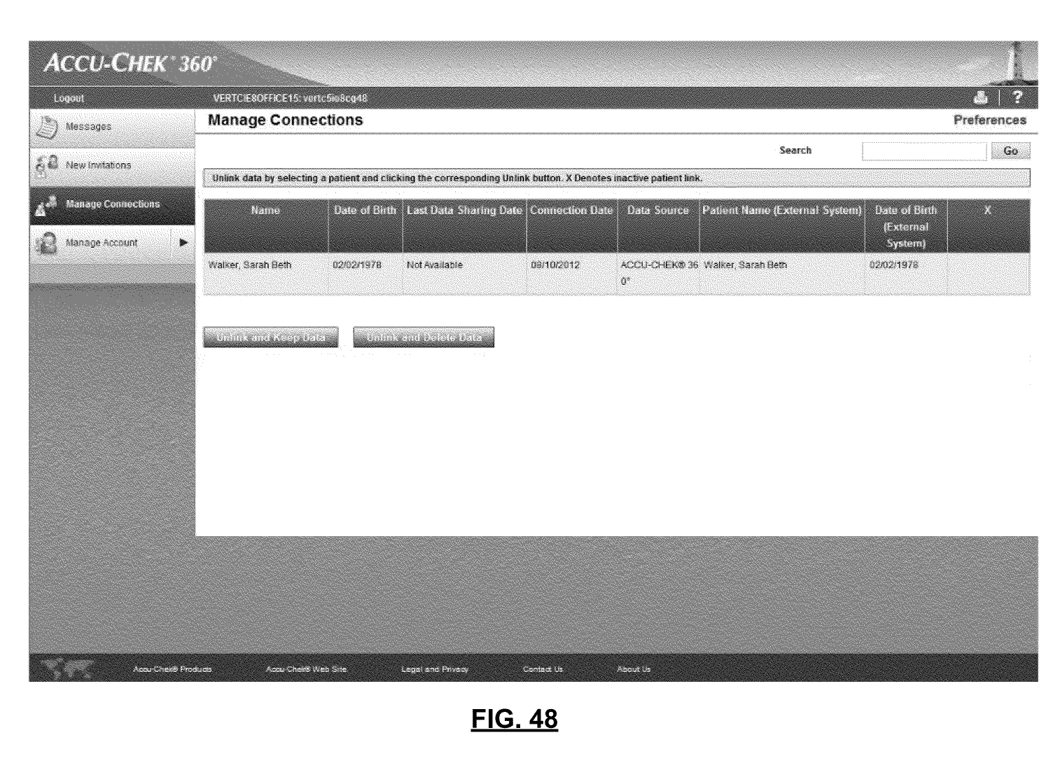

If there are no further patients to link, the user may be guided to a “Manage Connections” interface as shown in FIG. 48, where the user can verify that the linking was correctly performed. In the “Manage Connections” interface, a user can unlink a patient account from the health care professional's account and delete that patient's data, for example, if there is an incorrect match or link. The user can also unlink the patient account and retain the patient's data.

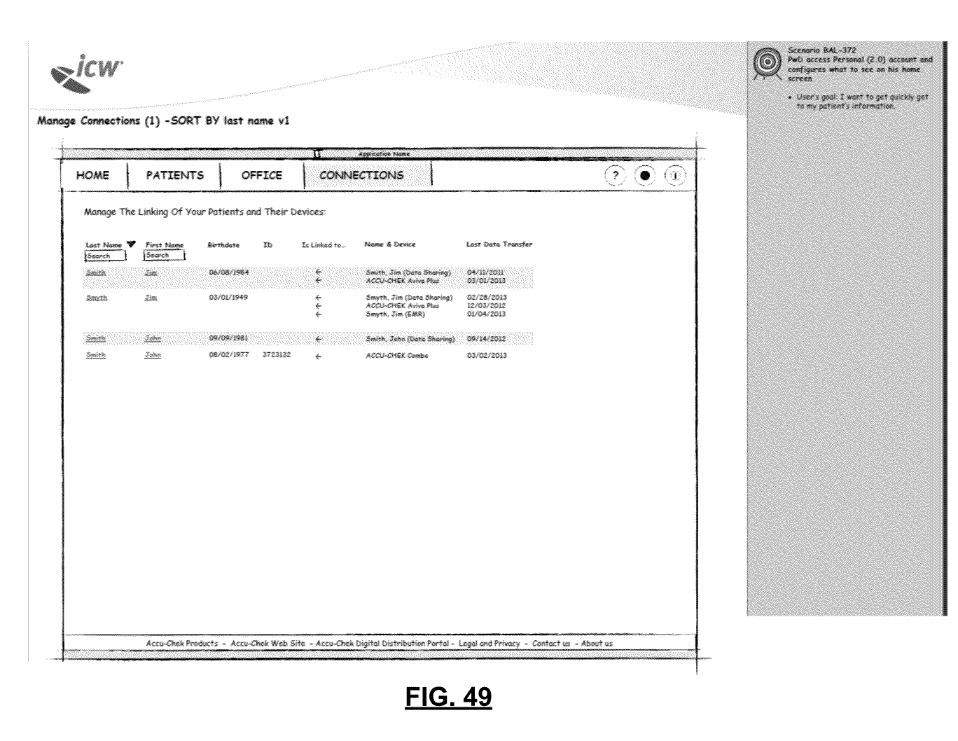

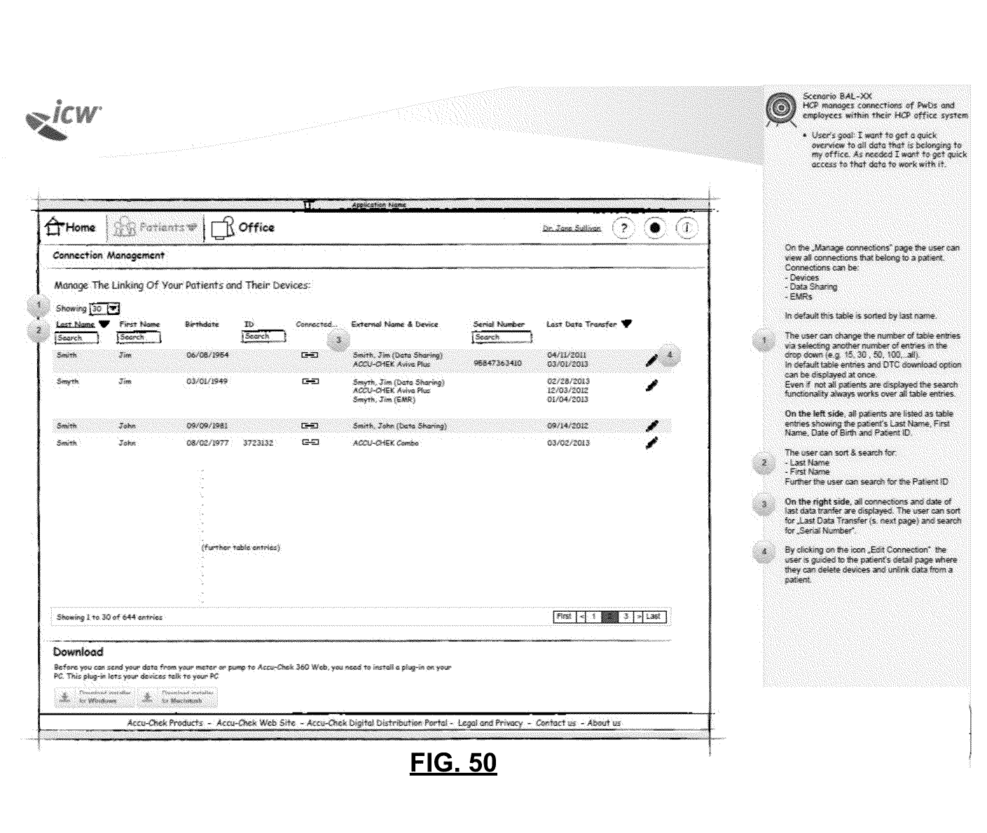

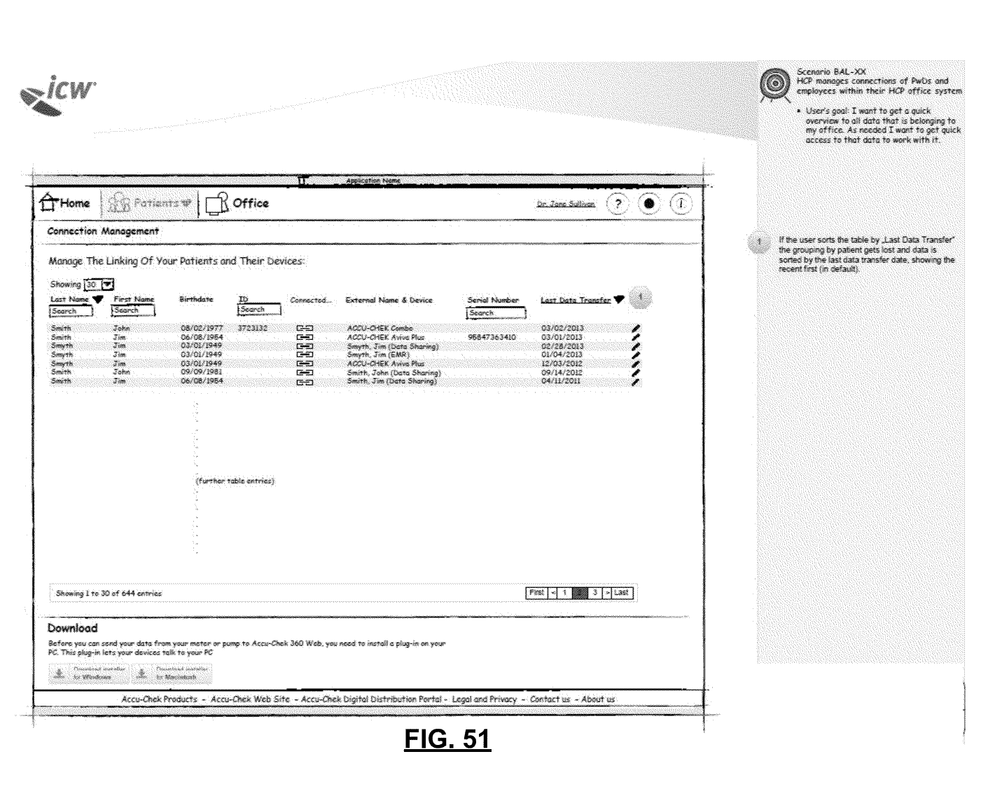

FIGS. 49-51 further illustrate the management of links between patient accounts and a health care professional's account in a tabular format. For ease of review, patients can be sorted by name, date of last data transferred, and other filter options. As shown in FIG. 49, the user can view all links associated with a patient, including devices, data sharing, and electronic medical records. By selecting a patient's name, a user may be directed to a details GUI, where they can manage links associated with to a patient.

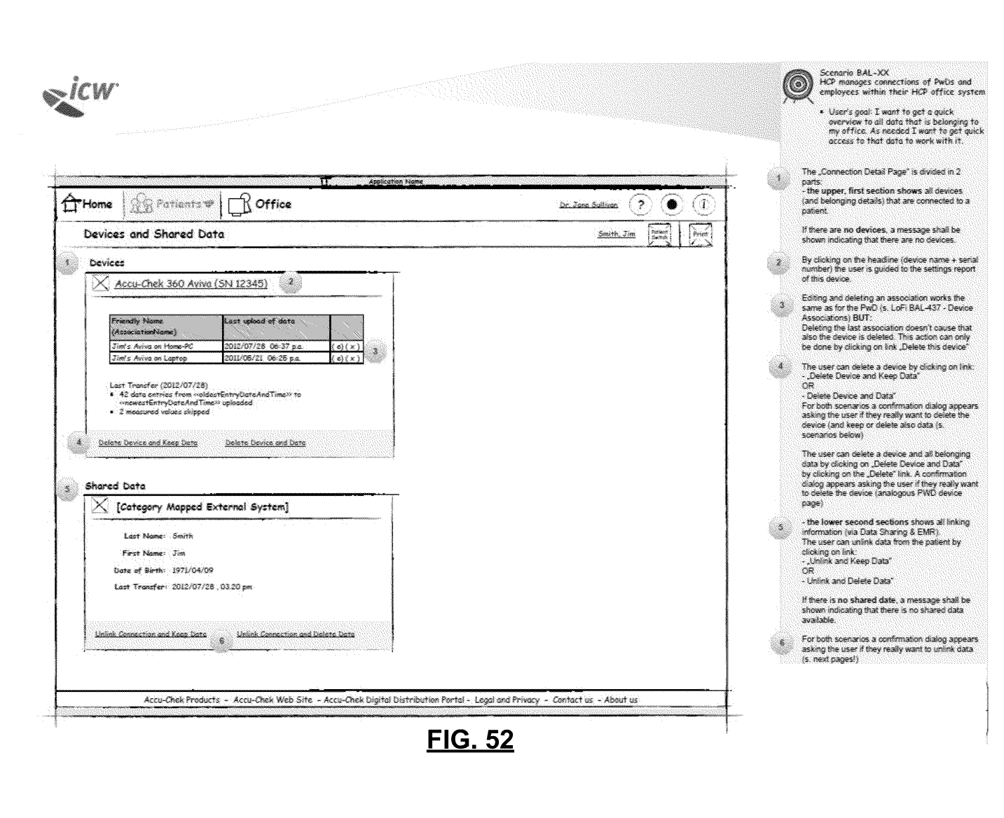

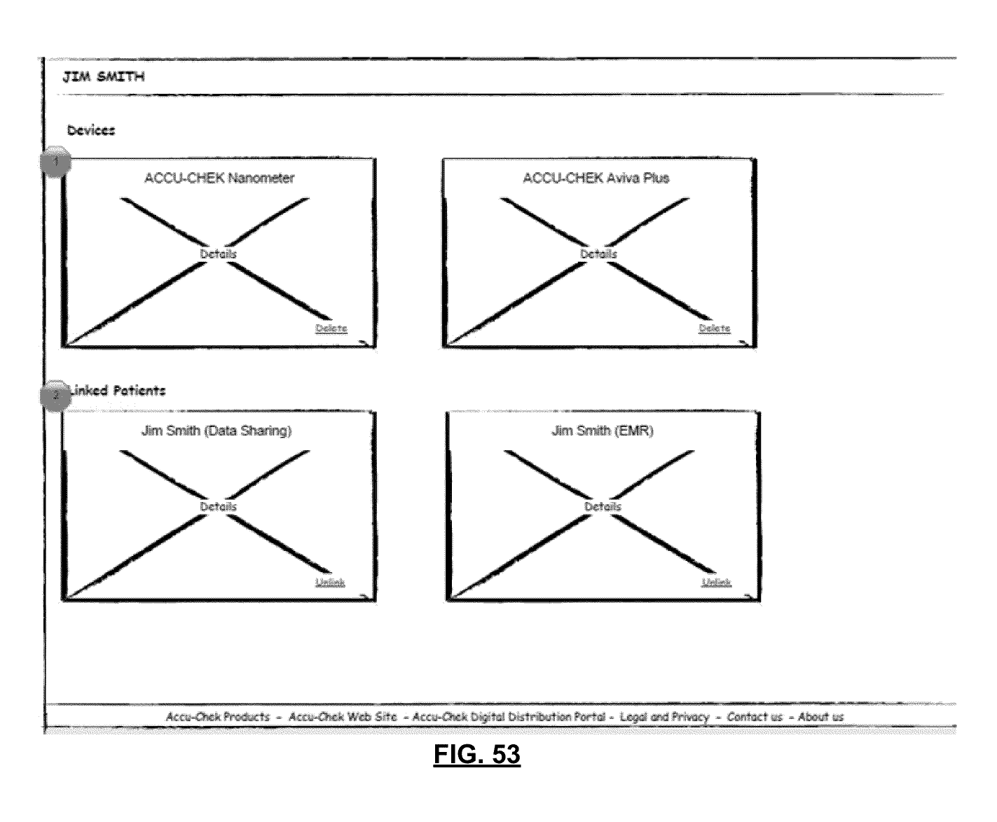

FIGS. 52 and 53 illustrate details of linked devices for a particular patient. All associations to the user account may be grouped in “panels” or “tiles” by device. A new panel may be added for every new link formed, such as in chronological order. A new link for an existing device may also be displayed in chronological order. Each panel title may include a device model name, a device type, and optionally a serial number. The last transfer summary lists the summary of the latest transferred data for the respective device. If there are notable problems during the last transfer, this information may be displayed as text.

By selecting the “delete this device” option, a GUI is opened asking a user to confirm that all associations to this device should be removed. Notably, this does not delete the data, but rather the link. When a user deletes the last existing link to a device, the panel for this device may be removed from the page as well. A separate download link may be provided for every available and installable client class in the system. If no download file is available, the panel may not be displayed.

The server computer 18 also provides an electronic “logbook” feature, where the healthcare provider and/or patient may use a logbook to visualize diabetes management data using user defined lists, filtering (e.g., date range, bG level, insulin, and advice) along with the ability to add and modify entries. The logbook may display images coordinated with other related DMSs. Various trend and other statistical reports may be generated that provide a visual representation of data over a selected time period and can be configured by date range, all data/flagged data, connected/averages along with the capability for drilling down into the data.

A standard full day report may provide selected data over a 24 hour period that can be dynamically viewed by scatter/aligned and flagged/unflagged as a graph, statistics, and drill down. As opposed to a traditional 24 hour period beginning at 12:01 and ending at 12:00, the 24 hour period of a standard day may be user configurable. In this manner, individuals having different schedules (e.g., working night shift) can have data displayed in similar formats despite their different daily schedules.

A standard week report may provide selected data over a number of standard days (e.g., up to seven) that can be dynamically viewed as scatter/aligned and flagged/unflagged data as represented in a graph, statistics, and a drill down format. A three-day profile type report may be used for structured testing or for viewing with the days (either in an overlaid or sequential format) as a graph, statistics, or a drill down format.

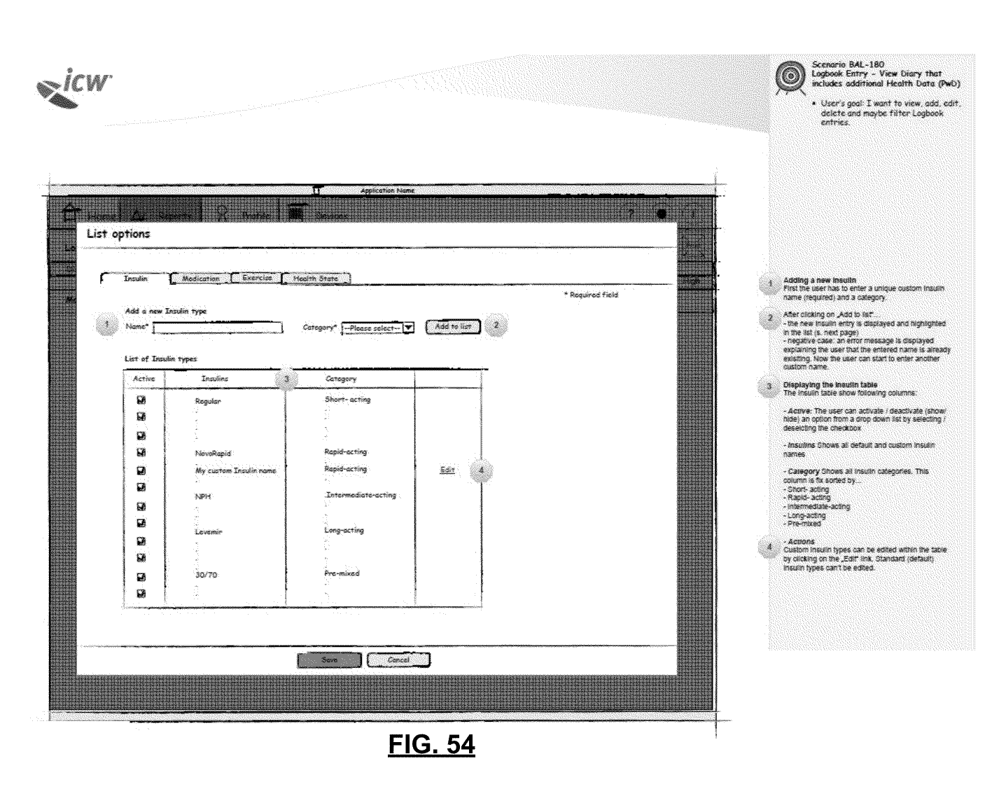

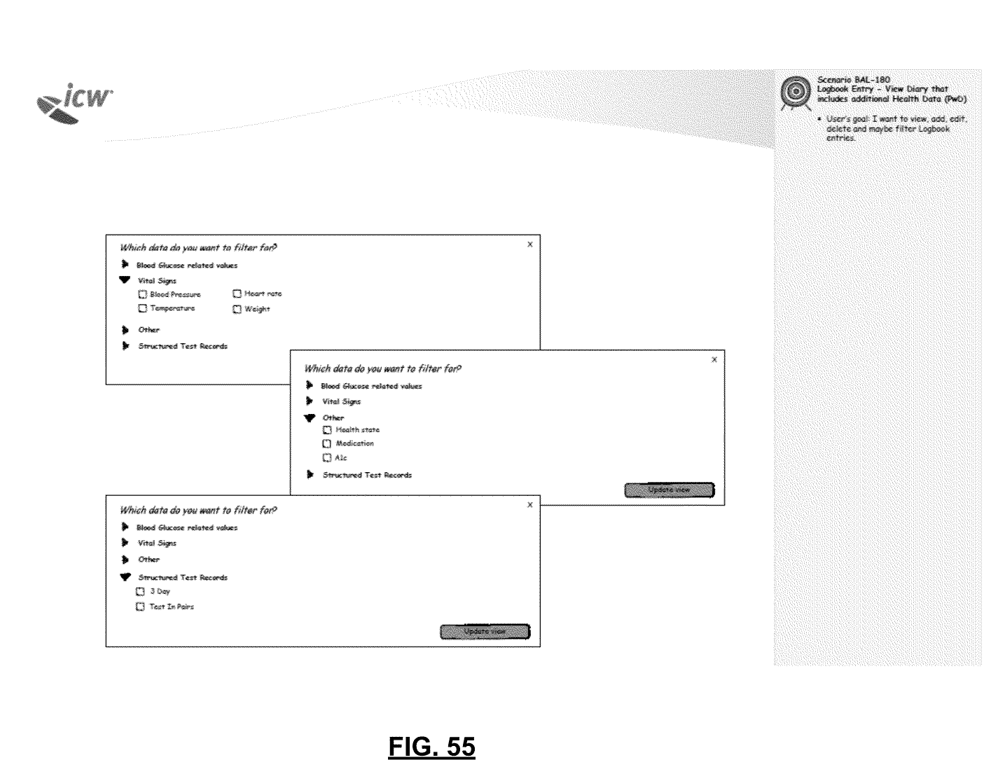

FIG. 54 illustrates a GUI that may be used to view, add, edit, delete, or filter logbook entries based on a user defined input. FIG. 55 illustrates various GUIs that allow a user to filter the display options. By selecting a record from the table in FIG. 54 and choosing an edit option, the user can enter a new name and/or category. Selecting the save option saves the entry, while selecting the “X” reverts back to the previous entry (and discards any edits).

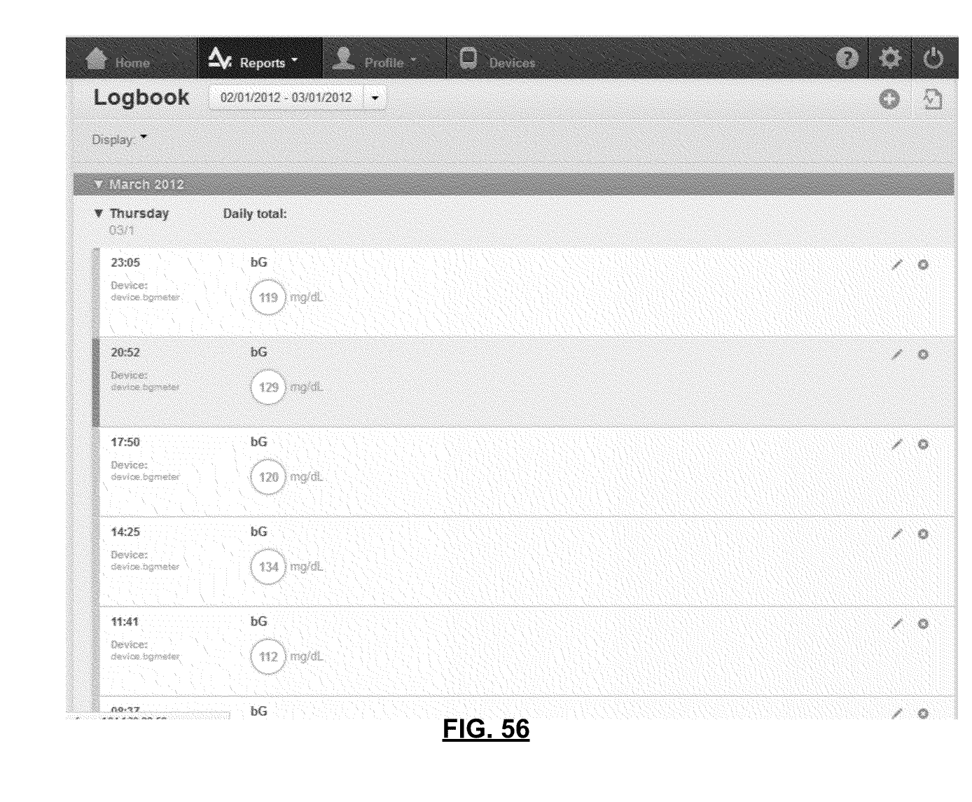

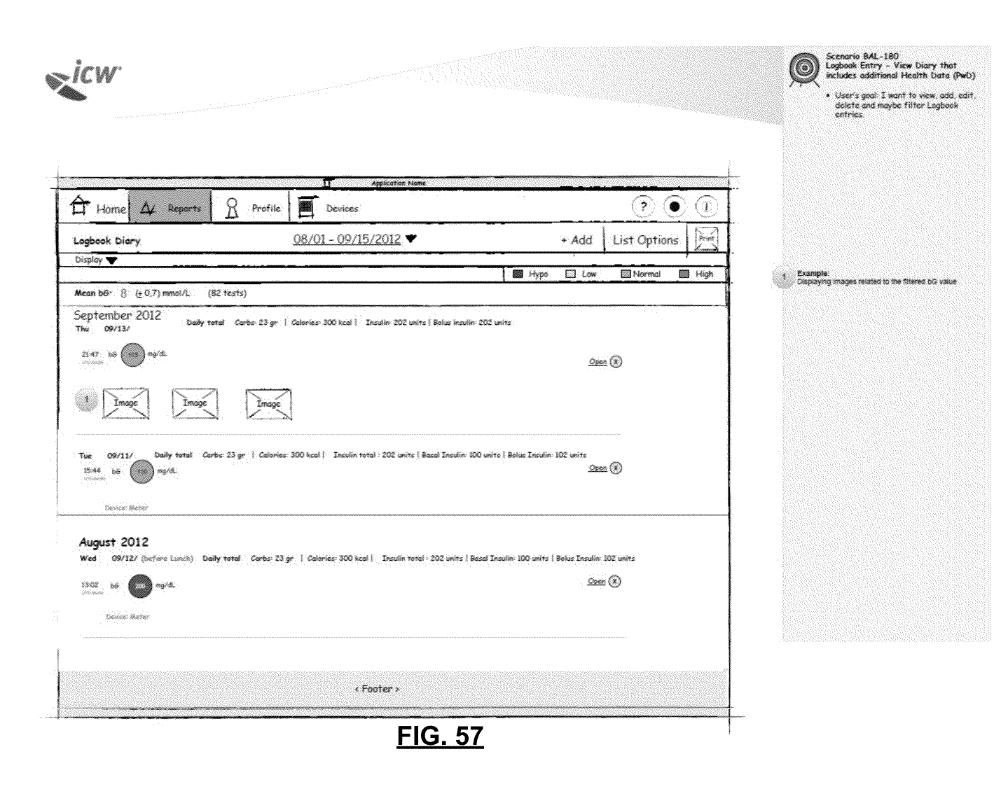

FIGS. 56 and 57 illustrate the logbook features in more detail. As shown in FIG. 56, a month date range is selected from a drop-down window, which displays diabetes management data for the entire month, starting with the newest data and working in reverse chronological order. The log entries shown include bG readings with a time stamp as well as an indication of the device used to obtain the reading. FIG. 57 shows a GUI displaying summaries of diabetes management data for different days within a date range.

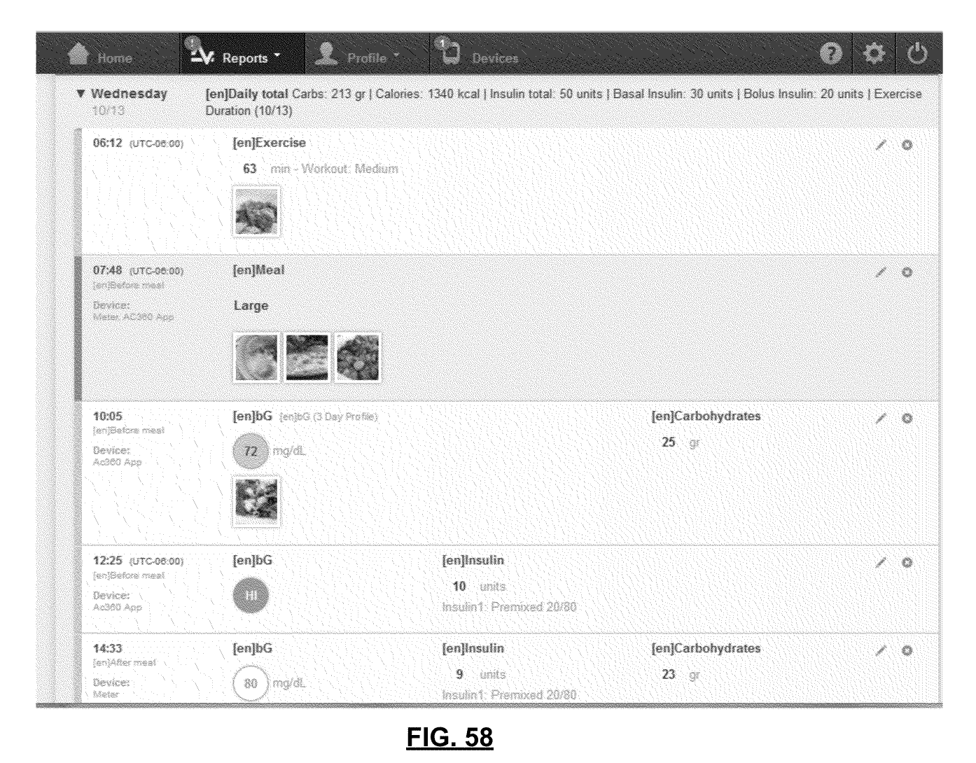

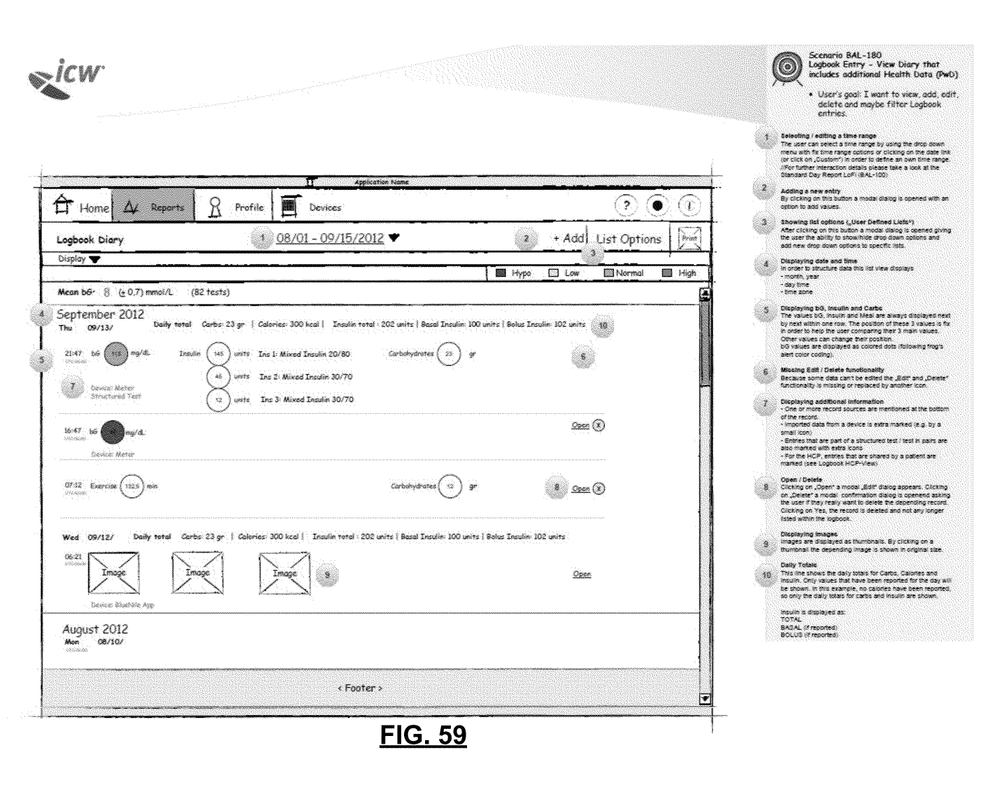

FIG. 58 illustrates a logbook including entries relating to meals, insulin units used, and exercise. FIG. 59 illustrates additional features and displays useful with the logbook. For example, a date range can be selected or edited as noted by circled reference number (1). A user may add a new entry by selecting the appropriate link at reference number (2). Editing options are provided at reference number (3), which may provide the user with the ability to show/hide the drop down options and add new drop down options to specific lists. The time and date are displayed at reference number (4). Reference number (5) displays the values of bG, insulin, and carbs/meal next to one another. The position of these values may assist a user when comparing their three main values. The bG values may further be displayed with color-coded features. Because structured tests are not to be edited, there is no option to edit or delete the values at reference number (6). Reference number (7) indicates where optional information, such as the device information or other imported data can be displayed. Reference number (8) indicates the ability to open/view or delete (“X”) a record. The deletion may remove the specific from being shown in the logbook, but not necessarily delete the underlying data. Reference number (9) represents images displayed as thumbnails. By selecting a thumbnail, the corresponding image may be displayed in a larger or original size. Reference number (10) indicates daily totals for values such as carbs, calories, and insulin. For example, only values that have been reported for a specific day will be shown.

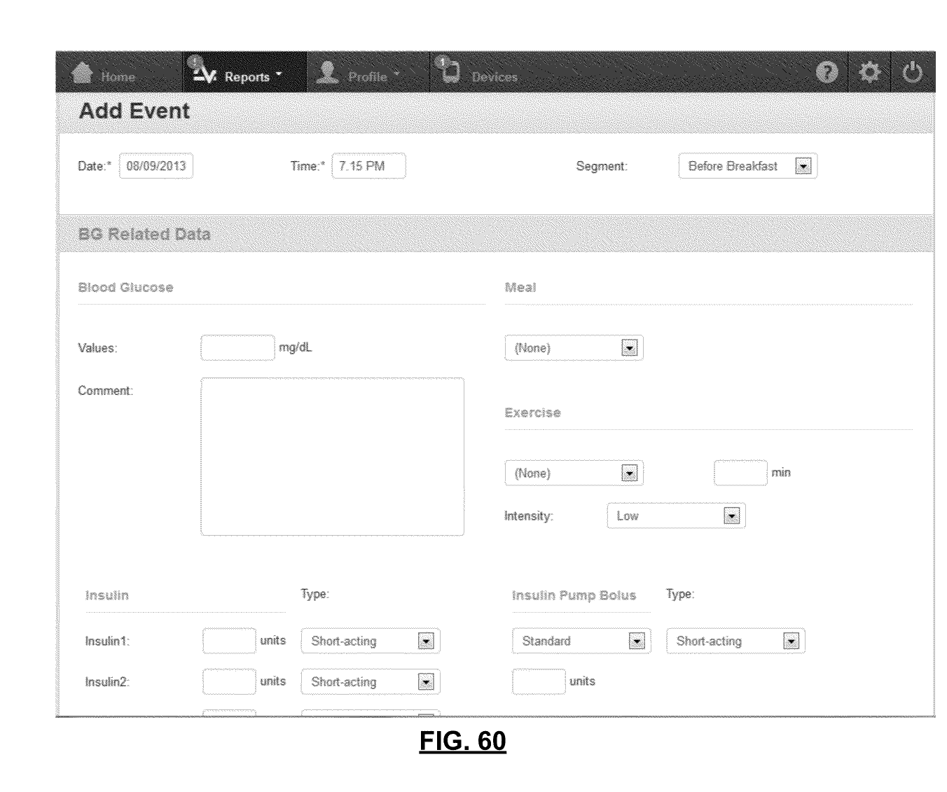

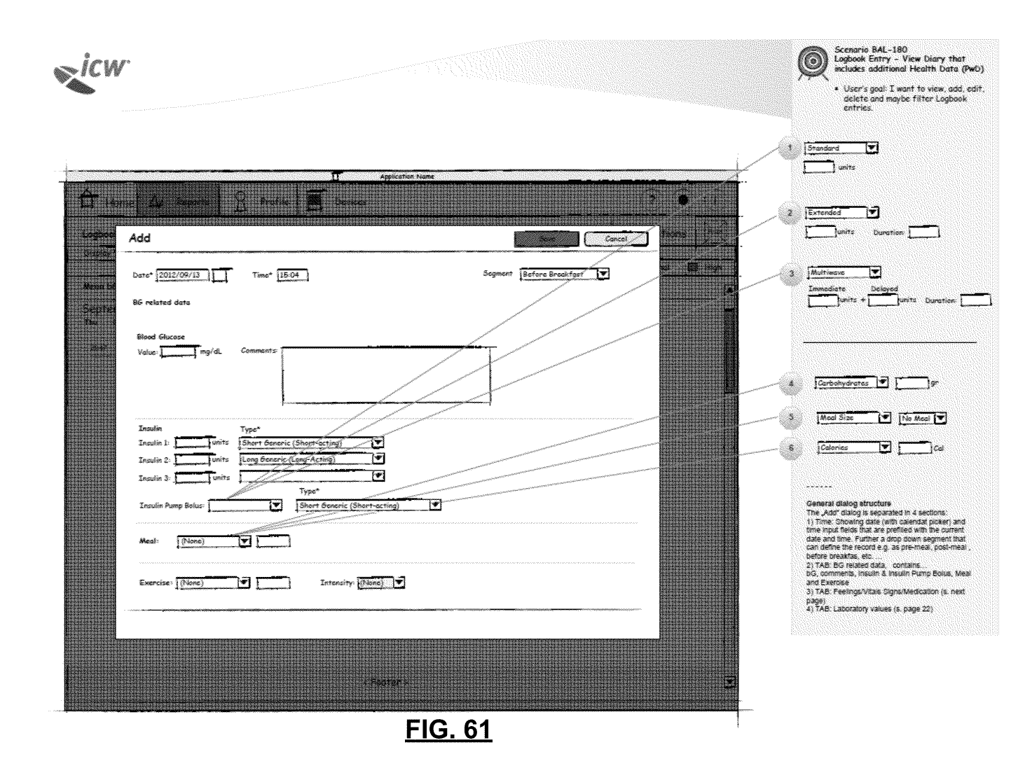

FIGS. 60 and 61 include a GUI for adding or modifying entries. As shown, the “add” dialog is separated in four sections, for adding a (1) time, (2) specific items (e.g., bG, carbs, insulin), (3) vital signs, feelings or medication, and (4) laboratory values information (e.g., A1c).

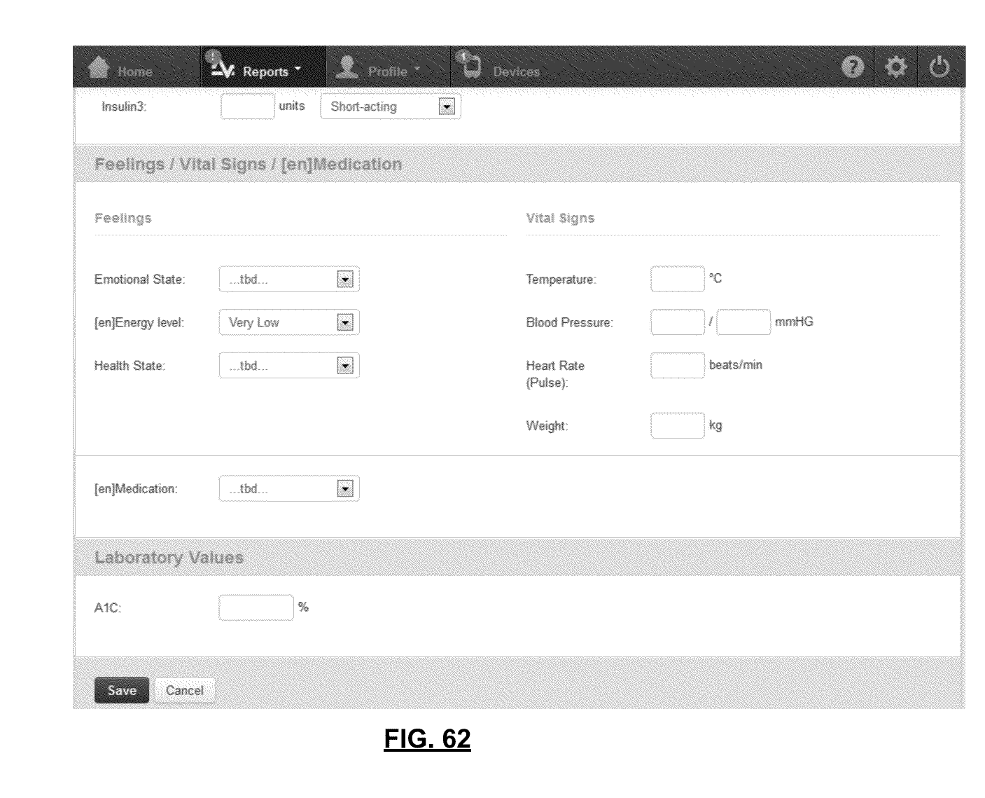

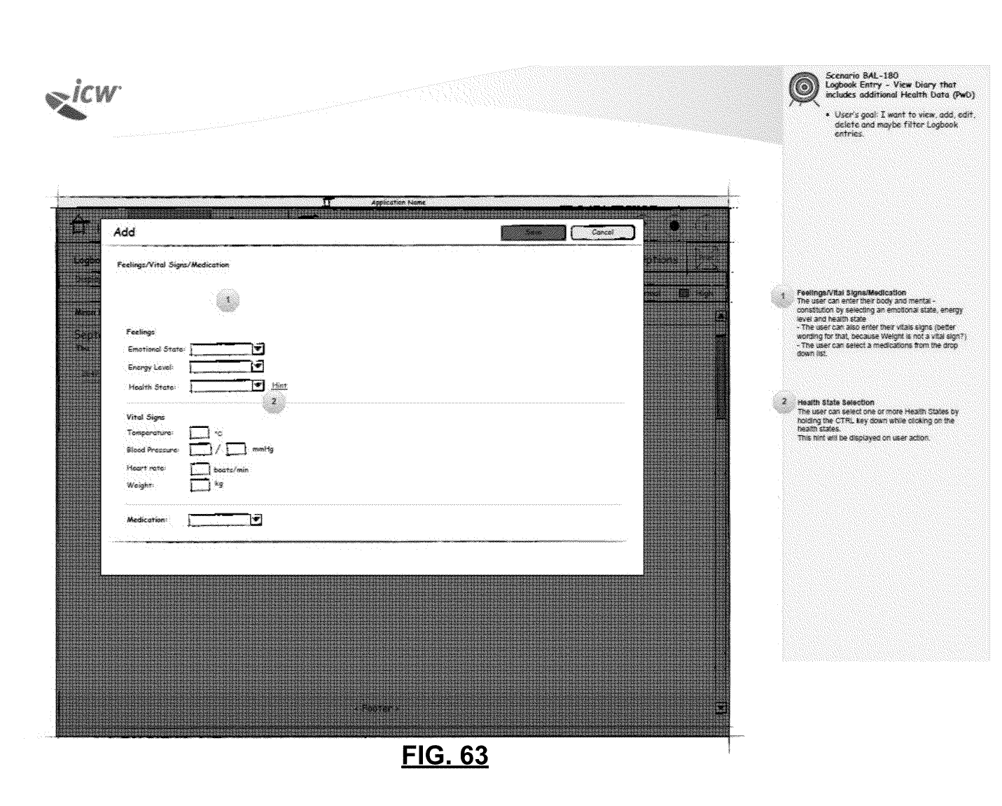

FIG. 62 is a specific GUI for inputting (3) vital signs, feelings or medication and (4) laboratory values information (e.g., A1c). FIG. 63 includes another GUI for adding diabetes management data where the user can enter their body and mental constitution by selecting an emotional status, energy level, and health state. The user can also enter their vital signs, such as temperature, blood pressure, heart rate, and other statistics, such as weight. Medications can be added from a drop down list.

The logbook may include features such as the creation of trend reports. Trend reports may include the ability to graph statistics and provide other views, in addition to drilling down to additional data. The trend reports may provide a view of selected data over a specified time period. The trend reports may be configurable to include Date Ranges, All Data/Flagged Data, Data that includes bG, Carbs, Insulin, Weight, etc., and Connected/Average data. The ability to print the reports in specific formats, such as Adobe PDF, may also be provided.

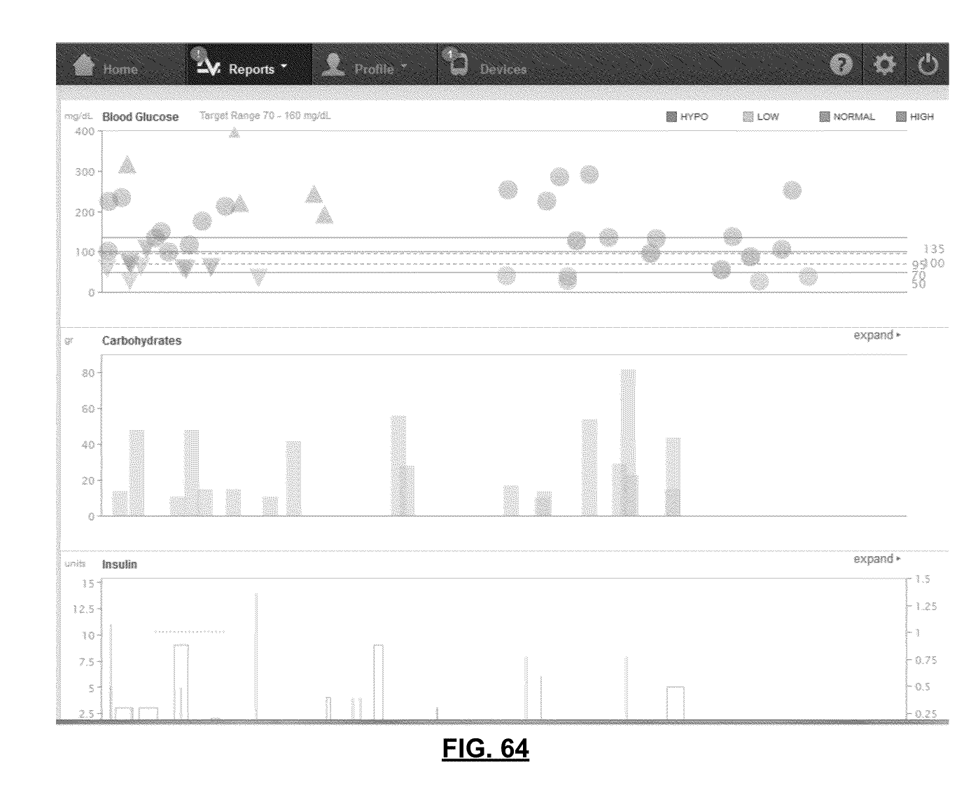

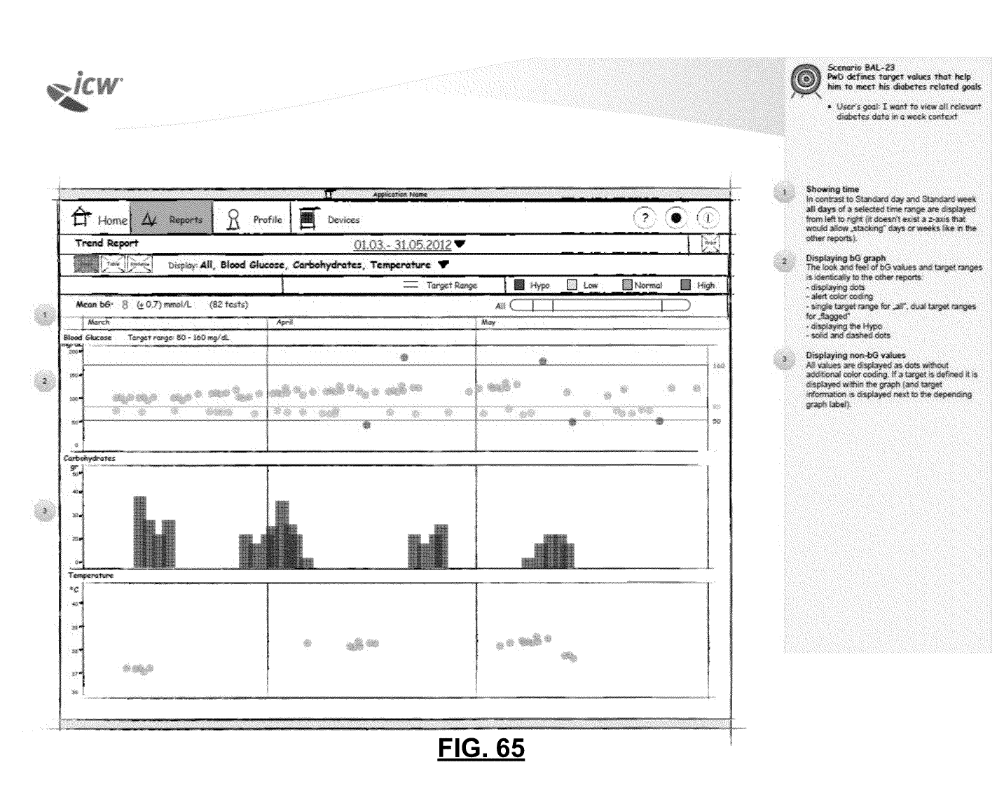

FIGS. 64 and 65 include GUIs including trend reports for blood glucose levels. They may be color coded for ease of review. Certain target ranges may be identified and/or flagged. Appropriate legends may be provided.

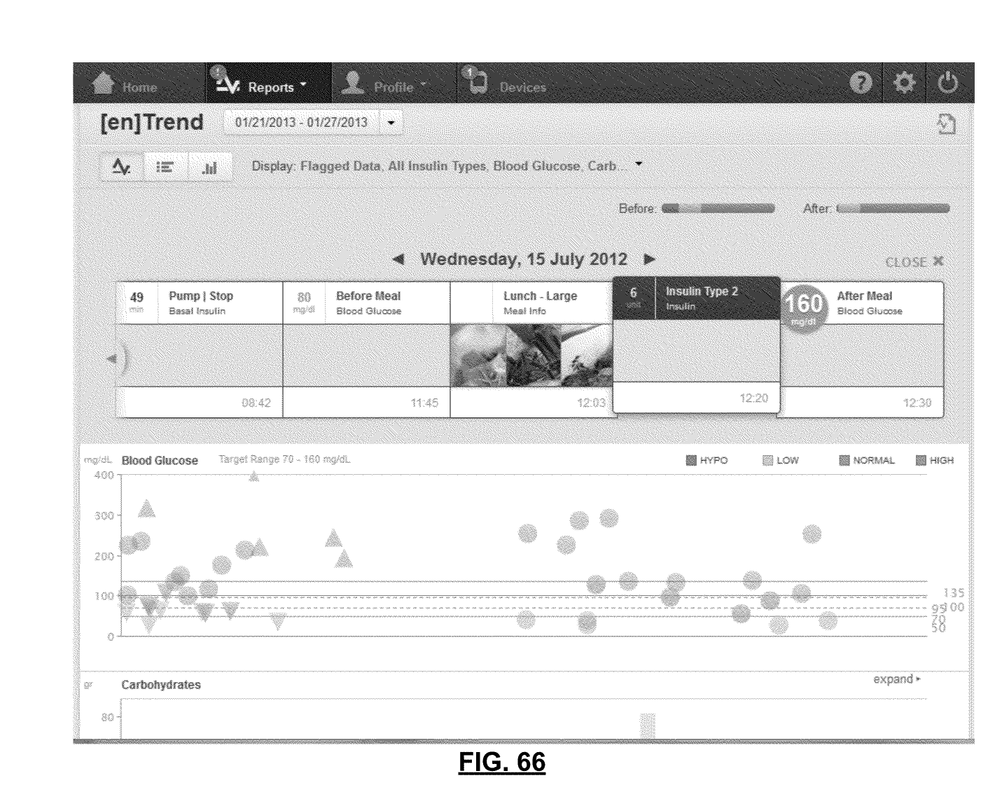

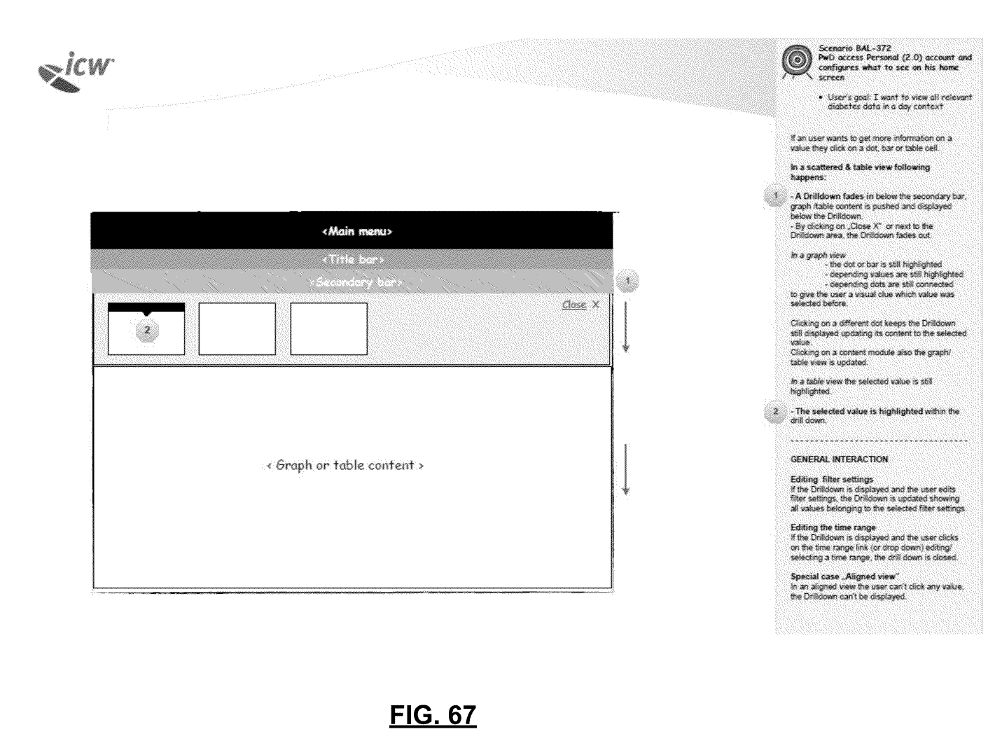

FIG. 66 includes a GUI including a drill down type report with additional detailed information. If a user wants more specific information, they may click or select a dot, bar, or table cell. When in a scattered and table view, a drill down menu fades in below a secondary bar as shown in FIG. 67.

In a graph view, the dot or bar is still highlighted to give the user a visual clue as to which value was selected before. Selecting a different dot keeps the drill down displayed, but updates the contents to the selected value. When selecting a content module, the graph/table view is also updated. In a table view, the selected value is still highlighted. As shown by reference number (2) of FIG. 67, the selected value is highlighted within the drill down menu. Filter settings and time ranges may be edited as desired. If the drill down is displayed and the user edits the filter settings, the drill down menu is updated showing all values belonging to the selected filter settings. If the drill down is displayed and the user selects on the time range link (or drop down) editing/selecting a time range, the drill down is closed. In the special case where there is an aligned view, the user may not be able to select any value, and the dropdown may not be able to be displayed.

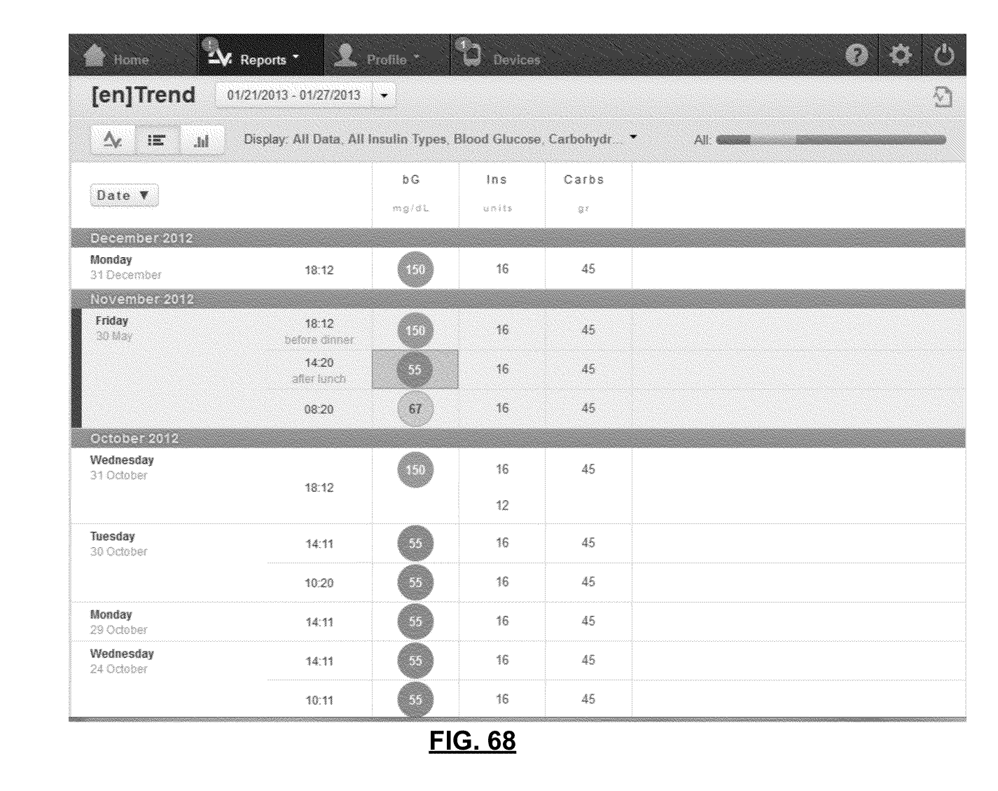

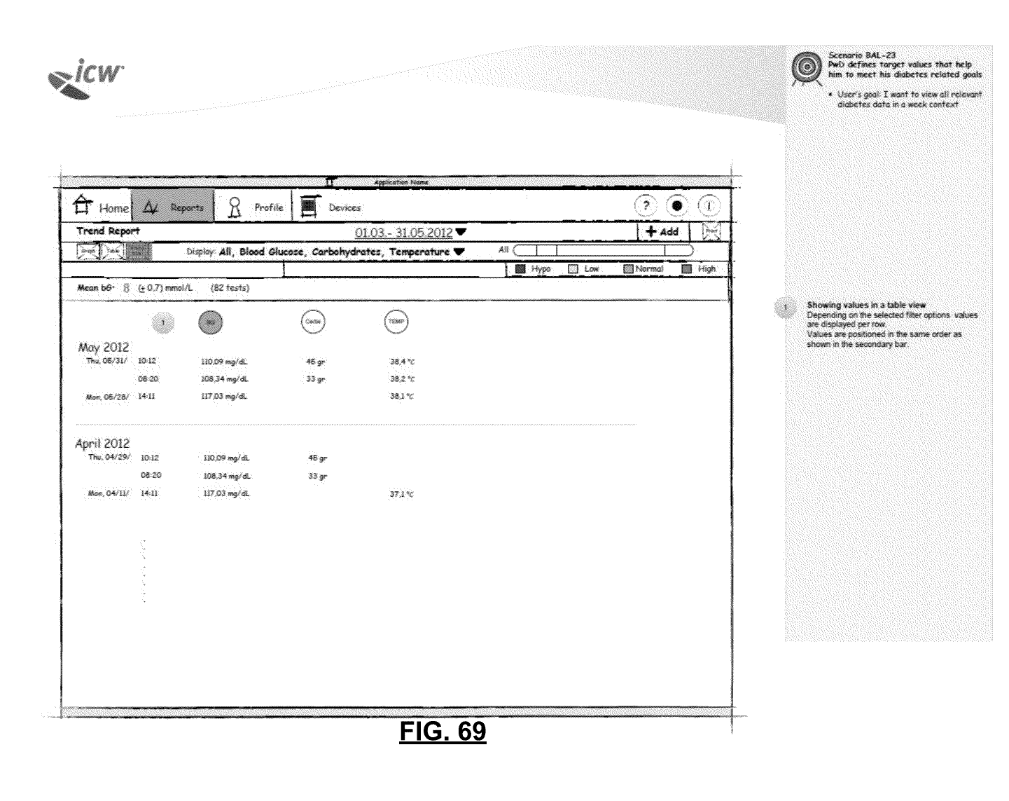

FIGS. 68 and 69 illustrate example GUIs showing a table view, representative of diabetes management data for a week. Depending on the selected filter options, values may be displayed per row. Reference number (1) of FIG. 69 shows that values may be positioned in the same order as shown in the secondary bar.

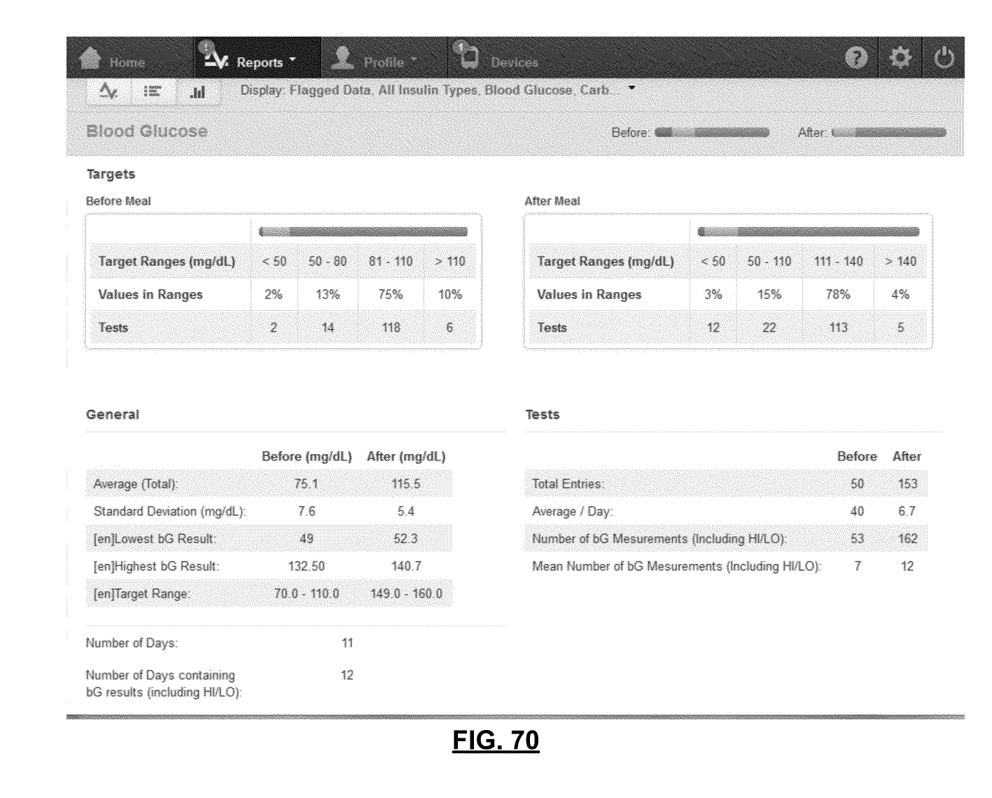

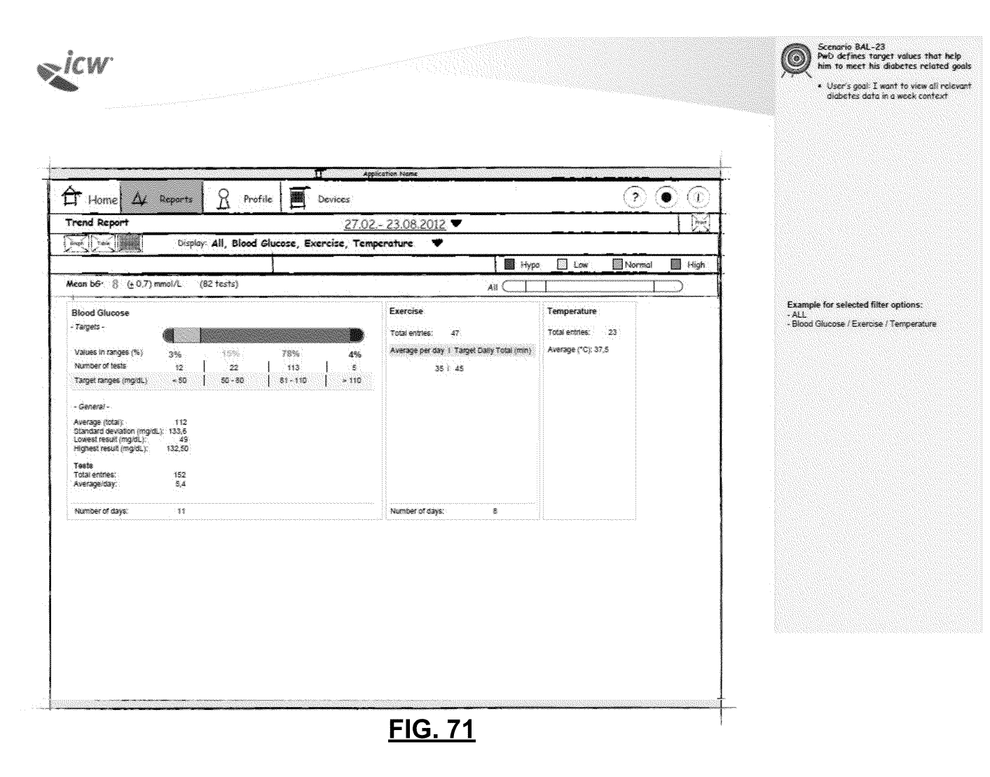

FIGS. 70 and 71 include example GUIs displaying various statistical trends. FIG. 71, for example, includes a view from a filtered selection including all blood glucose, exercise, and temperature data points.

The logbook may include features such as the creation of standard day reports. Standard day reports may include the ability to graph statistics and provide other views, in addition to drilling down to additional data. The standard day reports may provide a view of selected data over a 24 hour time period. As described above, the times defining the 24 hour period may be user set. The standard day reports may be scattered or aligned, configurable to include Date Ranges, All Data/Flagged Data, Days of the week. Data may include bG, carbs, insulin, etc. The ability to print the reports in specific formats, such as Adobe PDF, may also be provided.

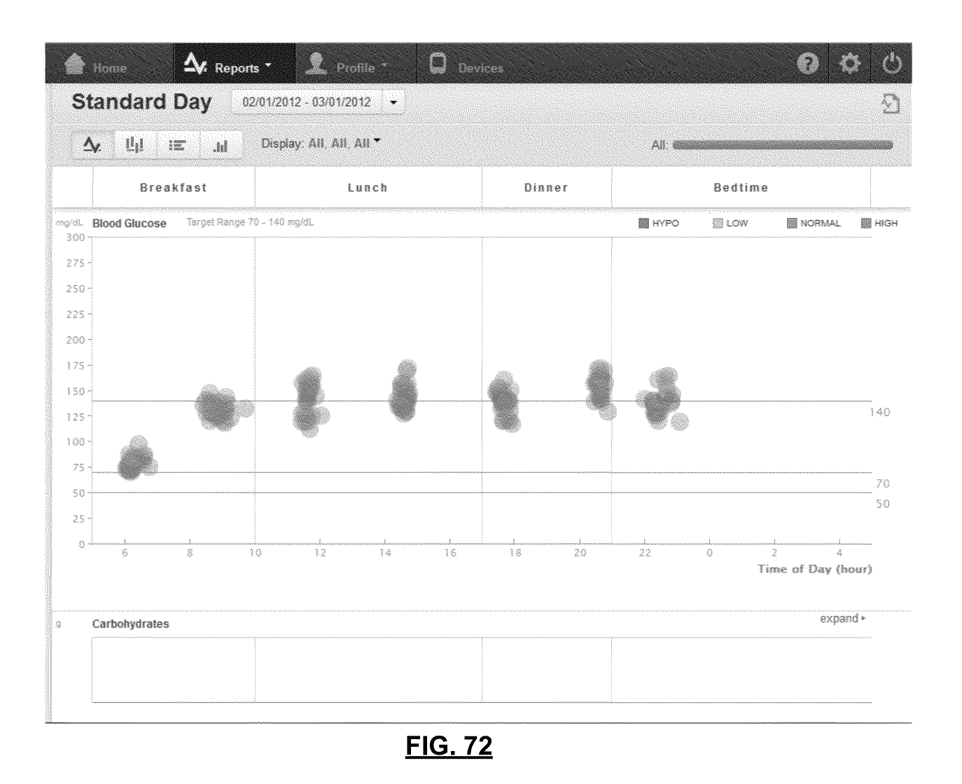

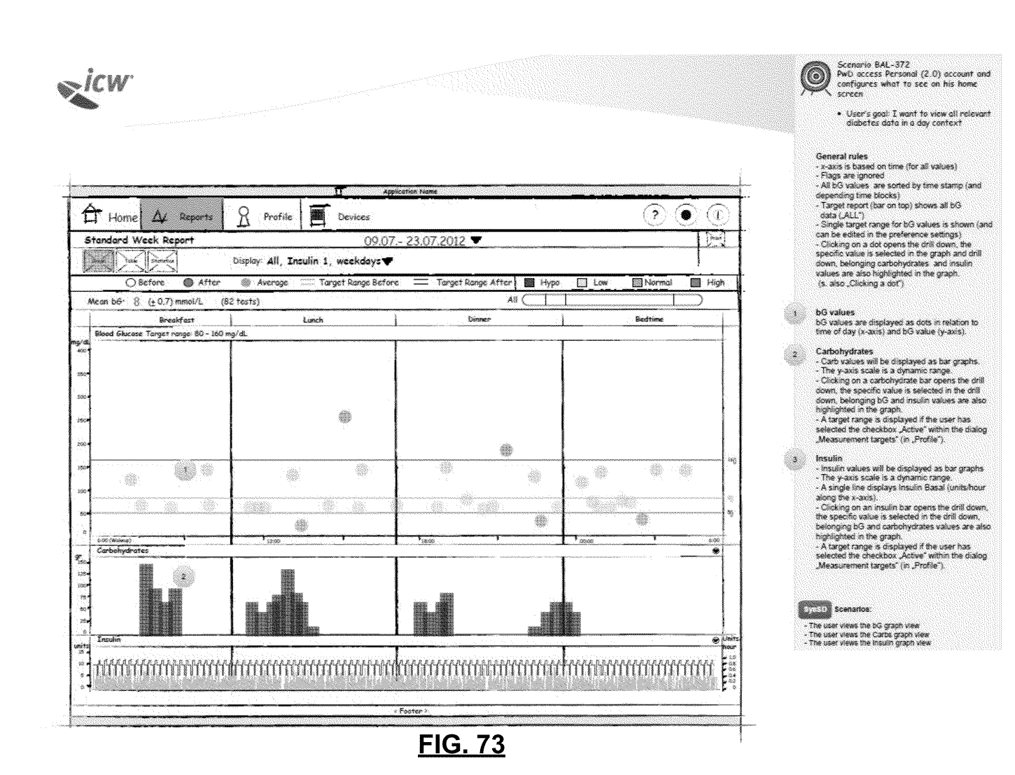

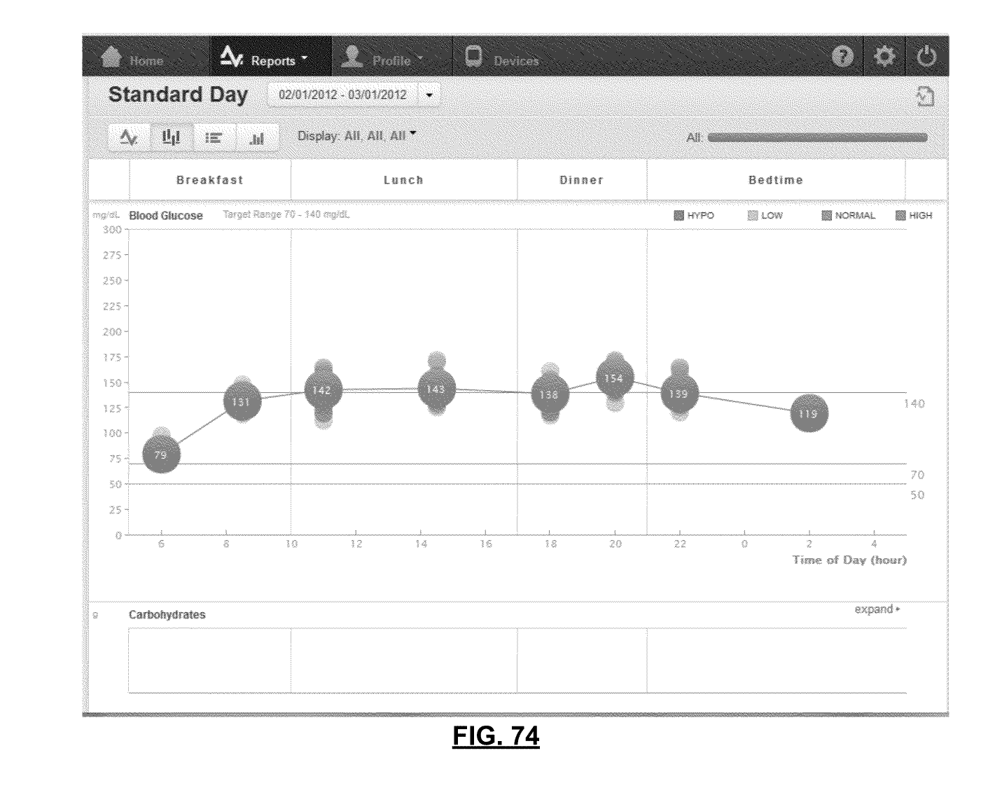

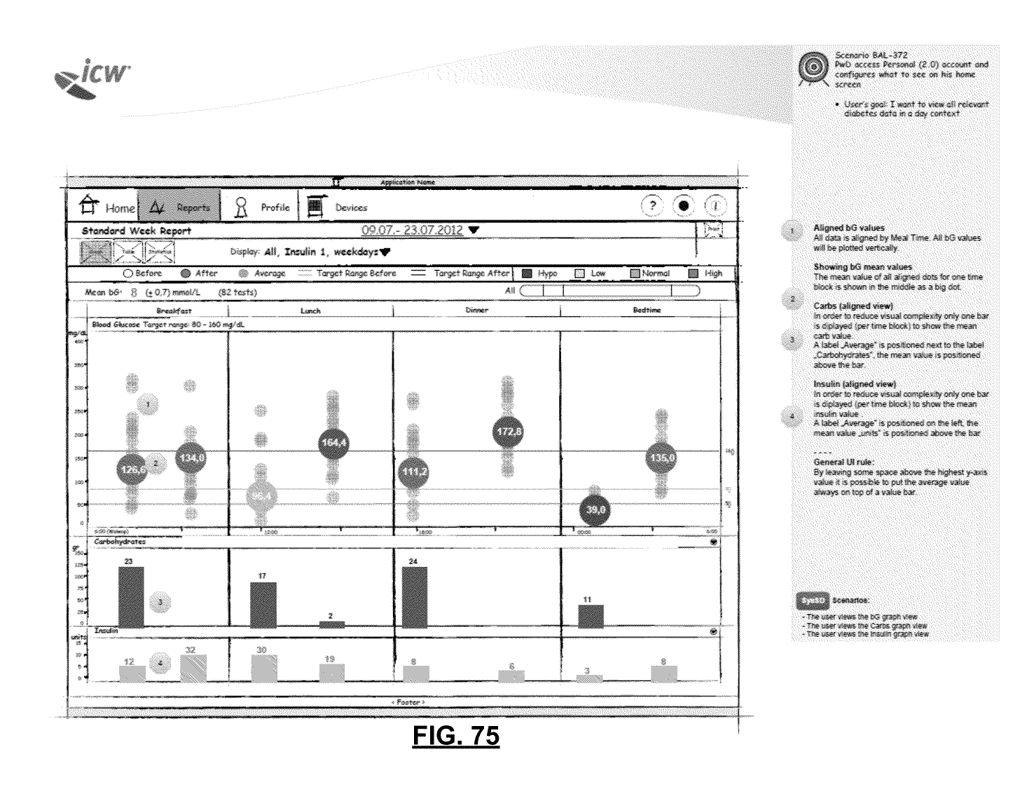

FIGS. 72 and 73 include GUIs displaying standard day reports (graph and target) with the data shown in a scattered and bar views. FIGS. 74 and 75 include GUIs displaying standard day aligned reports, with mean (average) values indicated for bG values.

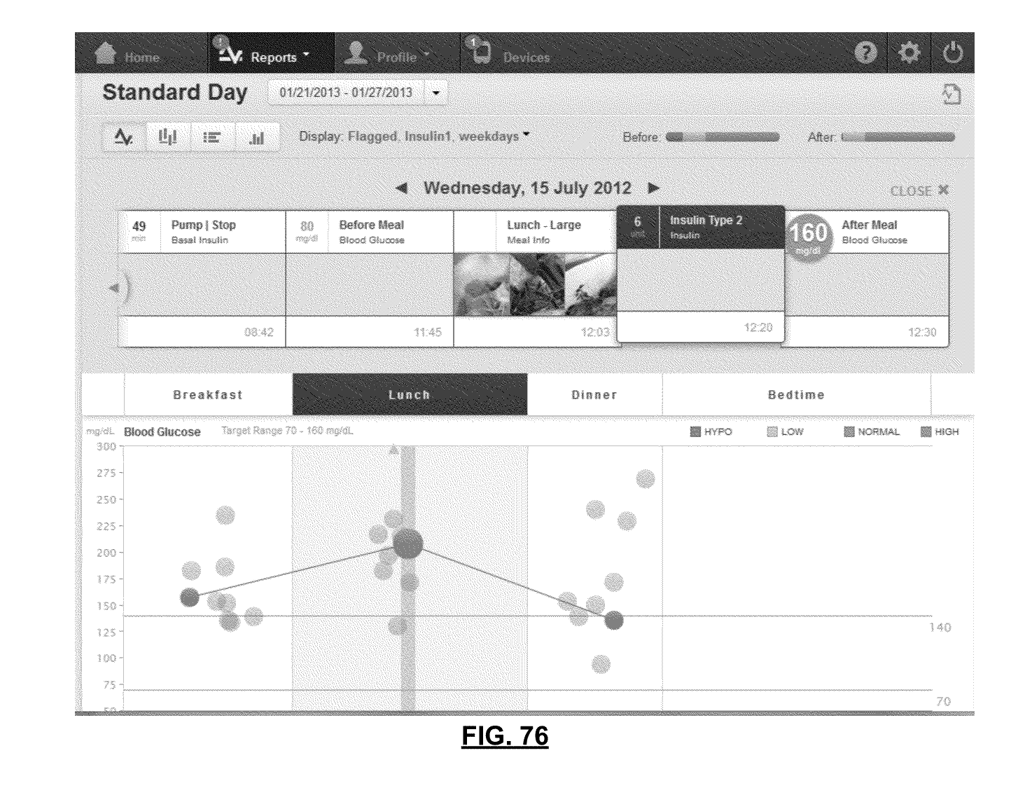

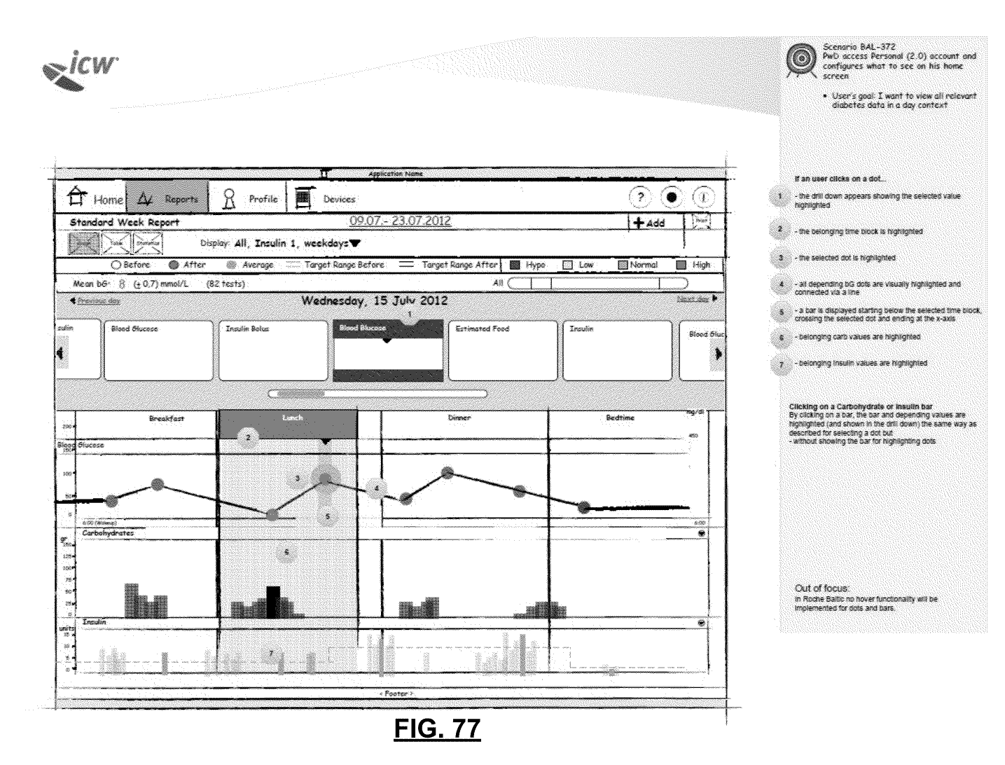

FIGS. 76 and 77 illustrate the ability to drill down on diabetes management data. For example, drilling down on the lunch time period displays the selected bG values falling within the lunch time period highlighted and connected via a line. At reference number (5), a bar may be displayed starting below the selected time block, crossing the selected dot and ending at the x-axis. Selection of the carbohydrate bar or insulin bar highlights the respective selected data.

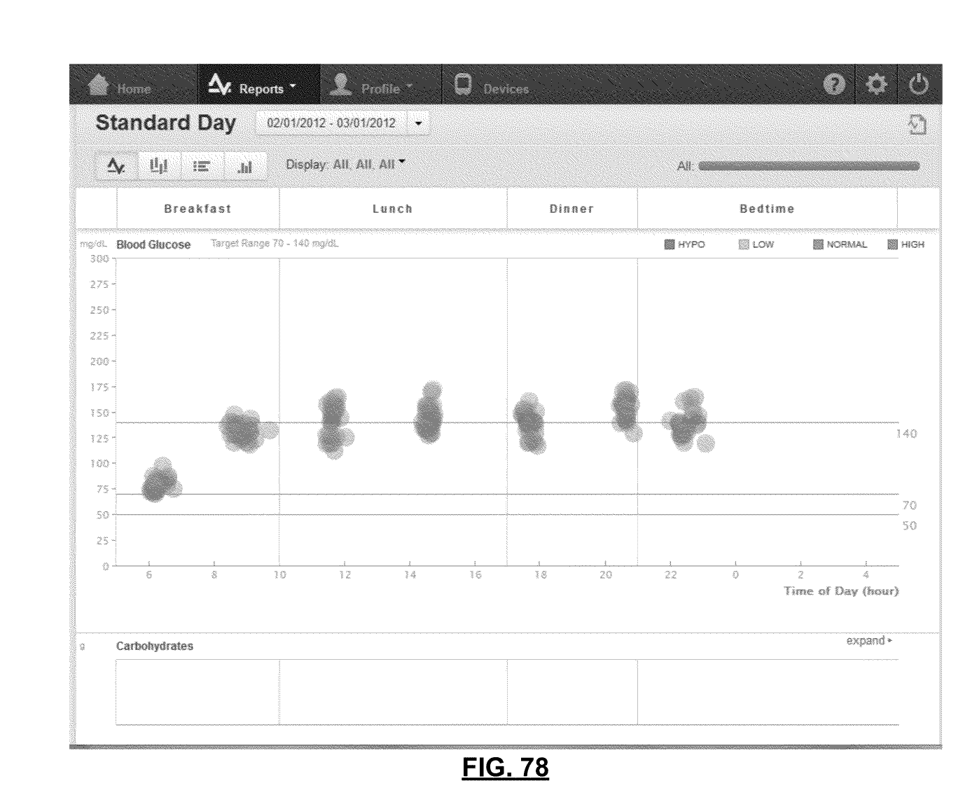

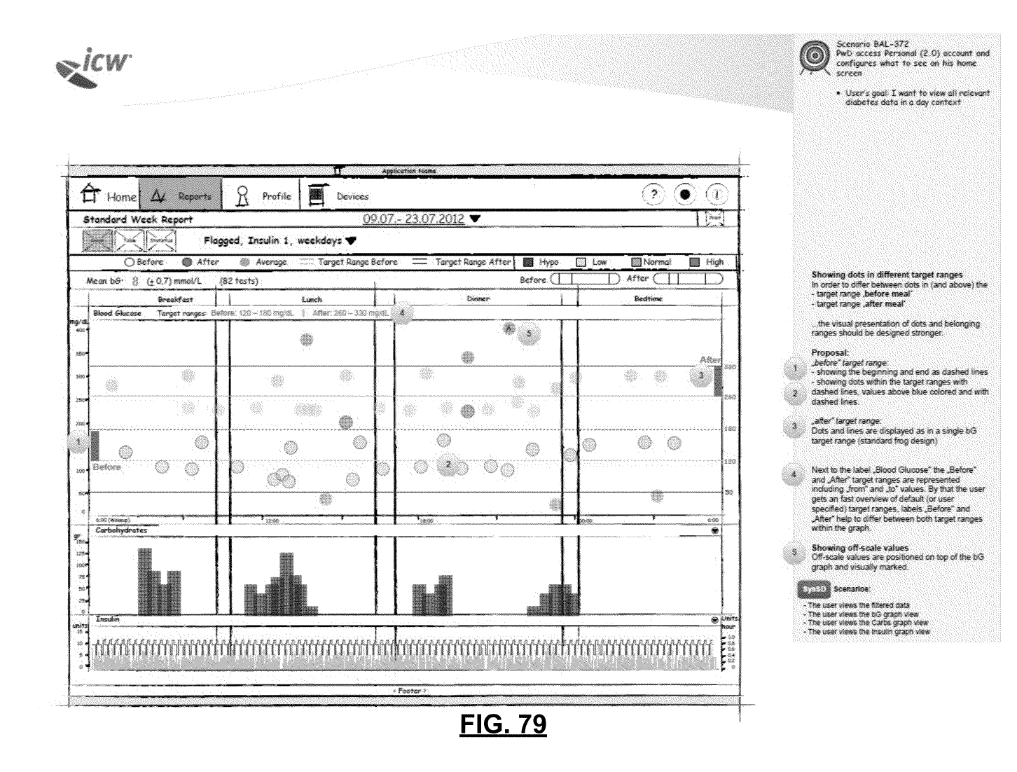

FIGS. 78 and 79 include GUIs displaying a standard day report with flagged data and all data scattered. The scales and axis may be dynamically created based on the data. Selecting a value, such as a dot, may open a drill down view and specific values are highlighted in the graphs.

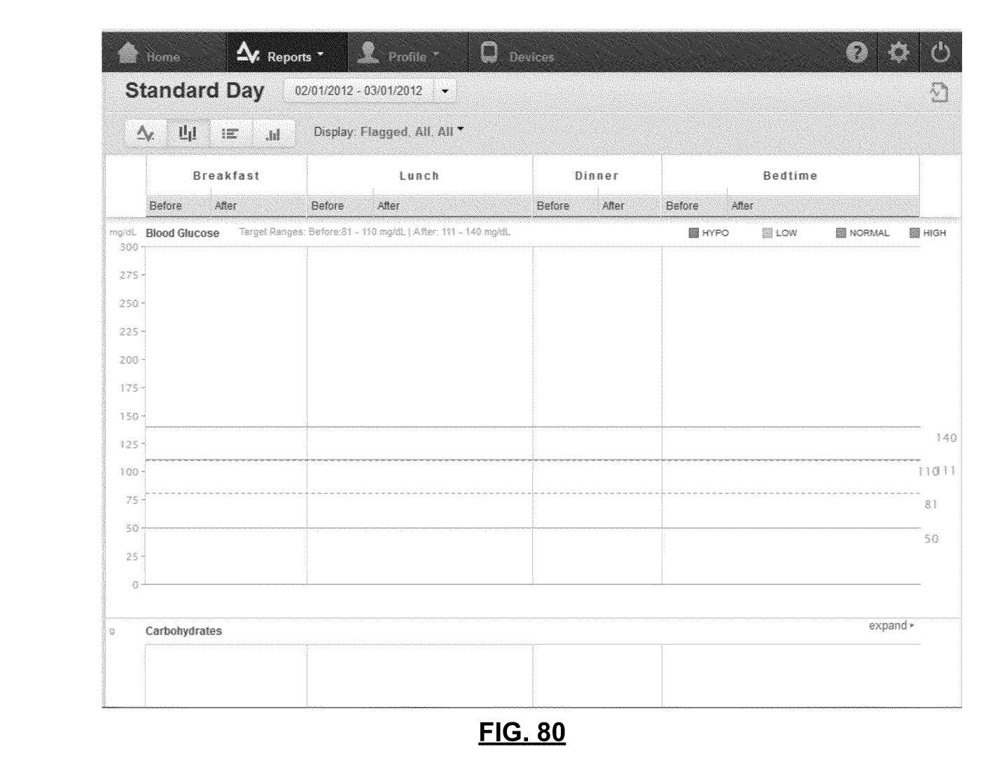

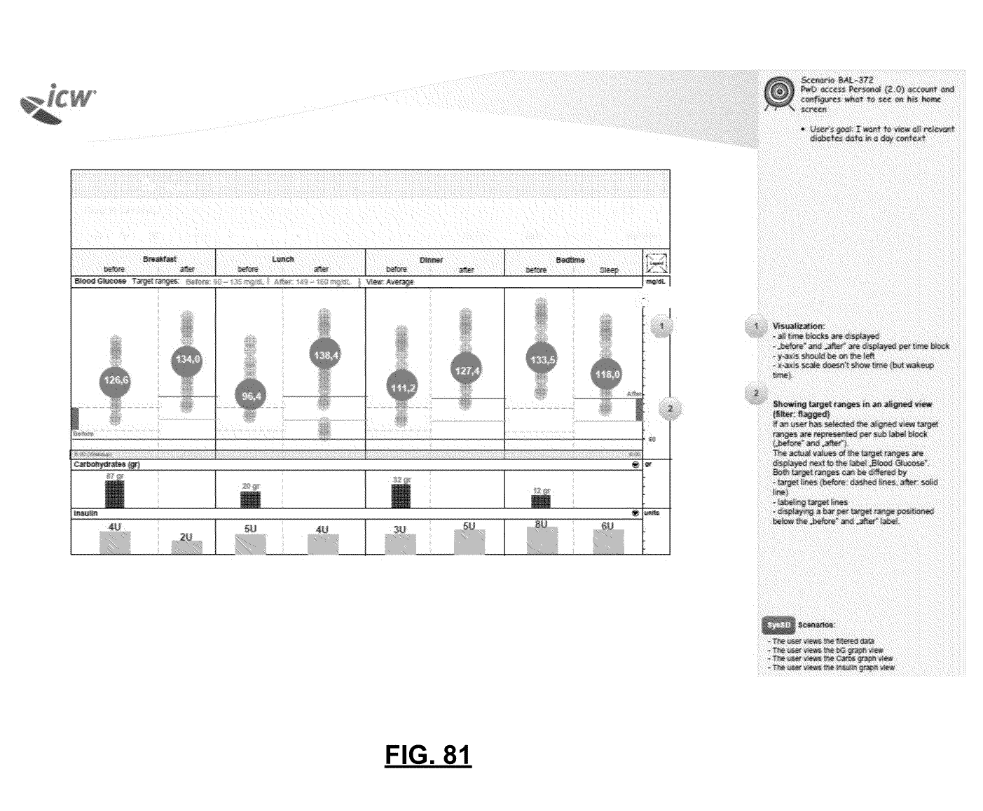

FIGS. 80 and 81 include GUIs displaying a standard day report with flagged data and all data aligned. Mean values may be specifically identified and color coded.

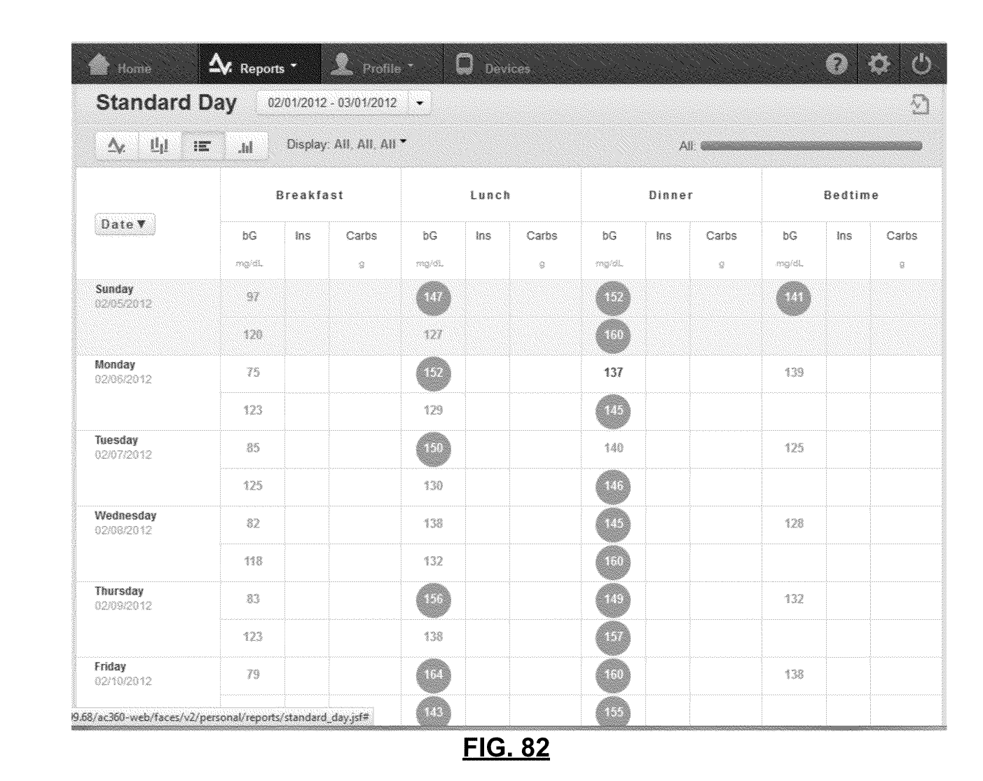

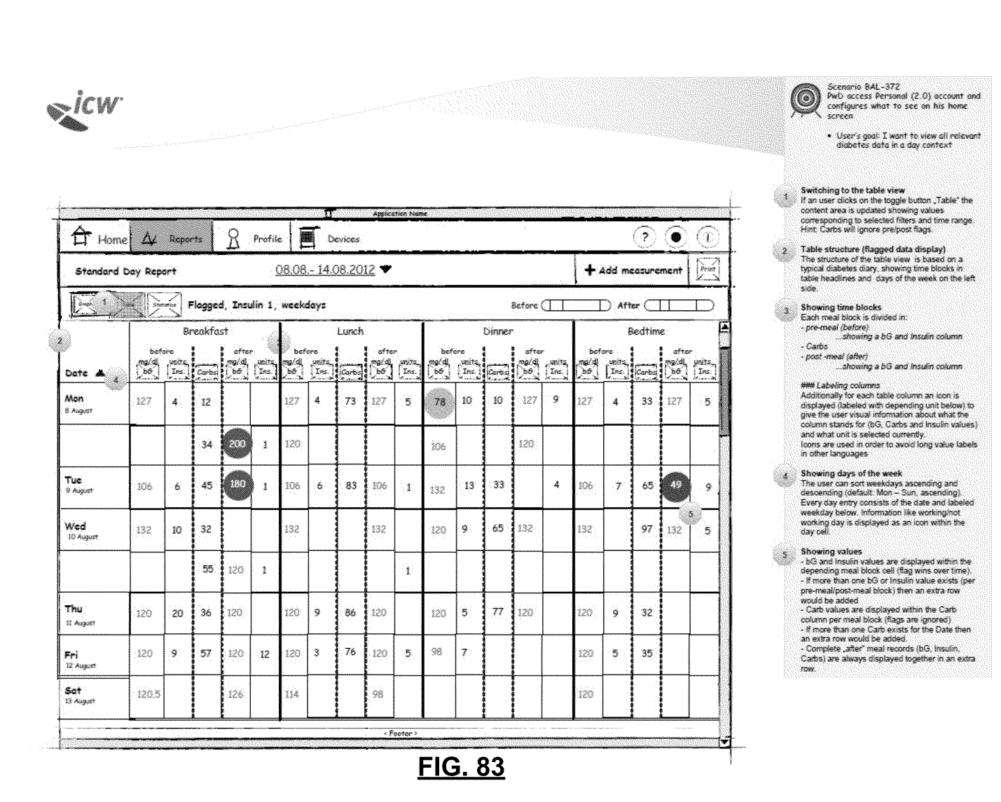

FIGS. 82 and 83 include GUIs displaying a standard day report for a month's worth of data that can be scrolled through accordingly. The table structure and content can be updated using toggle buttons, and is based on a typical diabetes diary with time blocks in table headlines and days of the week on the left side. Meals may be further divided into pre- and post-meals. Columns may be labeled with icons to avoid language issues. A user can sort through the weekdays in ascending or descending order. Numerical values are generally displayed within the respective meal block cell.

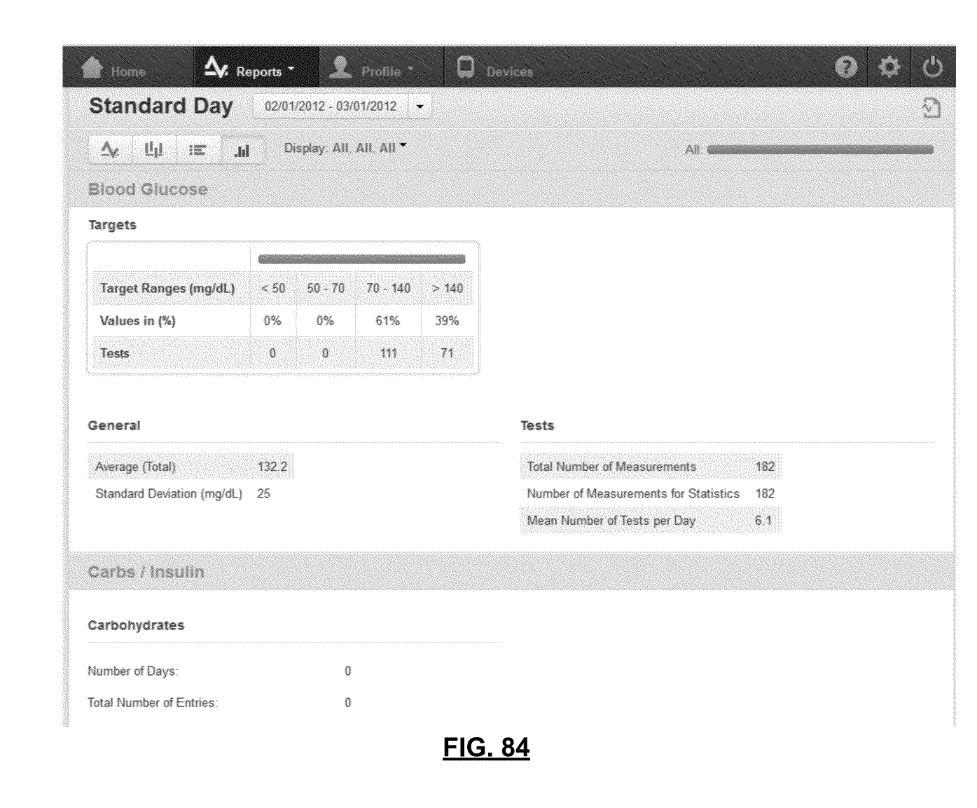

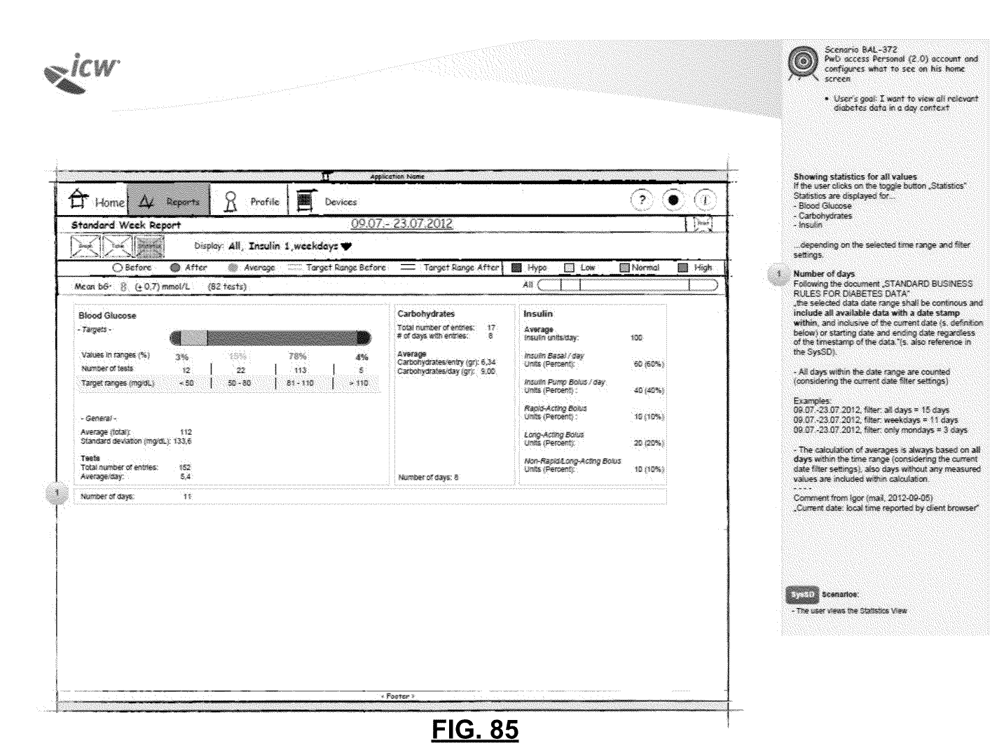

FIGS. 84 and 85 include GUIs displaying statistical information for a defined time range and filter settings. The calculation of averages is based on all days within the specified time ranges. Days without any measured values may be included in the calculations.

The logbook may further include features such as the creation of standard week reports. Standard week reports may include the ability to graph statistics and provide other views, in addition to drilling down to additional data. The standard week reports may provide a view of selected data up to a 7 day time period. The standard week reports may be scattered or aligned, configurable to include Date Ranges, All Data/Flagged Data, Days of the week. Data may include bG, carbs, insulin, etc. The ability to print the reports in specific formats, such as Adobe PDF, may also be provided.

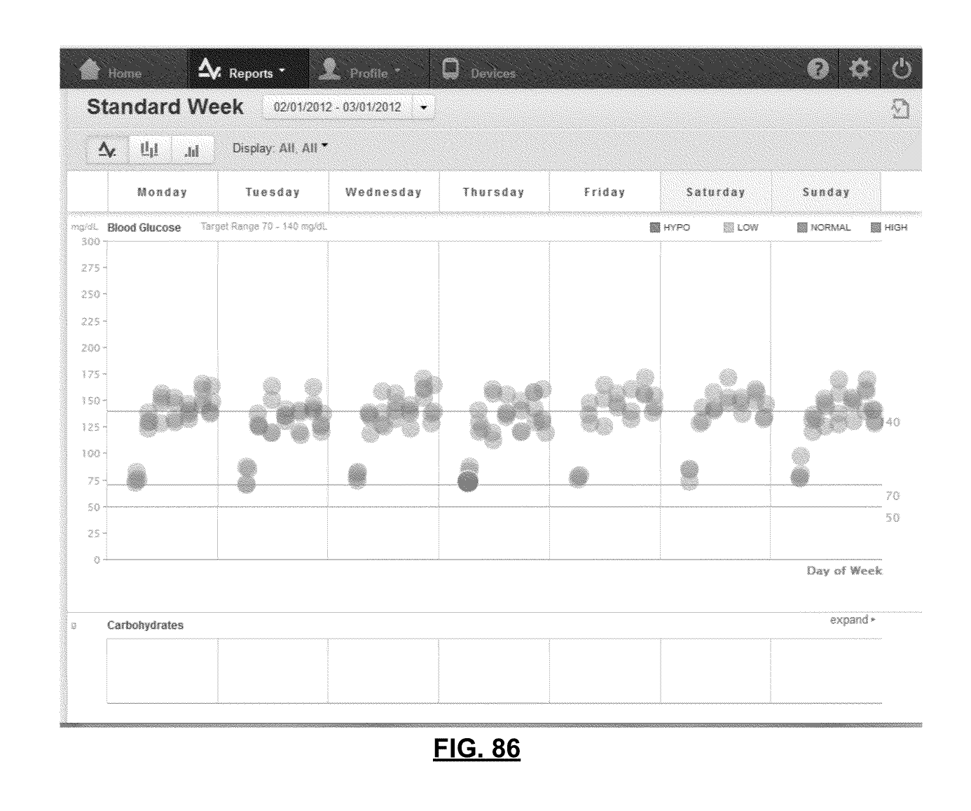

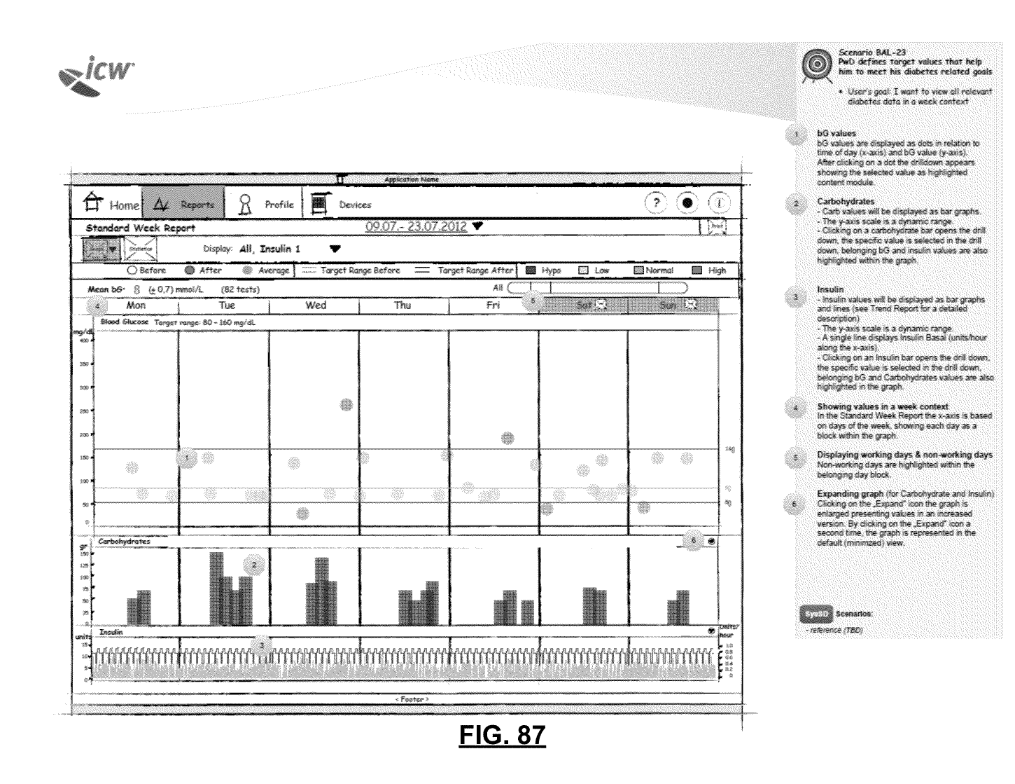

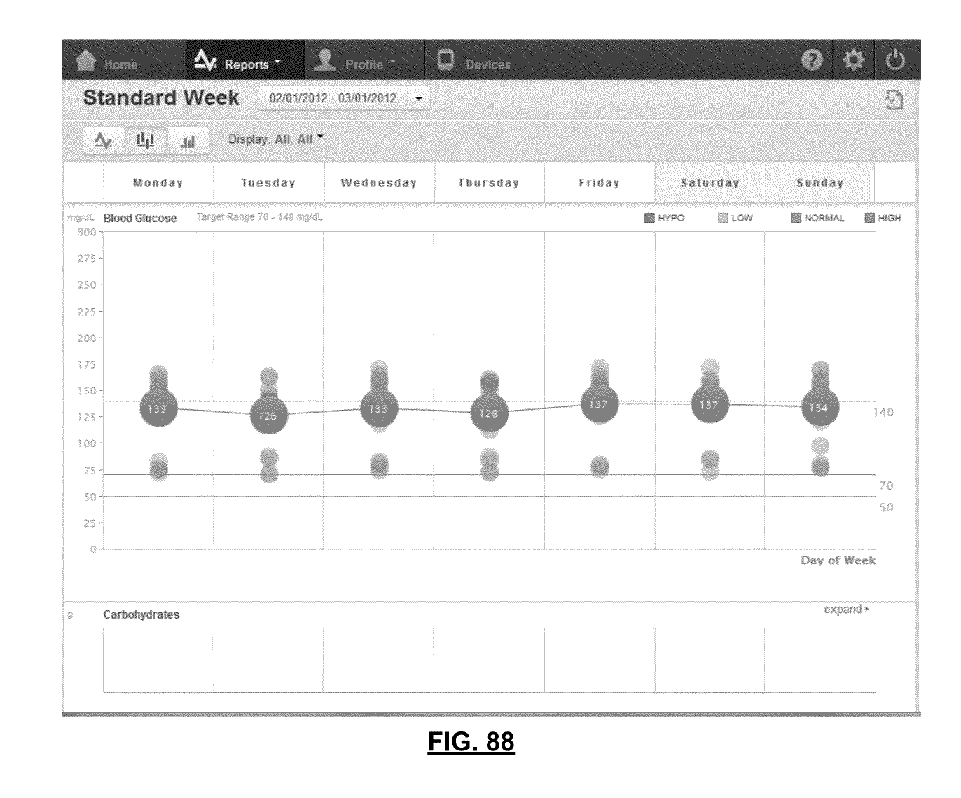

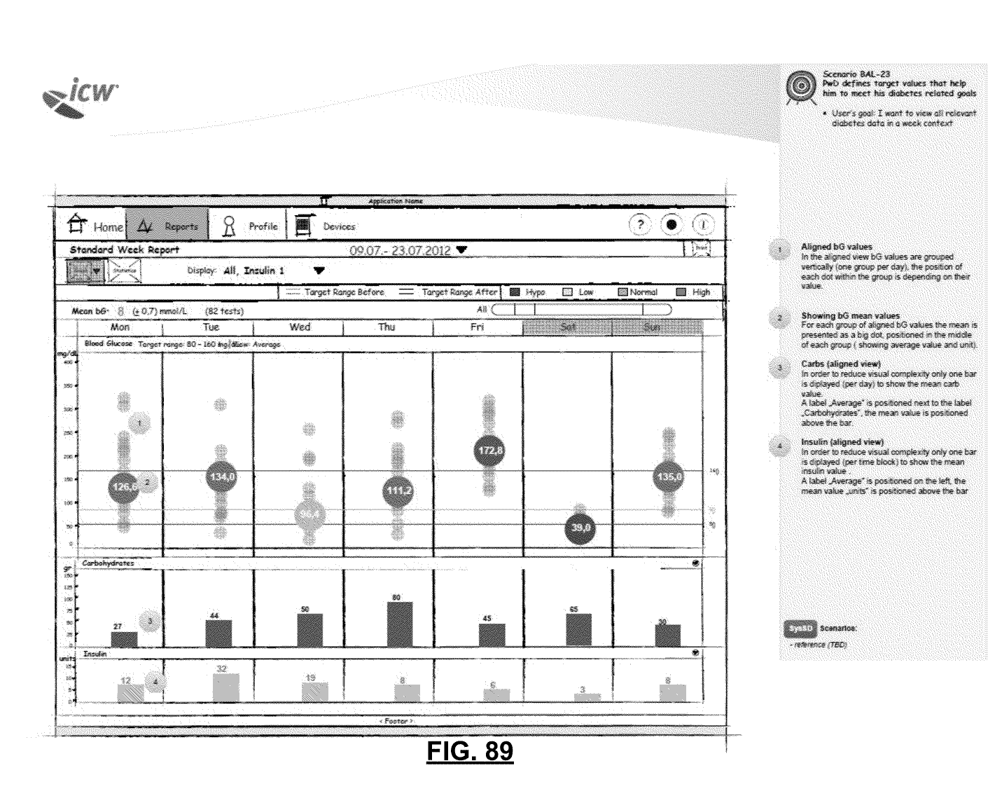

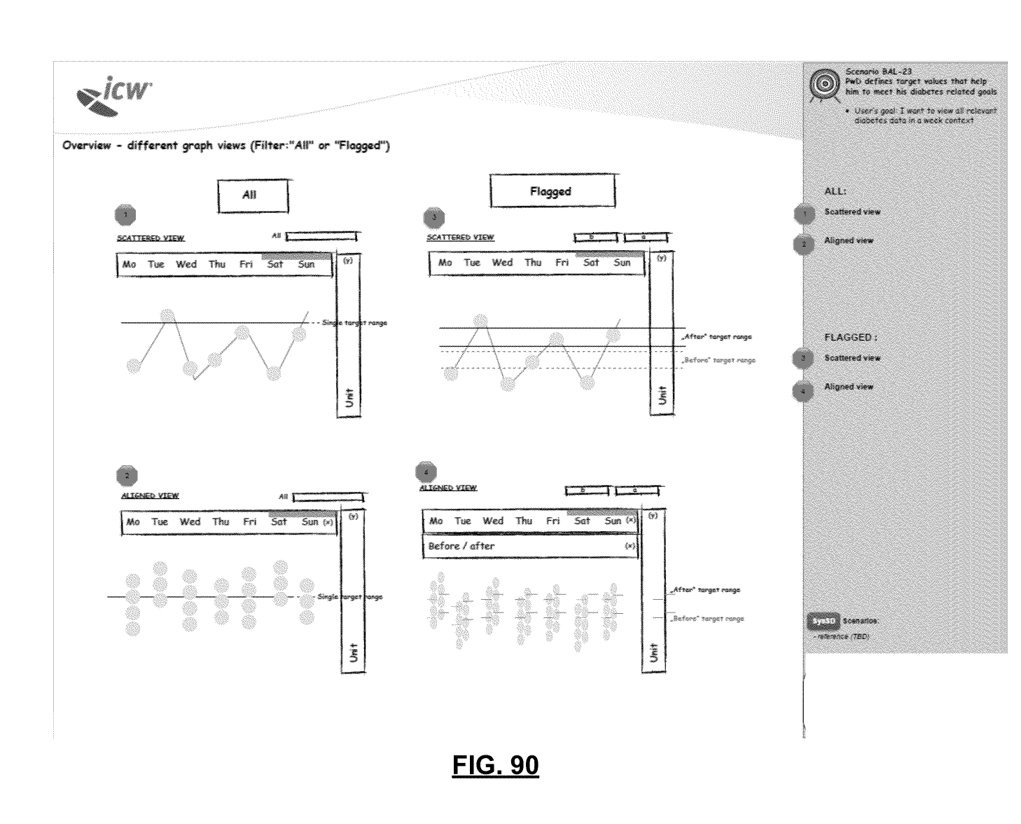

FIGS. 86 and 87 include GUIs displaying standard week reports (graph and target) with the data shown in a scattered and bar views. FIGS. 88-90 include GUIs displaying standard week aligned reports, with mean values indicated for bG values.

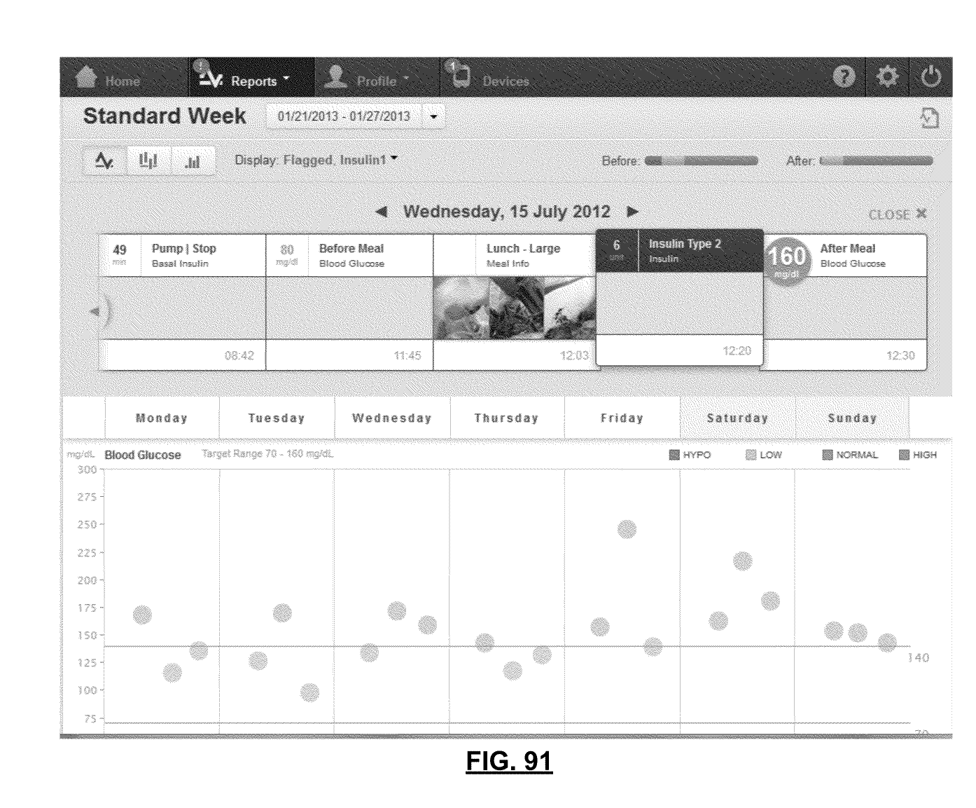

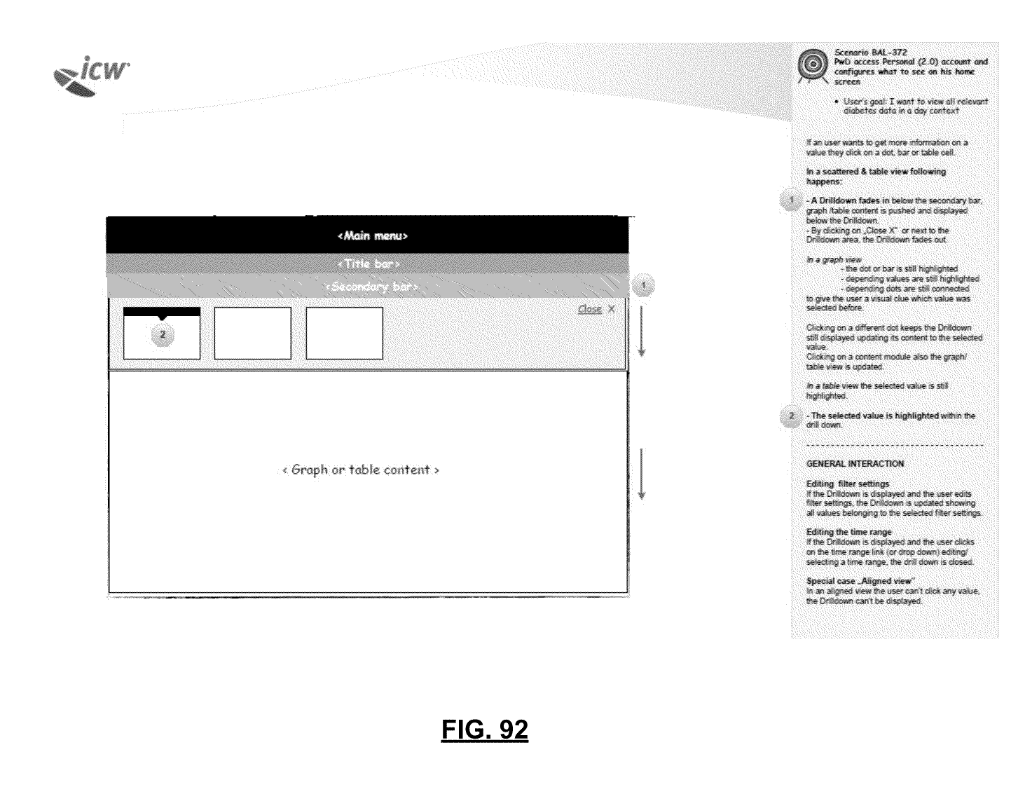

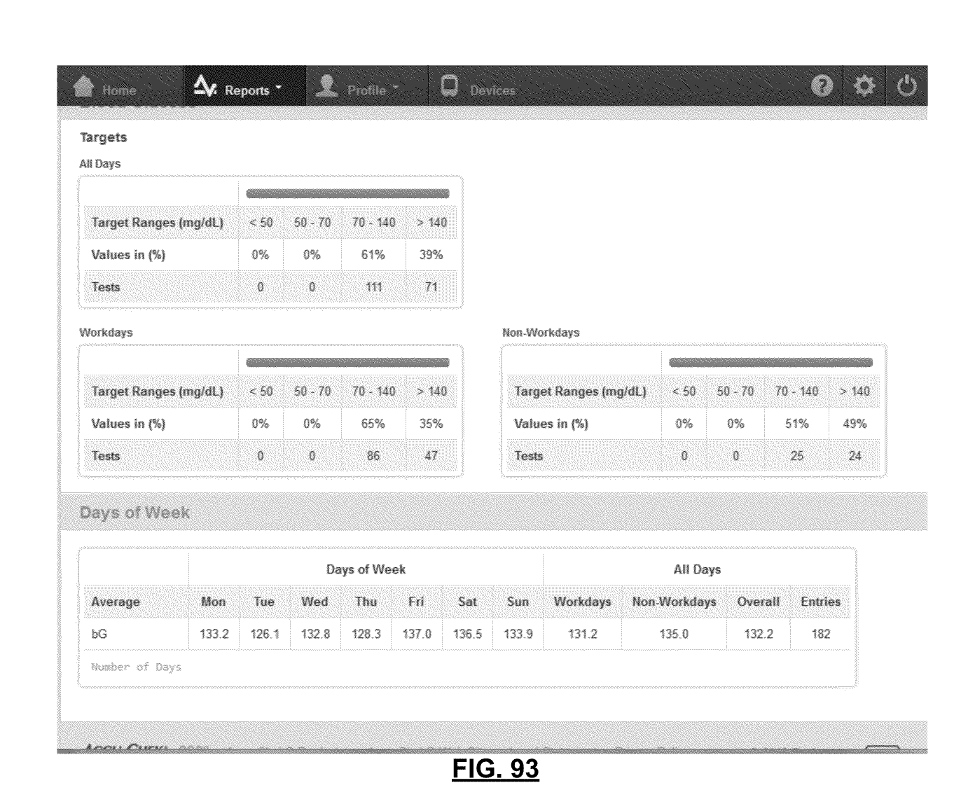

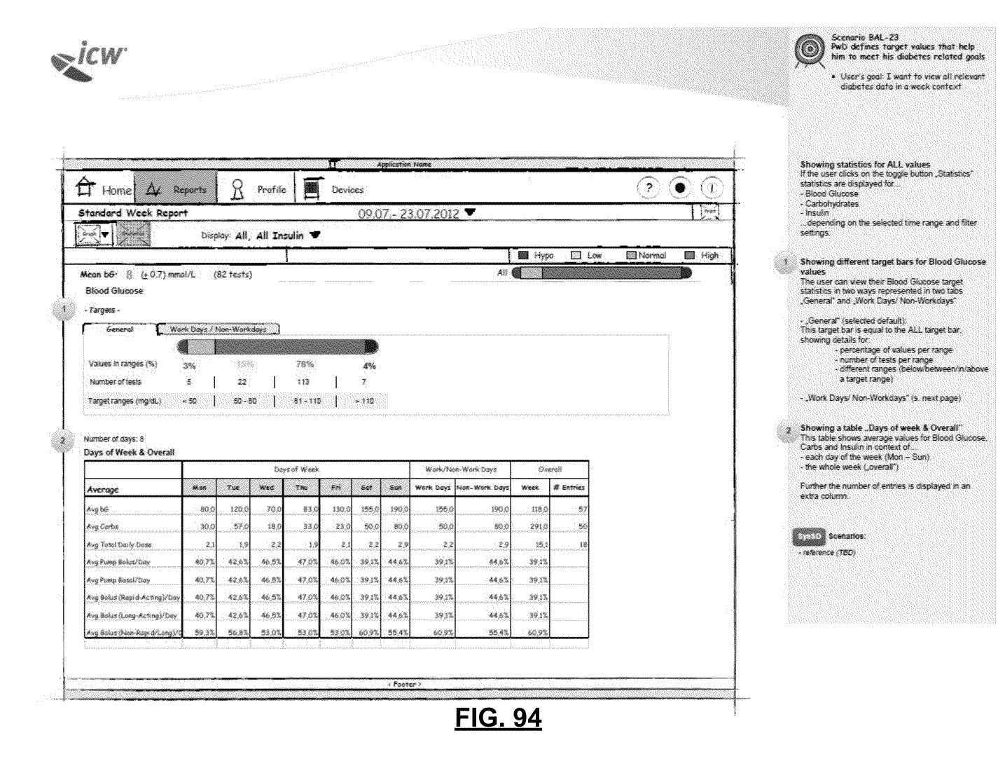

FIGS. 91 and 92 include GUIs illustrating the ability to drill down on diabetes management data within the standard week report. FIGS. 93 and 94 include GUIs displaying statistical information for a defined time range and filter settings. The calculation of averages is based on all days within the specified time ranges. Days without any measured values may be included in the calculations.

The logbook may further include features such as the creation of 3-day profile reports with a 3-day structured test. These reports may include the ability to graph statistics and provide other views, in addition to drilling down to additional data. The 3-day profile reports may provide a view of selected data up to a 72 hour (x-axis) time period and a 24 hour (x-axis) overlay. The 3-day profile reports may be scattered or aligned, configurable to include Day selections (Day 1, 2, 3, and all). Data may include bG, carbs, insulin, etc. The ability to print the reports in specific formats, such as Adobe® PDF, may also be provided.

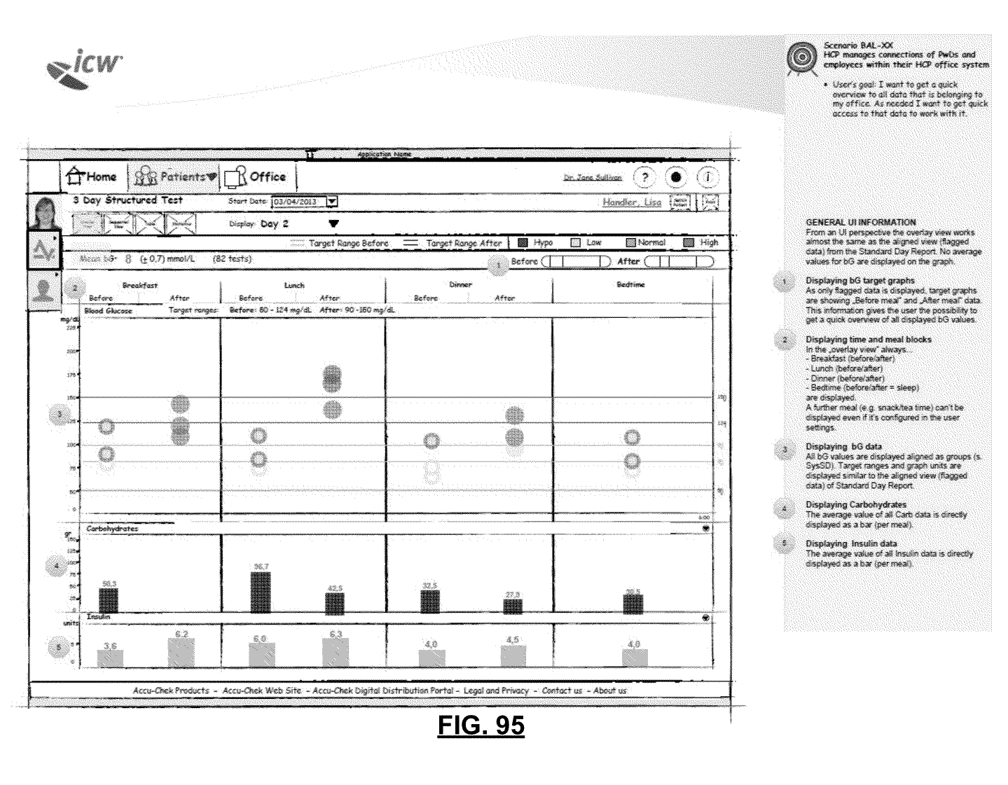

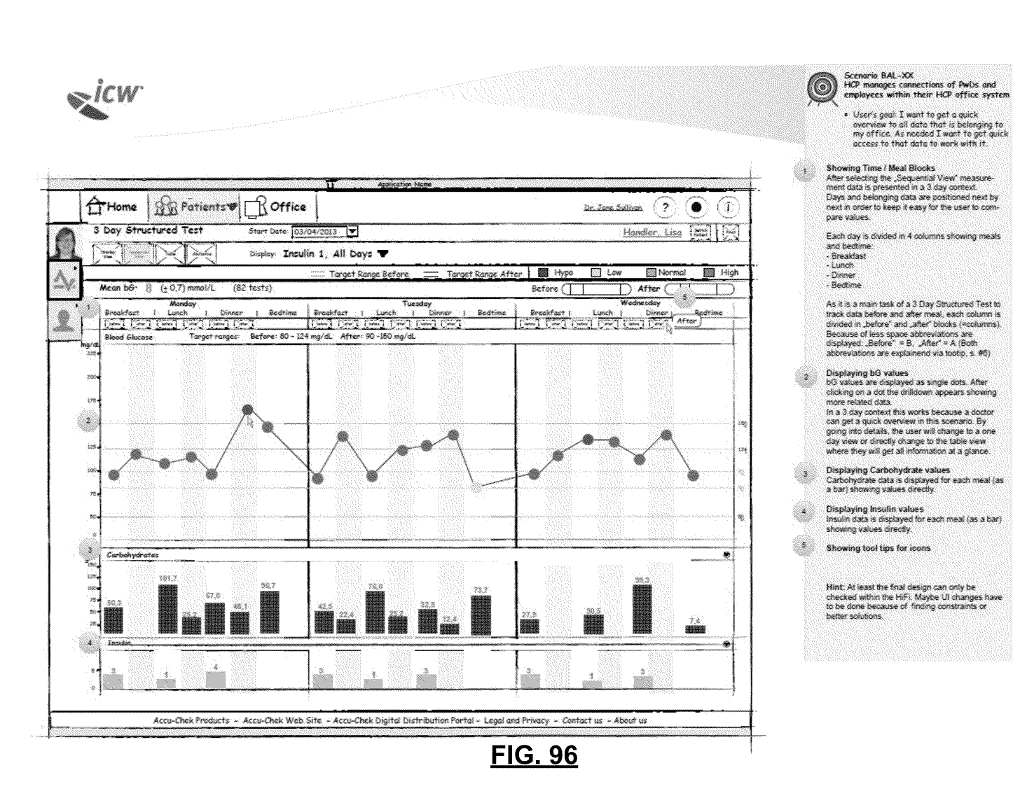

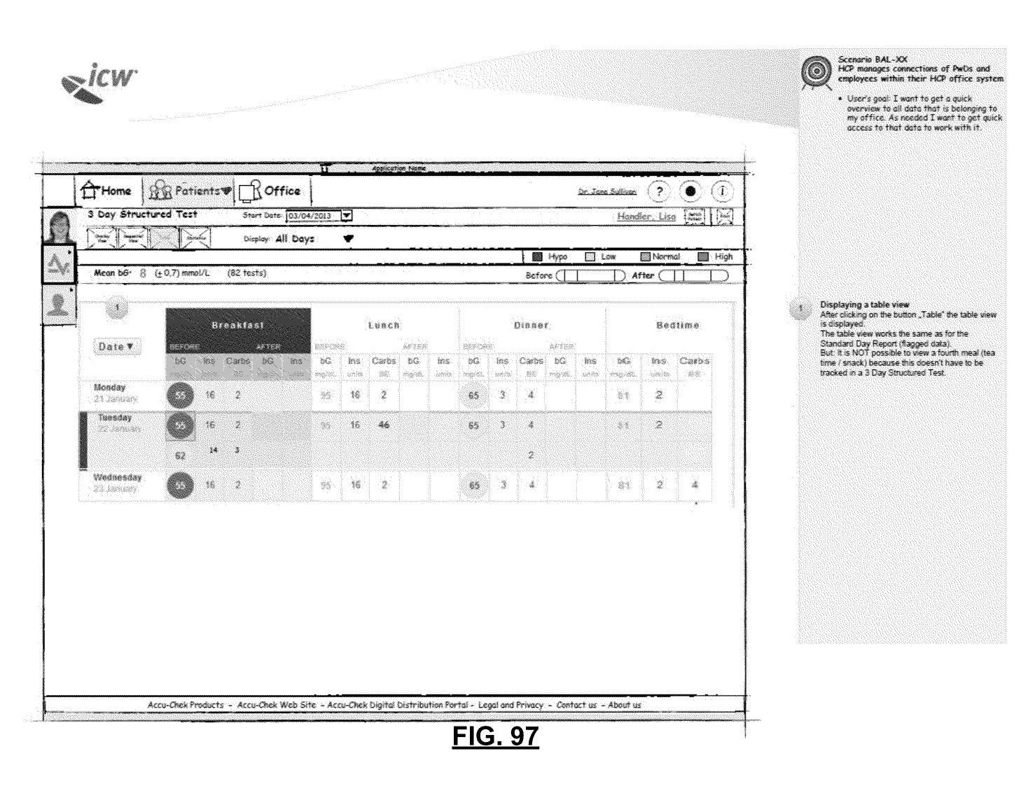

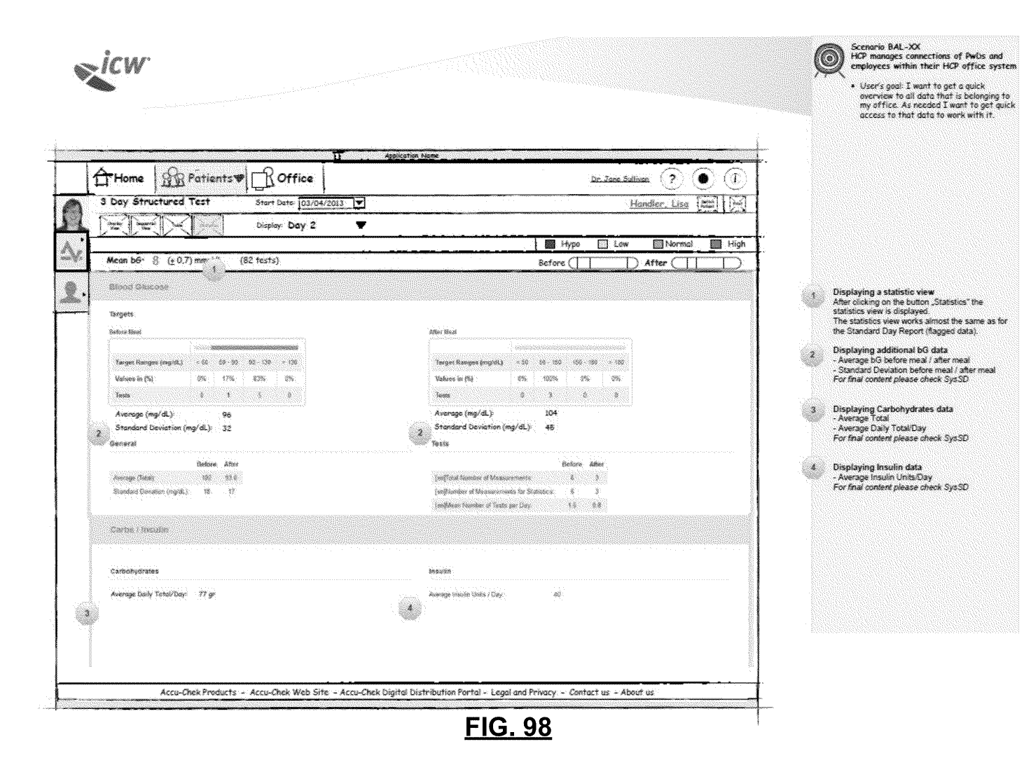

FIG. 95 includes a GUI displaying a one-day overlay graph. FIG. 96 includes a GUI displaying a three-day sequential graph. FIG. 97 includes a GUI displaying a table view for a three-day period. FIG. 98 includes a GUI displaying a view of the statistical data for a selected 3-day period.

The logbook may further include features such as the creation of patient summary reports. Patient summary reports may provide a quick overview of a patient's diabetes management data. The patient summary reports may provide a view of selected diabetes management data configurable for a date range, option for device settings, advice statistics, and pump statistics. The patient summary reports may include trend graphs, statistical analysis, advice statistics, pump statistics, and device settings. The ability to print the reports in specific formats, such as Adobe® PDF, may also be provided.

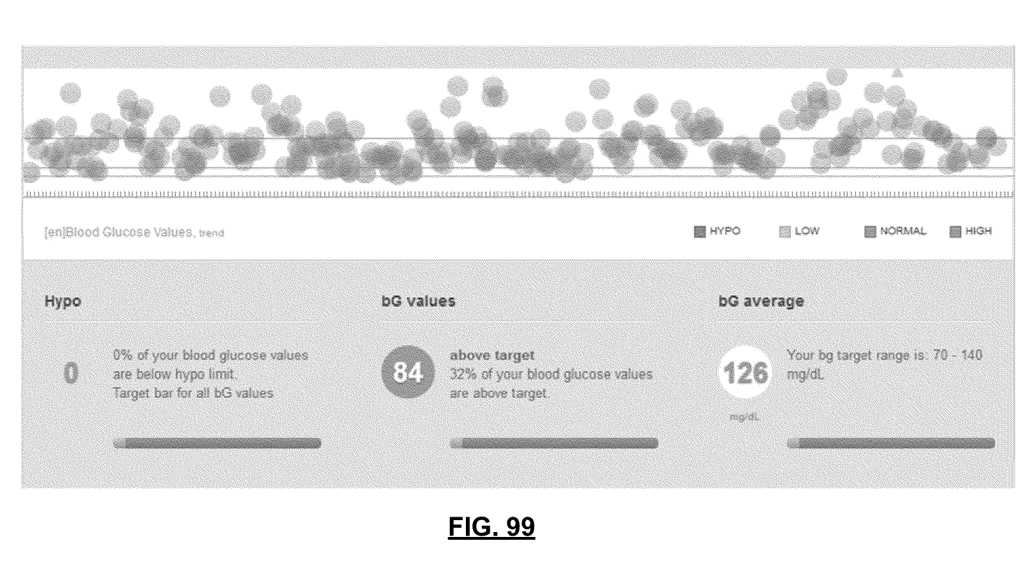

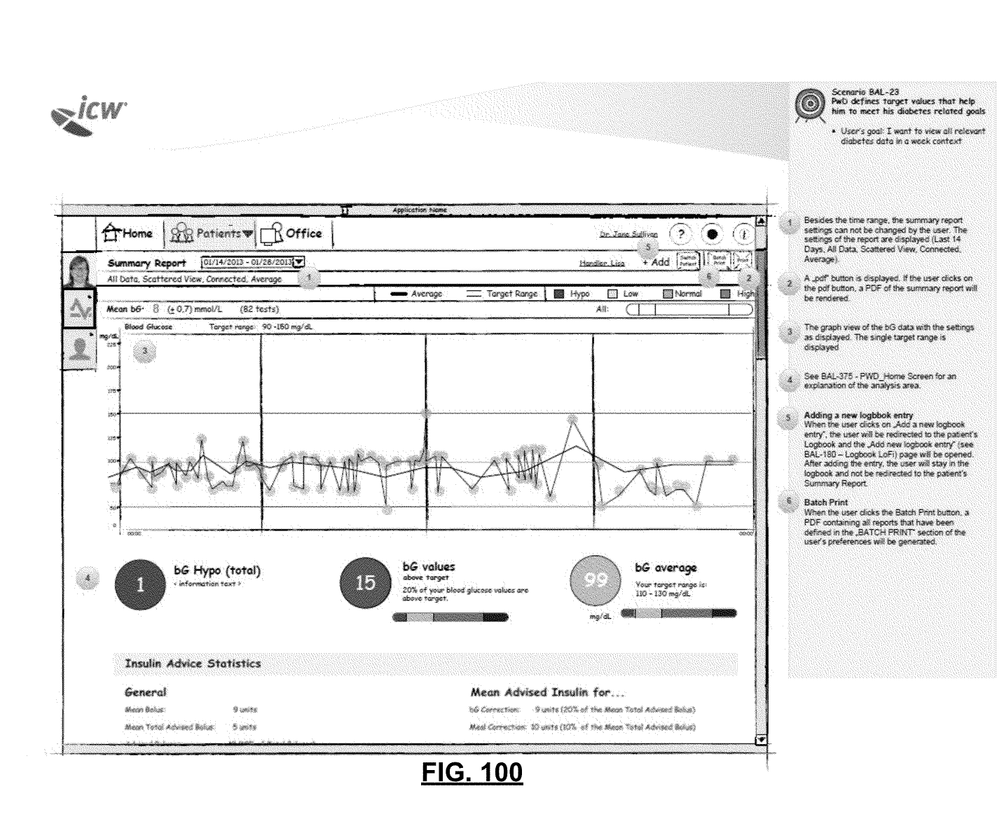

FIG. 99 includes a GUI providing a summary report for a patient. FIG. 100 includes a GUI displaying all relevant diabetes management data in a week context.

The logbook may further include features such as the creation of 15 day side-by-side reports, and settings reports. The ability to print these reports in specific formats, such as Adobe® PDF, may also be provided.

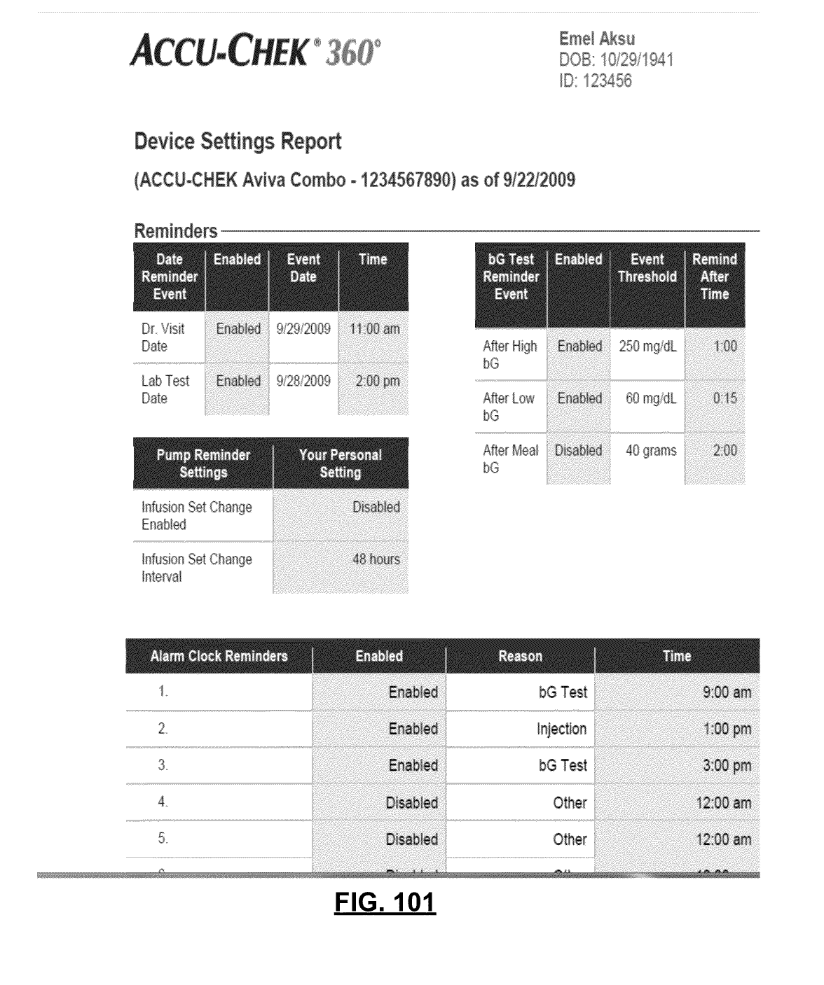

FIG. 101 includes a GUI displaying a device settings report for one specific device.

The server computer 18 also provides dynamic home page setting for both health care professional and patient accounts. For example, the server computer 18 provides a health care professional “home page” that includes dynamic information set based upon current account information including getting started areas, patients list, pending invitations, pending device associations/links, system messages, product messages, and statistical analysis. The server computer 18 provides also provides a patient “home page” that includes dynamic information set based upon patient's diabetes related settings (diabetes type, therapy type, amount of diabetes management data uploaded, types of diabetes management data uploaded, etc.) and includes getting started, graphs (trend and standard day), analysis, and Life Stream. For both the healthcare provider and patient accounts, the server computer 18 provides contextual navigation from the home page to reports.

The server computer 18 sets the home page displayed for an account based on the following tables.

Home Defaults

| | | | Analysis Statistic Options | | | | | | |
|---|---|---|---|---|---|---|---|---|---|
| | | | | bG | Pre-meal | Post-meal | bG avg | Meal vs. | Exercise |
| Therapy | bG | Date | Hypo | above | bG above | bG above | vs. | daily | vs. |
| type | Graph | Range | bG | target | target | target | target | target | target |
| Meal- | Std. | 1 | F | | G | G | | | |
| Dosed | Day | week | | | | | | | |
| Insulin | | | | | | | | | |
| Standard | Trend | 3 | E | E | | | E | | |
| Insulin | | weeks | | | | | | | |
| Oral & | Trend | 3 | C | C | | | C | | |
| Exercise & | | weeks | | | | | | | |
| Meal Plan | | | | | | | | | |
| Oral | Trend | 3 | D | D | | | D | | |
| Medication | | weeks | | | | | | | |
| Meal Plan | Trend | 3 | | C | | | | C | C |
| & Exercise | | weeks | | | | | | | |
| Exercise | Trend | 3 | | B | | | B | | B |
| | | weeks | | | | | | | |
| Meal Plan | Trend | 3 | | A | | | A | A | |
| | | weeks | | | | | | | |
| Other | Trend | 3 | D | D | | | D | | |
| | | weeks | | | | | | | |

Statistic Report Selection

| Report Option | Report | Settings |
|---|---|---|
| A | Trend | Date Range = Current Date Range |
| | | Data Filter = All Data |
| | | Graph = bG, Calories |
| | | Connected = No |
| | | Average = No |
| B | Trend | Date Range = Current Date Range |
| | | Data Filter = All Data |
| | | Graph = bG, Exercise |
| | | Connected = No |
| | | Average = No |
| C | Trend | Date Range = Current Date Range |
| | | Data Filter = All Data |
| | | Graph = bG, Calories, Exercise |
| | | Connected = No |
| | | Average = No |
| D | Trend | Date Range = Current Date Range |
| | | Data Filter = All Data |
| | | Graph = bG |
| | | Connected = No |
| | | Average = No |
| E | Trend | Date Range = Current Date Range |
| | | Data Filter = All Data |
| | | Graph = bG, Carbohydrates, Insulin |
| | | Connected = No |
| | | Average = No |
| F | Standard | Date Range = Current Date |
| | Day | Range Data Filter = All Data |
| | | Insulin Filter = All |
| | | Days of Week Filter = All Days |
| | | View: Graph, Scattered, Not Connected |
| G | Standard | Date Range = Current Date |
| | Day | Range Data Filter = Flagged Data |
| | | Insulin Filter = All |
| | | Days of Week Filter = All Days |
| | | View: Graph, Scattered, Not Connected |

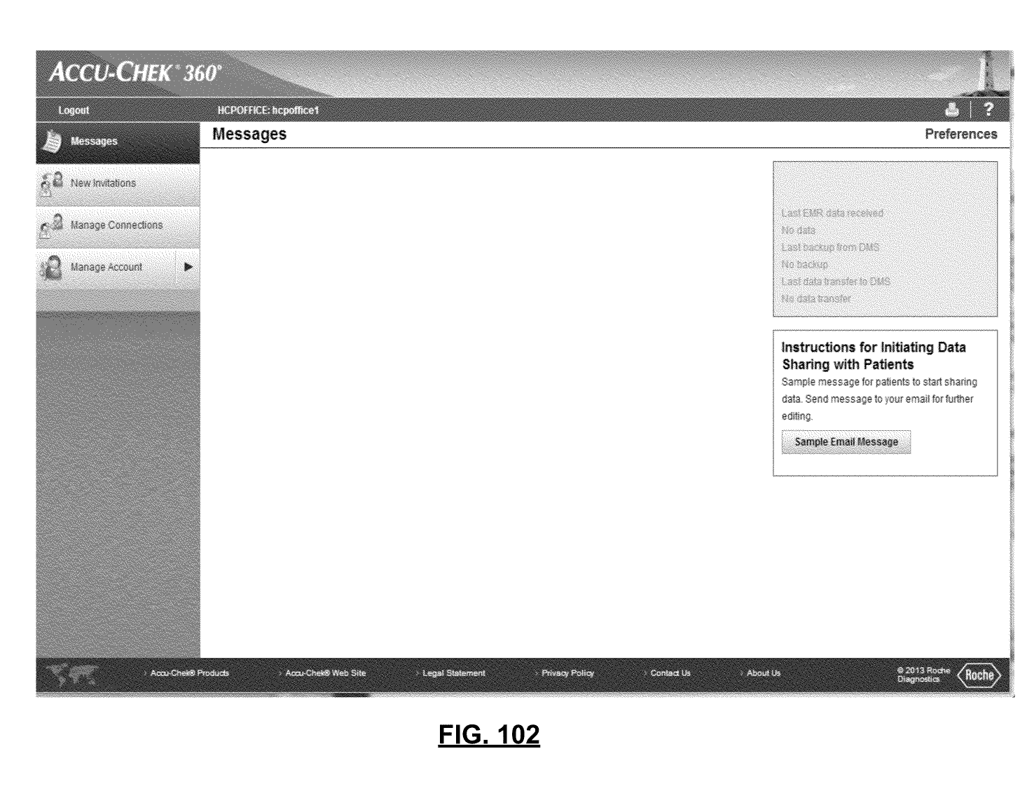

FIG. 102 includes a GUI for displaying a simple home page for a healthcare professional account and includes features such as system messages, product messages, and invitation notices.

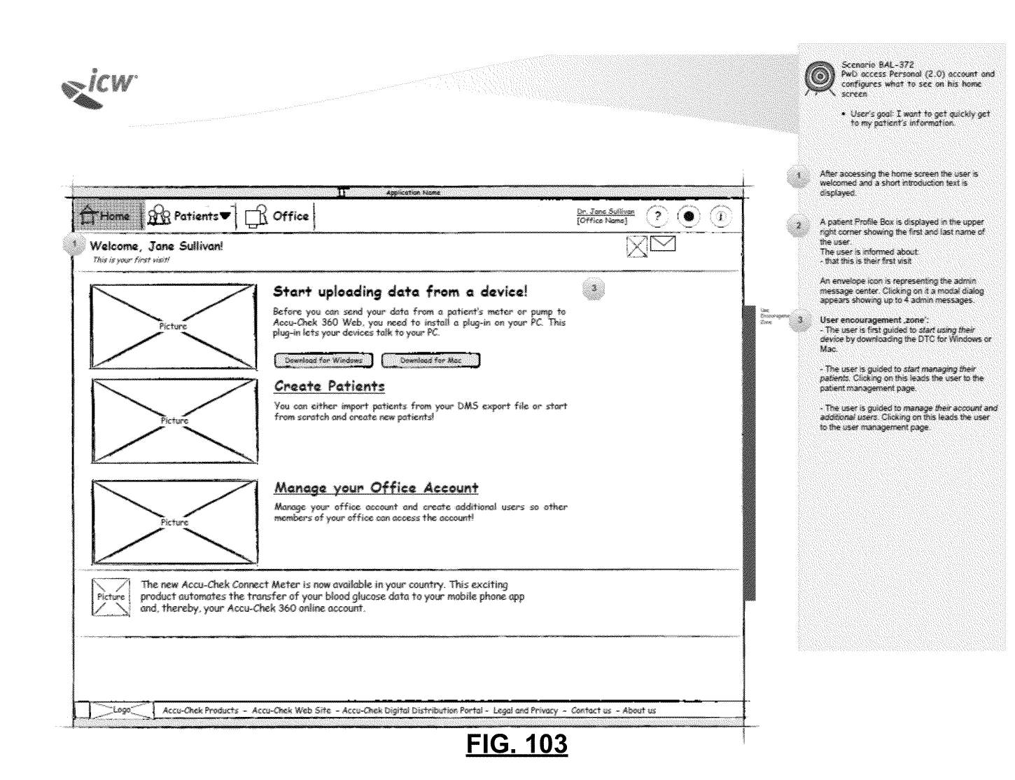

FIG. 103 includes a GUI for displaying access to dynamic information based on current account information, including “getting started” areas, patients list, pending invitations, pending device associations, system messages, product messages, etc. In one example, after the user is presented with the home page, the server computer 18 displays a welcome message to the user and displays a short introduction screen. A patient profile box may be shown in the upper right corner providing the first and last name of the user. As shown, the user is informed of a message. In the example of FIG. 103, the user is informed that this is their first visit. An envelope icon is provided representing the administrative message center. Selecting it opens a model dialog that shows up to four administrative messages. Reference number (3) of FIG. 103 provides an area referred to as a “user encouragement zone” where messages can be displayed to the user for encouraging the user to use various features.

In various aspects, the user may be guided to start using their device by downloading a software plug-in for use with a Windows®, Mac®, or other operating system. The user may also be guided to start managing their patients. Selecting this option leads the user to the patient management page. The user may then be guided to manage their account and additional users via a user management page.

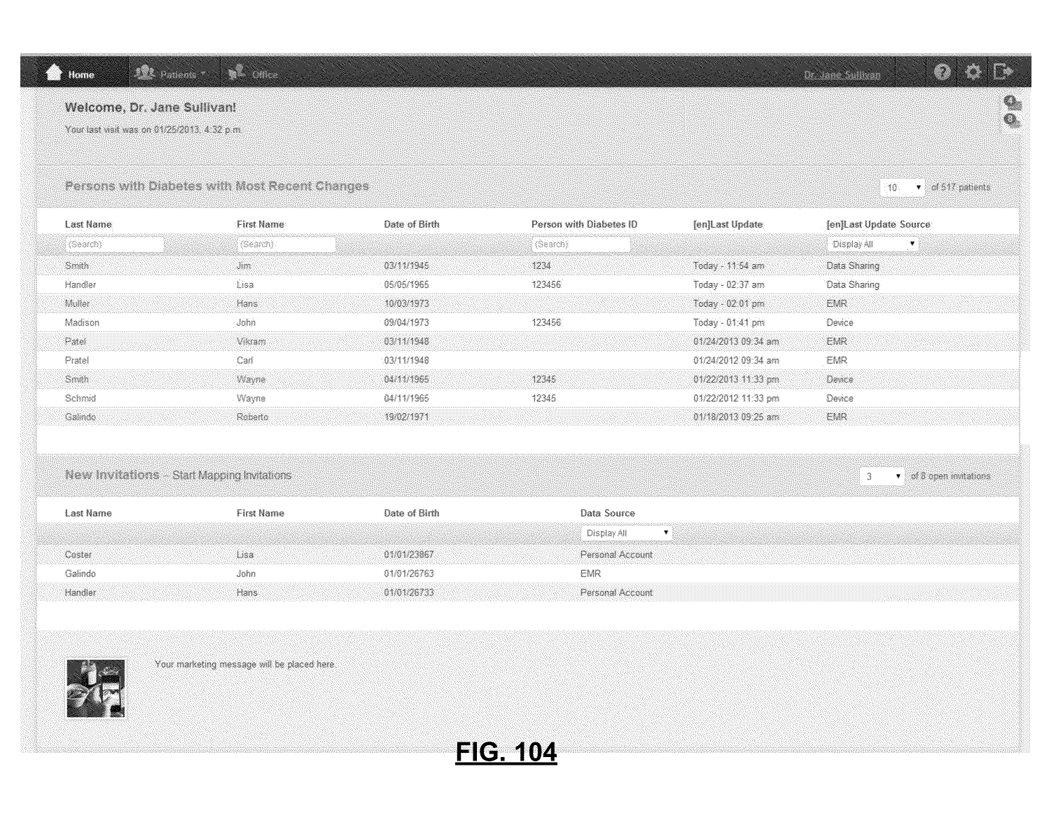

FIG. 104 includes a GUI for a healthcare professional account that displays a listing of patients, in order of most recent changes, as well as new invitations for data sharing. Various parameters of this user interface may be searchable, filterable, or otherwise adjusted by a user. This user interface may have various tab features, as shown, which are labeled as “home,” “Patients,” “Office,” and “Connections.”

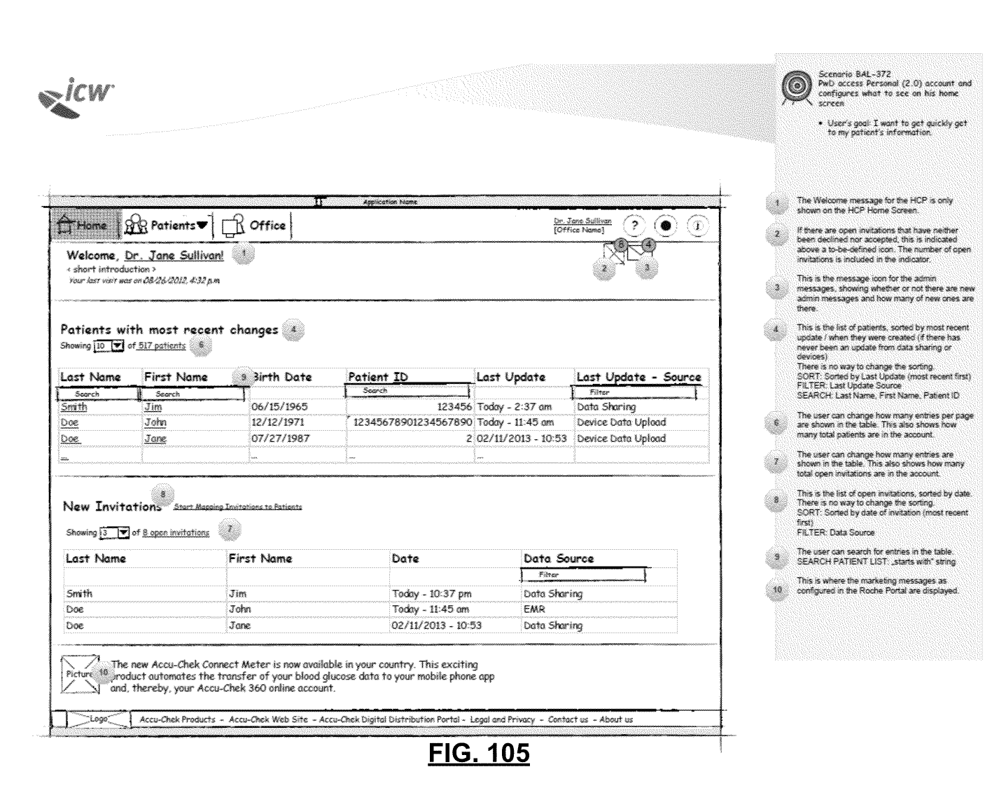

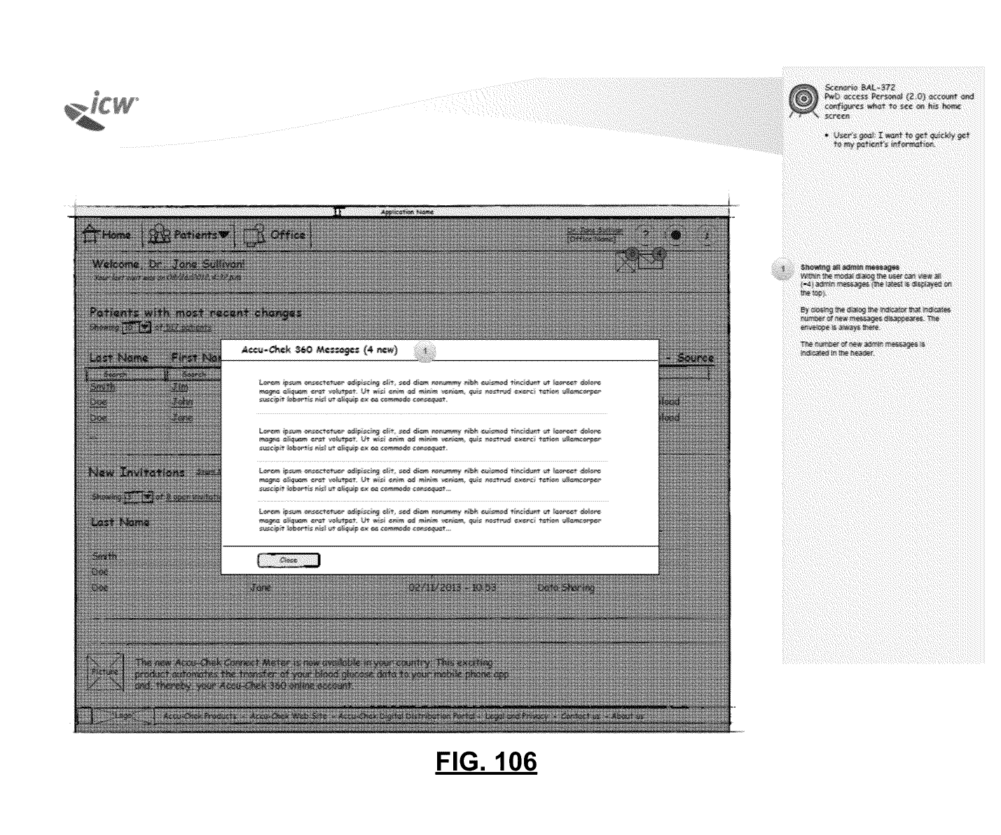

One user's goal may be to quickly get to patient information. As shown in FIG. 105, the welcome message for the healthcare provider may be shown on the healthcare provider home screen. If there are open invitations for the user that have neither been declined nor accepted, this is indicated at Reference number (2), which may be a defined icon. The number of open invitations may also be included as an indicator. Reference number (3) is a message icon for administrative messages, showing whether or not there are new administrative messages, and how many new or unread messages are present. As shown in FIG. 106, administrative messages may be provided in separate user interfaces.

Reference number (4) illustrates a representative of a list of patients, which may be sorted by most recent update/when they were created (if there has never been an update from data sharing or devices). Reference number (6) indicates that the user can change how many entries per page are shown in the table. This area also shows how many total patients are in the account. Reference number (7) indicates how many total open invitations are in the account, and the user can also change how many entries are shown in this table. Reference number (8) indicates a list of open (not yet accepted or declined) invitations, sorted by date. A user can initiate a search of entries in the table by entering a query at the top row. For example, reference number (9) illustrates a search aspect for the names of patients. Various marketing messages can be provided at the bottom of the page, for example, at reference number (10).

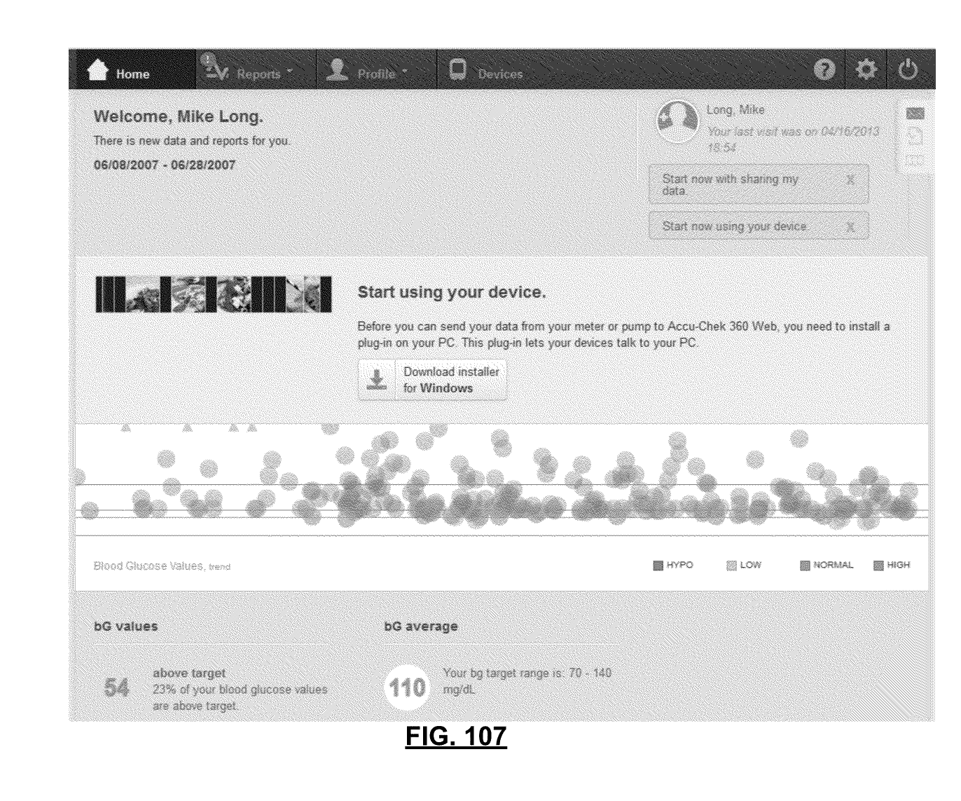

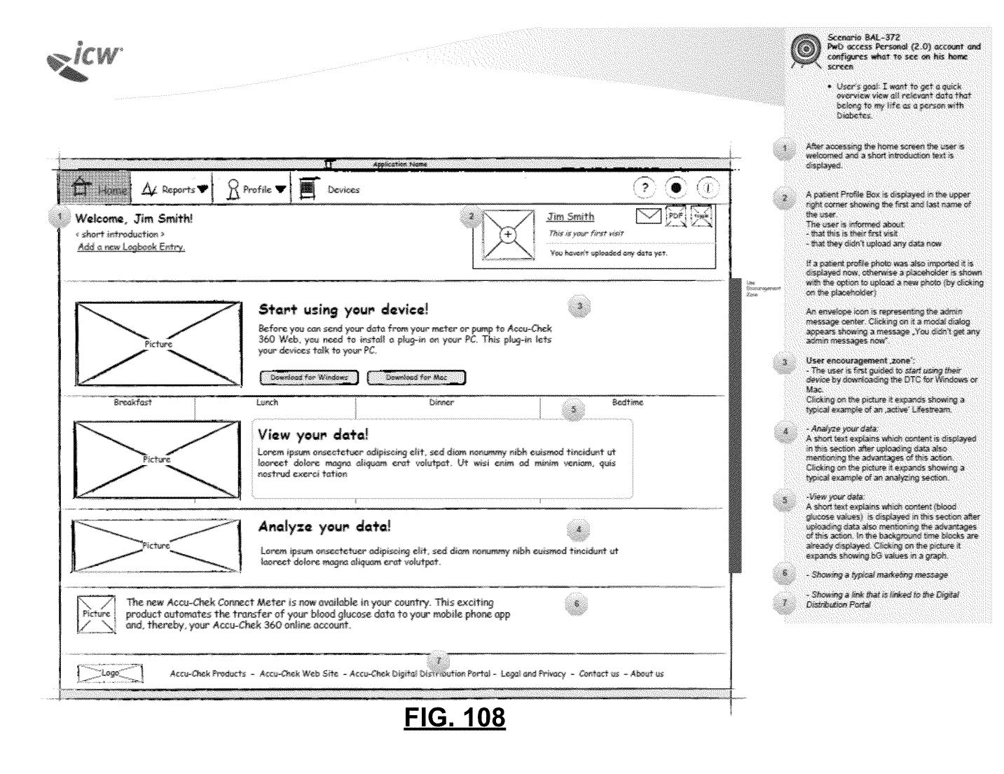

As shown in FIGS. 107 and 108, the server computer 18 also generates GUIs for home pages of patient accounts. Home pages for patient accounts may be set to provide the patient with new data and reports. Various options are presented for the user to navigate as detailed on the sample home pages shown. In various aspects, the user is able to obtain a quick overview snapshot of all relevant diabetes management data that pertains to a person with diabetes.

With specific reference to FIG. 108, after being presented with a home page user interface, the user is welcomed and a short introduction text is displayed. Reference number (2) indicates a patient Profile Box, displayed in the upper right corner showing the first and last name of the user. The user may be informed that this is their first visit or they did not upload any data now. If a patient profile photo was also imported it is displayed here, otherwise a placeholder is shown with the option to upload a new photo (by selecting the placeholder). An envelope icon representative of an administrative message center may be provided. Selecting (clicking on) the administrative message center may open a user interface showing administrative messages received by the user account, if any.

Reference number (3) provides what may be referred to as a “user encouragement zone.” The user may be guided to start using their device by downloading a plug-in application for their operating system, such as Windows®, Mac®, or other operating system. Selecting a picture icon may open a user interface showing a typical example of an “active Life Stream.”

Reference number (4) indicates an “Analyze your Data” feature. Simplified text may be provided, explaining which content is displayed in this section after uploading data, and also mentioning the advantages of this action. Selecting the picture expands the view, showing a typical example of an analyzing section.

Reference number (5) indicates a “View your Data” feature. Simplified text may be provided, explaining which content (blood glucose values) is displayed in this section after uploading data, and also mentioning the advantages of this action. In the background, time blocks may already be displayed.

Reference number (6) indicates an example marketing message, and reference number (7) indicates a hyperlink that may be linked to the Digital Distribution Portal.

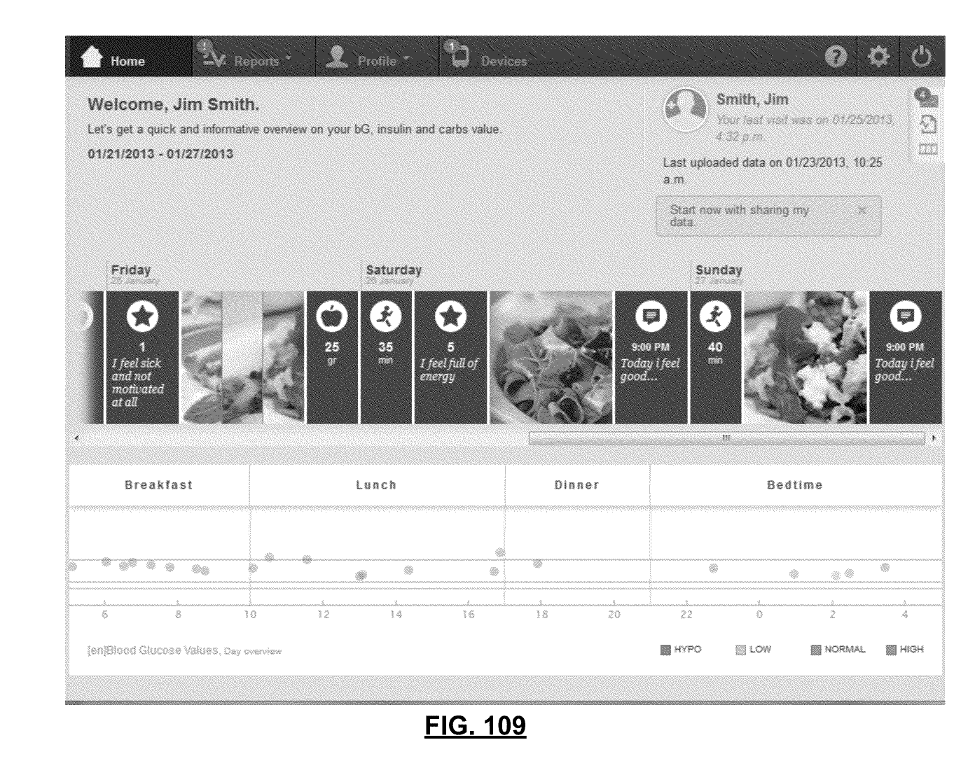

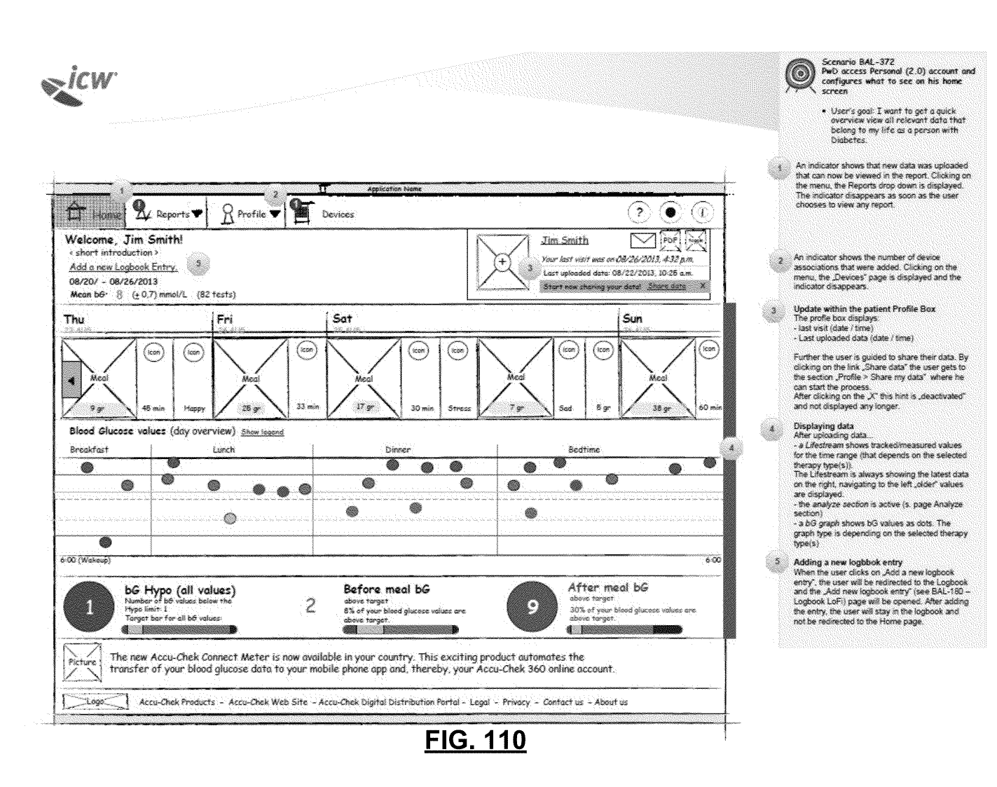

FIGS. 109 and 110 include GUIs displaying a “Life Stream.” By way of example, a patient user may want to get a quick overview of their relevant diabetes management data. Reference number (1) of FIG. 110 illustrates an indicator that shows new data was uploaded that can now be viewed in the report. Upon selecting a menu, a “Reports” drop down user interface may be displayed. The indicator may be removed when the user chooses to view any report.

Reference number (2) illustrates an indicator showing the number or device associations that were added. Upon selecting the menu, the “Devices” page is displayed and the indicator may be removed. Reference number (3) illustrates an update within a patient profile box. The patient profile box may display the last visit (date/time) and last uploaded data (date/time). The patient profile box may also include a message for the user to share their diabetes management data. By selecting the “Share data” hyperlink, the user gets to the section Profile >“Share my data” where he can start the process. After selecting the “X,” this link is deactivated and not displayed any longer.

Reference number (5) illustrates the displaying of various data. After uploading data, a “Life Stream” shows tracked/measured values for the time range (that depends on the selected therapy type(s)). The “Life Stream” is always showing the latest data on the right; navigating to the left, older values are displayed. The “analyze” section of the user interface is active. The bG values are typically illustrated as dots. Characteristics of the graph displayed are dependent on the selected therapy type(s), as discussed above.

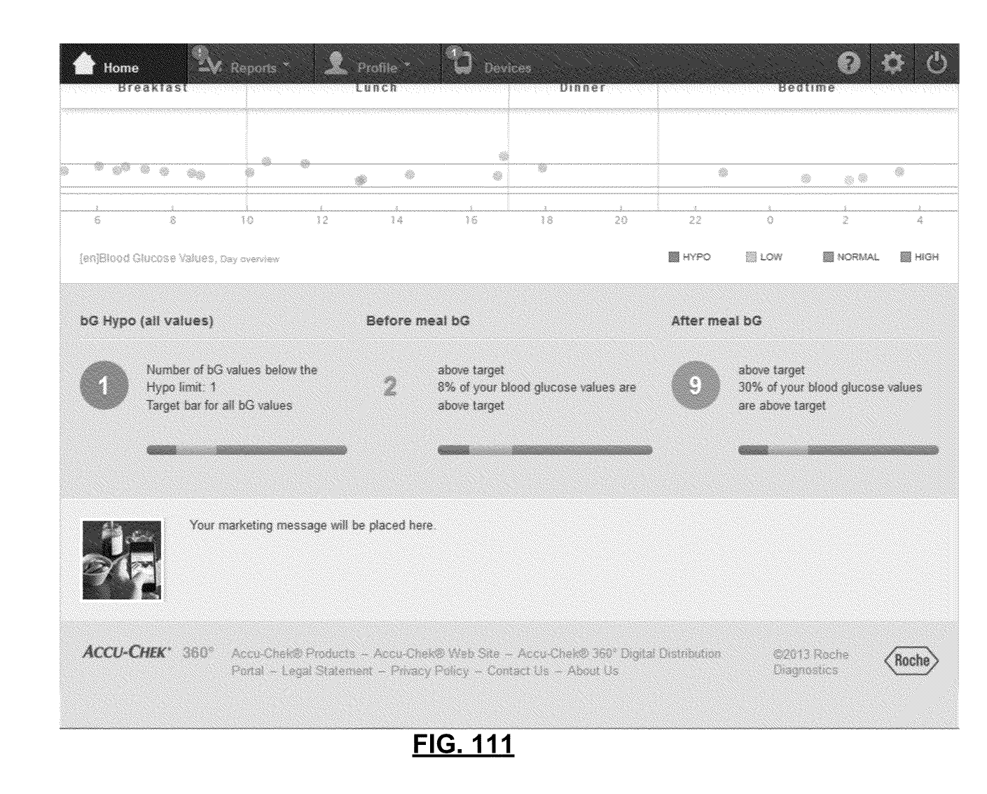

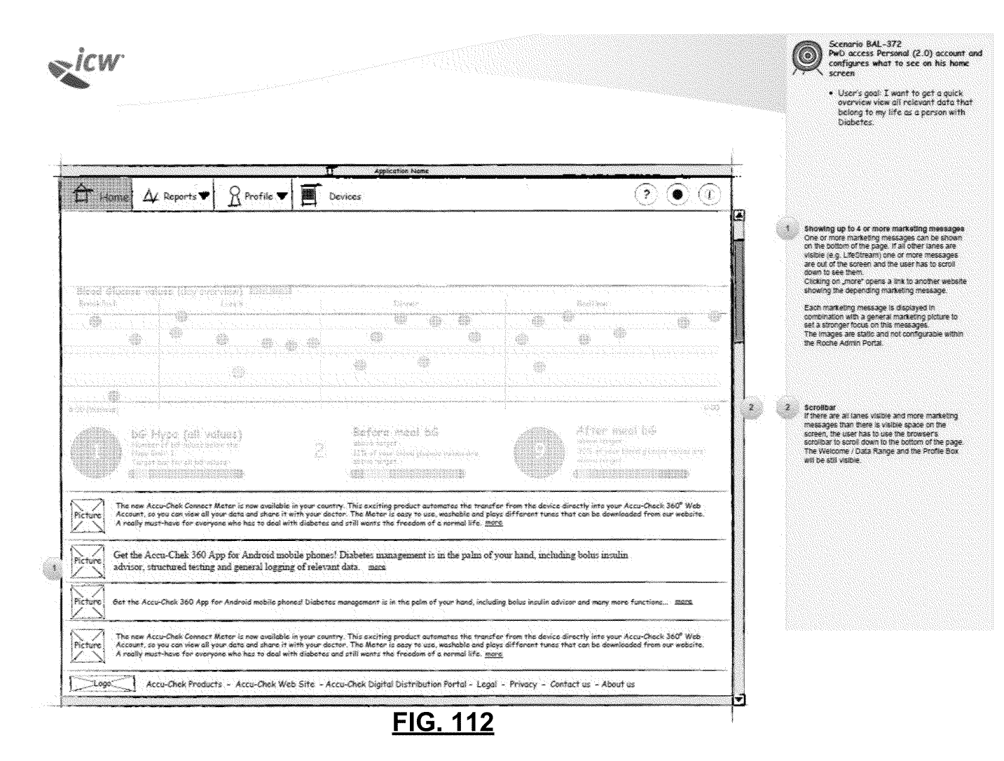

FIGS. 111 and 112 include additional example GUIs for home pages of patient accounts. Up to a predetermined number of marketing messages may be displayed, such as four, and the marketing messages may be displayed in a row as indicated by the top left of FIG. 112. By selecting “more,” a user interface may display the remaining marketing message(s). Each marketing message may be displayed in combination with a general marketing picture to set a stronger focus on the messages. The images may be static and may not configurable within the web portal. Users of patient accounts may be able to view and purchase products from an e-store accessed via the home page.

Home pages for patient accounts may further include features such as the creation of patient summary reports. Patient summary reports may provide a quick overview of a patient's information. The patient summary reports may provide a view of selected data configurable for a date range, option for device settings, advice statistics, and pump statistics. The patient summary reports may include trend graphs, statistical analysis, advice statistics, pump statistics, and device settings. The ability to print the reports in specific formats, such as Adobe PDF, may also be provided.

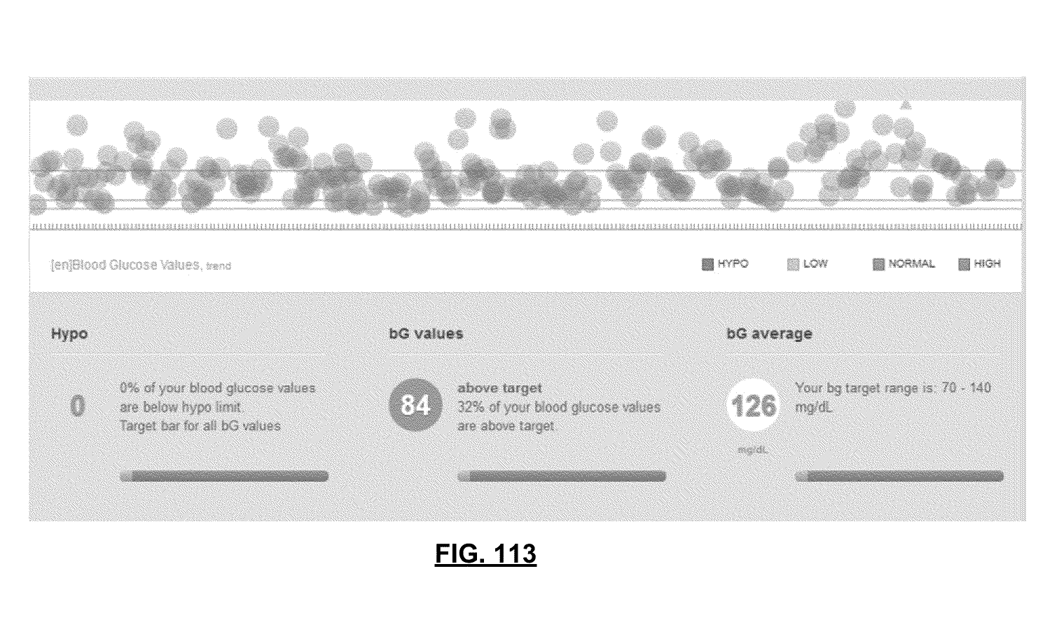

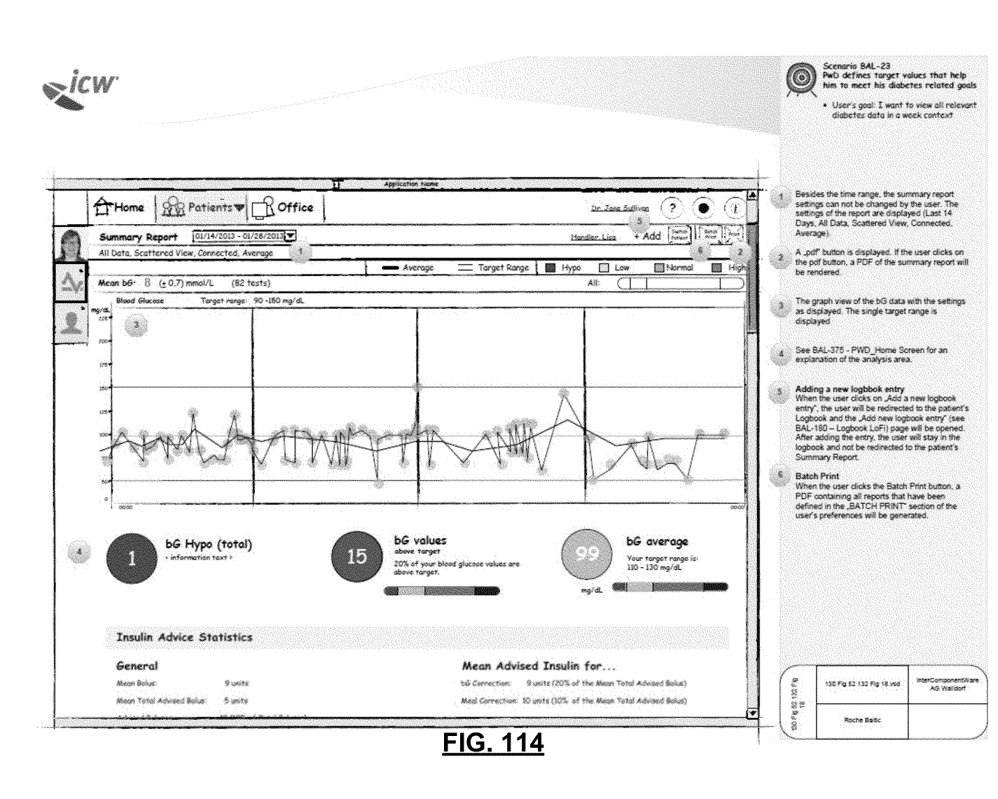

FIG. 113 illustrates a GUI providing a summary report for a patient. FIG. 114 includes a GUI displaying relevant diabetes management data in a predetermined time context, shown with two weeks' worth of data.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of managing diabetes management data, comprising:
receiving, at a computing device, account creation information input by a user;
transmitting the account creation information from the computing device to a diabetes management server;
using the diabetes management server, creating an account based on the account creation information;
receiving, at the computing device, diabetes management data from a diabetes management device that is connected to the computing device wirelessly or by wire, wherein the diabetes management data does not include a blood glucose (bG) measurement;
using the computing device, transmitting an indicator of the account and the diabetes management data to the diabetes management server;
using the diabetes management server, in response to receipt of the diabetes management data:
creating a bG measurement entry for the account in a database,
leaving empty a field of the bG measurement entry for a bG measurement in the bG measurement entry based on the diabetes management data not including a bG measurement; and
storing the diabetes management data in one or more respective fields of the bG measurement entry;
using the diabetes management server, generating a user interface for displaying data stored in the bG measurement entry and at least one other bG measurement entry that is associated with the account; and,
using the computing device, accessing data stored in the database in association with the account and displaying the user interface including displaying the data stored in the bG measurement entry and the at least one other bG measurement entry that is associated with the account.

2. The method of claim 1 further comprising:
using the diabetes management server, generating a second user interface based on a type of diabetes management therapy associated with the account,
wherein the account information input by the user includes the type of diabetes management therapy; and
using the computing device, displaying the second user interface.

3. The method of claim 2 wherein the second user interface includes a bG measurement graph set based on the type of diabetes management therapy associated with the account.

4. The method of claim 2 wherein the second user interface includes a date range set based on the type of diabetes management therapy associated with the account.

5. The method of claim 2 wherein the second user interface includes a calorie intake graph set based on the type of diabetes management therapy associated with the account.

6. The method of claim 2 wherein the second user interface includes an exercise graph set based on the type of diabetes management therapy associated with the account.

7. The method of claim 2 wherein the second user interface includes an insulin intake graph set based on the type of diabetes management therapy associated with the account.

8. The method of claim 2 wherein the second user interface includes a statistical analysis of an average bG value versus a target bG value set based on the type of diabetes management therapy associated with the account.

9. The method of claim 1 wherein the diabetes management data includes an amount of insulin administered via a syringe and does not include a bG measurement.

10. The method of claim 1 wherein the diabetes management data includes an amount of insulin administered via an insulin pump and does not include a bG measurement.

11. The method of claim 1 wherein the diabetes management data includes a carbohydrate intake and does not include a bG measurement.

12. The method of claim 1 wherein the diabetes management data includes a calorie intake and does not include a bG measurement.

13. The method of claim 1 wherein the diabetes management data includes advice given and does not include a bG measurement.

14. The method of claim 1 further comprising:
receiving, at the computing device, information for a health care professional's account; and
using the diabetes management server, selectively enabling one or more users of the health care professional's account to access diabetes management data stored in the database in association with the account.

15. The method of claim 14 further comprising, using the diabetes management server, identifying the health care professional's account based on the information for the health care professional's account.

16. The method of claim 14 further comprising:
displaying, using the computing device, a request for consent to enable the health care professional's account to access the diabetes management data stored in the database in association with the account; and
using the diabetes management server, enabling the one or more users of the health care professional's account to access the diabetes management data in response to receipt of the consent by the diabetes management server.

17. The method of claim 1 further comprising, using the diabetes management server, updating the field for the bG measurement of the bG measurement entry with a bG measurement input by a user to the computing device.

18. The method of claim 17 further comprising, using the diabetes management server, storing an indicator with the bG measurement, the indicator indicating that the bG measurement was edited by the user.

19. The method of claim 1 further comprising, using the computing device, transferring the diabetes management data from the diabetes management device to the diabetes management server without ever storing the diabetes management device anywhere within the computing device.

20. A diabetes management system, comprising:
a computing device that receives account creation information input by a user to the computing device;
a diabetes management server that:
receives the account creation information from the computing device; and
creates an account in a database based on the account creation information;
a diabetes management device that:
is connected to the computing device wirelessly or by wire; and
transmits diabetes management data stored in the diabetes management device to the computing device,
wherein the diabetes management data does not include a blood glucose (bG) measurement;
the computing device further transmitting an indicator of the account and the diabetes management data to the diabetes management server;
in response to receipt of the diabetes management data, the diabetes management server further:
creating a bG measurement entry for the account in the database,
leaving empty a field of the bG measurement entry for a bG measurement in the bG measurement entry based on the diabetes management data not including a bG measurement; and
storing the diabetes management data in one or more respective fields of the bG measurement entry;
the diabetes management server further generating a user interface for displaying data stored in the bG measurement entry and at least one other bG measurement entry that is associated with the account; and,
the computing device further:
accessing data stored in the database in association with the account; and
displaying the user interface including displaying the data stored in the bG measurement entry and the at least one other bG measurement entry that is associated with the account.
